(19) United States
(12) Patent Application Publication
(10) Pub. No.: US 2026/0236838 A1
(43) Pub. Date: Aug. 13, 2026

(54) SYSTEMS AND METHODS FOR MACHINE LEARNING MODEL PERSONALIZATION FOR CONVERSATIONAL SIMULATION OF A SPECIFIC SUBJECT

(71) Applicant: Eternos.Life Inc., Palo Alto, CA (US)

(72) Inventors: Robert Peter LoCascio, Los Altos, CA (US); Andrew Philip LoCascio, Manhasset, NY (US)

(73) Assignee: Eternos.Life Inc., Palo Alto, CA (US)

(21) Appl. No.: 19/193,089

(22) Filed: Apr. 29, 2025

Related U.S. Application Data
(60) Provisional application No. 63/640,150, filed on Apr. 29, 2024.

(51) Int. Cl. G06N 20/00

(52) U.S. Cl. CPC G06N 20/00

(57) ABSTRACT

Machine learning model personalization systems and techniques are described. For instance, a system receives input data through a discovery user interface. The input data includes answers from a subject. The answers are associated with questions, and include subject-specific information that is specific to the subject. The system parses and/or processes the input data to generate model personalization data (e.g., training data). The system modifies a trained machine learning model using the model personalization data to generate a personalized machine learning model that is personalized to simulate the subject. The system receives a message through a conversational user interface. The system generates a response to the message using the personalized machine learning model. The response is generated to simulate the subject, for instance by being generated to include at least a subset of the subject-specific information. The system outputs the response through the conversational user interface.

### CROSS-REFERENCE TO RELATED APPLICATIONS

The present patent application claims the priority benefit of U.S. provisional patent application No. 63/640,150 filed Apr. 29, 2024 and titled “Systems and Methods for Machine Learning Model Personalization for Conversational Simulation of a Specific Subject,” the disclosure of which is incorporated by reference herein in its entirety.

### FIELD

This disclosure is related to personalization and/or customization of machine learning models to simulate a subject. More specifically, this disclosure relates to systems and methods of modifying machine learning model(s) using subject-specific input information (that is specific to a subject and/or gathered through an interactive user interface and processed) to generate personalized machine learning model(s) that simulates the subject, for instance to simulate a conversation with the subject, a voice of the subject, an appearance of the subject, or a combination thereof.

### BACKGROUND

A machine learning (ML) model is an artificial intelligence (AI) model that uses algorithms to learn how to perform a specific function by processing training data that includes example inputs and corresponding example outputs of the specific function. In some examples, ML models can be used to recognize patterns in data, make predictions, or other tasks.

### BRIEF SUMMARY

Systems and techniques are described for machine learning model personalization. In some examples, a model personalization system receives input data (e.g., from a first client device associated with a subject) through a discovery user interface. The input data includes answers from a subject. The answers are associated with questions, and include subject-specific information that is specific to the subject. The model personalization system parses and/or processes the input data to generate model personalization data, for instance by converting the input data into a spreadsheet and/or a JavaScript Object Notation (JSON) file. The model personalization system modifies a trained machine learning model using the model personalization data (e.g., by fine-tuning the trained machine learning model and/or further training the trained machine learning model) to generate a personalized machine learning model that is personalized to simulate the subject. The model personalization system receives a message through a conversational user interface (e.g., from a second client device associated with a user). The model personalization system generates a response (e.g., written, verbal, visual, or a combination thereof) using the personalized machine learning model. The response is responsive (e.g., conversationally responsive) to the message. The response is generated to simulate the subject, for instance by being generated to include at least a subset of the subject-specific information, and/or by being generated to simulate at least one speaking style of the subject, a writing style of the subject, a verbal tic of the subject, an accent of the subject, a dialect of the subject, a language register of the subject, an elocution of the subject, a tone associated with the subject, a diction associated with the subject, a rhetoric associated with the subject, a lexicon associated with the subject, a jargon associated with the subject, a cadence associated with the subject, an idiolect associated with the subject, a syntax associated with the subject, a linguistic persona associated with the subject, or a combination thereof. The model personalization system outputs the response through the conversational user interface (e.g., as text, as audio, as video, or as a combination thereof). In some examples, the model personalization system receives a second message, extracts feedback about the response from the second message, and updates the personalized machine learning model further (e.g., fine-tuning and/or training the personalized machine learning model further) based on the feedback (e.g., strengthening or weakening weights to encourage or discourage similar response(s) to similar message(s)). In some examples, the model personalization system uses the updated personalized machine learning model to generate a second response that is responsive (e.g., conversationally responsive) to the second message, and outputs the second response (e.g., as text, as audio, as video, or as a combination thereof).

In some aspects, the techniques described herein relate to a method for machine learning model personalization, the method including: receiving input data through a discovery user interface, wherein the input data includes answers from a subject, wherein the answers are associated with questions, and wherein the answers include subject-specific information that is specific to the subject; processing the input data to generate model personalization data; modifying a trained machine learning model using the model personalization data to generate a personalized machine learning model that is personalized to simulate the subject; receiving a message through a conversational user interface; generating a response using the personalized machine learning model, wherein the response is responsive to the message, and wherein the response is generated to simulate the subject by being generated to include at least a subset of the subject-specific information; and outputting the response through the conversational user interface.

In some aspects, the techniques described herein relate to a system for machine learning model personalization, the system including: a memory that stores instructions; and a processor coupled to the memory, wherein execution of the instructions by the processor causes the processor to: receive input data through a discovery user interface, wherein the input data includes answers from a subject, wherein the answers are associated with questions, and wherein the answers include subject-specific information that is specific to the subject; process the input data to generate model personalization data; modify a trained machine learning model using the model personalization data to generate a personalized machine learning model that is personalized to simulate the subject; receive a message through a conversational user interface; generate a response using the personalized machine learning model, wherein the response is responsive to the message, and wherein the response is generated to simulate the subject by being generated to include at least a subset of the subject-specific information; and output the response through the conversational user interface.

In some aspects, the techniques described herein relate to a non-transitory computer-readable storage medium having embodied thereon a program, wherein the program is executable by a processor to perform a method of machine learning model personalization, the method including: receiving input data through a discovery user interface, wherein the input data includes answers from a subject, wherein the answers are associated with questions, and wherein the answers include subject-specific information that is specific to the subject; processing the input data to generate model personalization data; modifying a trained machine learning model using the model personalization data to generate a personalized machine learning model that is personalized to simulate the subject; receiving a message through a conversational user interface; generating a response using the personalized machine learning model, wherein the response is responsive to the message, and wherein the response is generated to simulate the subject by being generated to include at least a subset of the subject-specific information; and outputting the response through the conversational user interface.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

Illustrative aspects of the present application are described in detail below with reference to the following drawing figures:

FIG. 1 is a swim lane diagram illustrating an example of a process for personalizing one or more machine learning (ML) model(s) that is performed using one or more client device(s) and one or more special-purpose server system(s), in accordance with some examples;

FIG. 2 is a block diagram illustrating an example of a system architecture of a model personalization system that includes the one or more client device(s) and one or more special-purpose server system(s), in accordance with some examples;

FIG. 3 is a conceptual diagram illustrating an example of a conversion from input data to a spreadsheet using the data parser, in accordance with some examples;

FIG. 4 is a conceptual diagram illustrating a table of shortcodes, actions, and sample outputs, in accordance with some examples;

FIG. 5 is a block diagram illustrating examples of various inputs and outputs of various ML models, including personalized variants of ML models for text, voice, and visual processing, in accordance with some examples;

FIG. 6 is a conceptual diagram illustrating a user interface for a first conversation with one or more personalized machine learning models via text, and a user interface for a second conversation with one or more personalized machine learning models via video and/or audio, in accordance with some examples;

FIG. 7 is a block diagram illustrating an architecture of a model personalization system, in accordance with some examples;

FIG. 8 is a block diagram illustrating an ML-based recollection system that uses ML model(s) to generate summaries of different chat sessions, and that uses ML model(s) to generate a summary of the different chat session summaries, for use by a personalized ML model for recollection of past conversations, in accordance with some examples;

FIG. 9 is a block diagram illustrating an ML-based emotion system that uses of a response ML model to generate a response to a message, that uses an emotion ML model to identify emotions corresponding to portions of the response, and that uses a voice ML model to determine how to read the response based on the identified emotions, in accordance with some examples;

FIG. 10 is a block diagram illustrating a collective ML model personalization system that combines personalized ML models, each associated with different people (e.g., a first person, a second person, and a third person), to form a customized collective ML model associated with a group of people (e.g., the first person, the second person, and the third person), for instance focused on recollections of an event by the group of people, in accordance with some examples;

FIG. 11 is a block diagram illustrating a modular ML model personalization system that combines of model-specific data (e.g., training data, fine-tuning data, model parameters, and/or other model customization data) from a version of a personalized ML model and a number of subject-specific models, on a modular basis, to form an updated version of the personalized ML model, in accordance with some examples;

FIG. 12 is a block diagram illustrating a biographical ML model personalization system that uses trained machine learning models to generate an interactive biography of a subject (person), where a listener can interrupt an output of the interactive biography with messages (e.g., questions) and receive responses in real-time, in accordance with some examples;

FIG. 13 is a block diagram illustrating a content summarizing ML model personalization system that uses of trained machine learning models to summarize a book or other media content, first on a portion-by-portion (e.g., chapter-by-chapter) basis, then to generate a summary of the entirety, in accordance with some examples;

FIG. 14 is a block diagram illustrating an example of a machine learning system for training and use of one or more machine learning model(s) used to generate one or more response(s) responsive to one or more message(s), in accordance with some examples;

FIG. 15 is a block diagram illustrating a retrieval augmented generation (RAG) system that may be used to implement some aspects of the technology, according to some examples.

FIG. 16 is a conceptual diagram illustrating a process for dynamically updating a personalized machine learning model in a continuous fashion as further data continues to be received over time, in accordance with some examples;

FIG. 17 is a flow diagram illustrating a process for machine learning model training, in accordance with some examples;

FIG. 18 is a swim lane diagram illustrating a process for retrieval augmented generation (RAG), in accordance with some examples;

FIG. 19 is a flow diagram illustrating a process for machine learning model personalization, in accordance with some examples; and

FIG. 20 is a diagram illustrating an example of a computing system for implementing certain aspects described herein, in accordance with some examples.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the spirit and scope of the application as set forth in the appended claims.

A machine learning (ML) model is an artificial intelligence (AI) model that uses algorithms to learn how to perform a specific function by processing training data that includes example inputs and corresponding example outputs of the specific function. In some examples, ML models can be used to recognize patterns in data, make predictions, or other tasks. Examples of ML models can include neural network (NN(s)), convolutional NN(s) (CNN(s)), trained time delay NN(s) (TDNN(s)), deep network(s), autoencoder(s) (AE(s)), variational AE(s) (VAE(s)), deep belief net(s) (DBN(s)), recurrent NN(s) (RNN(s)), generative adversarial network(s) (GAN(s)), conditional GAN(s) (cGAN(s)), support vector machine(s) (SVM(s)), random forest(s) (RF(s)), decision tree(s), NN(s) with fully connected (FC) layer(s), NN(s) with convolutional layer(s), computer vision (CV) system(s), deep learning (DL) system(s), classifier(s), transformer(s), clustering algorithm(s), reinforcement learning (RL) model(s), supervised learning (SL) model(s), unsupervised learning (UL) model(s), gradient boosting model(s), sequence-to-sequence (Seq2Seq) model(s), autoregressive (AR) model(s), large language model(s) (LLMs), or combinations thereof.

A large language model (LLM) is a type of ML model that can recognize, complete, and/or generate text. Training data that is used to train an LLM to recognize, complete, and/or generate text in a specific language (e.g., English) includes large quantities of text data written in the specific language. LLMs are created using a specific type of neural network referred to as a transformer model. Examples of LLMs include Generative Pre-Trained Transformer (GPT) (e.g., GPT-2, GPT-3, GPT-3.5, GPT-4, ChatGPT, and/or other GPT variant(s)), DaVinci, LLMs using Massachusetts Institute of Technology (MIT) langchain, Google® Bard®, Google® Gemini®, Large Language Model Meta AI (LLaMA), LLaMA 2, LLaMA 3, LLaMA 4, Megalodon, or combinations thereof.

Traditional ML models that generate text, such as LLMs, generate text in a way that does not represent any specific perspective, and does not simulate any specific person. For instance, traditional ML models that generate text do not reference any specific person's history or memories as being its own, do not simulate any specific person's speaking style (e.g., phrases, verbal tics, etc.), and otherwise do not generate outputs intended to represent a specific perspective or subject. In some cases, however, a more personalized ML model may be useful to simulate a perspective of a particular person who is unable to respond at a given time, for instance because that person is busy, is away, is sick, or is deceased.

This disclosure is related to machine learning model personalization. More specifically, this disclosure relates to systems and methods of modifying machine learning model(s) using subject-specific input information (that is specific to a subject) to generate personalized machine learning model(s) that simulates the subject, for instance to simulate a conversation with the subject, a voice of the subject, an appearance of the subject, or a combination thereof. For instance, in some examples, a model personalization system receives input data through a discovery user interface (e.g., from a first client device associated with a subject). The input data includes answers from a subject. The answers are associated with questions, and include subject-specific information that is specific to the subject. The model personalization system parses and/or processes the input data to generate model personalization data (e.g., training data, fine-tuning data, model parameter data), for instance by converting the input data into a spreadsheet and/or a JavaScript Object Notation (JSON) file. The model personalization system modifies a trained machine learning model using the model personalization data (e.g., by fine-tuning the trained machine learning model and/or further training the trained machine learning model) to generate a personalized machine learning model that is personalized to simulate the subject. The model personalization system receives a message through a conversational user interface (e.g., from a second client device associated with a user). The model personalization system generates a response (e.g., written, verbal, visual, or a combination thereof) using the personalized machine learning model. The response is responsive (e.g., conversationally responsive) to the message. The response is generated to simulate the subject, for instance by being generated to include at least a subset of the subject-specific information, and/or by being generated to simulate at least one of a speaking style of the subject, a writing style of the subject, a verbal tic of the subject, an accent of the subject, a dialect of the subject, a language register of the subject, an elocution of the subject, or a combination thereof. The model personalization system outputs the response through the conversational user interface (e.g., as text, as audio, as video, or as a combination thereof).

In some examples, the model personalization system receives a second message, extracts feedback about the response from the second message, and updates the personalized machine learning model further (e.g., fine-tuning and/or training the personalized machine learning model further) based on the feedback (e.g., strengthening or weakening weights to encourage or discourage similar response(s) to similar message(s)). In some examples, the model personalization system uses the updated personalized machine learning model to generate a second response that is responsive (e.g., conversationally responsive) to the second message, and outputs the second response (e.g., as text, as audio, as video, or as a combination thereof).

The model personalization systems and techniques described herein provide a number of technical improvements over other machine learning model systems. For instance, the model personalization systems and techniques described herein provide personalized ML models that have capabilities that other ML models do not. For instance, the personalized ML models are capable of generating responses that are generated to simulate a specific subject (e.g., a specific person), for instance in terms of content discussed (e.g., specific memories of the subject, historical facts about the subject, opinions of the subject, preferences of the subject, and/or biases of the subject), in terms of language style and patterns (e.g., a speaking style of the subject, a writing style of the subject, a verbal tic of the subject, an accent of the subject, a dialect of the subject, a language register of the subject, an elocution of the subject, a tone associated with the subject, a diction associated with the subject, a rhetoric associated with the subject, a lexicon associated with the subject, a jargon associated with the subject, a cadence associated with the subject, an idiolect associated with the subject, a syntax associated with the subject, and/or a linguistic persona associated with the subject), or a combination thereof. In some examples, the personalized ML models are capable of generating audio that further simulates the voice of the subject reading those generated responses, further simulating a vocal style of the subject (e.g., an accent of the subject, a vocal tone of the subject, a pitch of the subject, a register of the subject, a speaking pattern of the subject, a speech cadence of the subject, and/or a speech speed of the subject). In some examples, the personalized ML models are capable of generating video that further simulates the appearance of the subject, in some examples including simulating the mouth movements that the subject would make while reading the generated response, with the mouth movements generated to line up with the generated audio that simulates the subject's voice reading the generated responses.

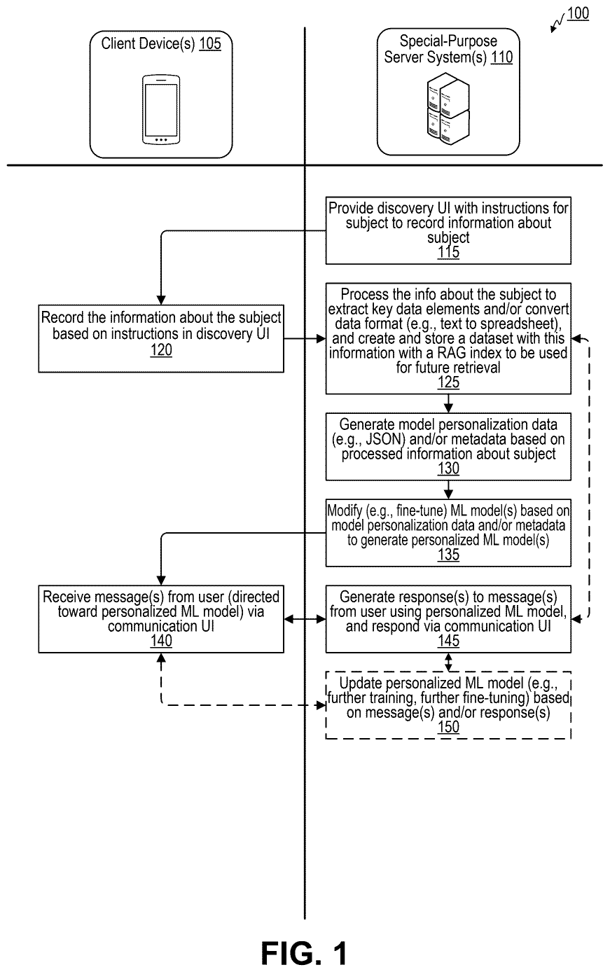

Various aspects of the application will be described with respect to the figures. FIG. 1 is a swim lane diagram illustrating an example of a process 100 for personalizing one or more machine learning (ML) model(s) that is performed using one or more client device(s) 105 and one or more special-purpose server system(s) 110. At operation 115, the special-purpose server system(s) 110 provides a discovery user interface (UI) (e.g., see discovery UI 215) of the client device(s) 105 with instructions (e.g., instructions 210) for a subject to record information about the subject (e.g., information 220 about the subject). The subject can be a user (e.g., a person) that a personalized ML model (e.g., personalized ML model 255) is to be personalized to, and who is to be simulated using the personalized ML model. In some examples, operation 115 includes sending the instructions to the client device(s) 105 (e.g., a subject client device associated with the subject) to cause the client device(s) 105 (e.g., the subject client device) to output the instructions via the discovery UI 215. In some examples, the instructions include questions.

At operation 120, the client device(s) 105 (e.g., the subject client device) receives and/or records information about the subject (e.g., information 220 about the subject) based on the instructions (e.g., questions) output by the client device(s) 105 (e.g., the subject client device), the instructions having been provided by the special-purpose server system(s) 110 in operation 115. In some examples, the information about the subject includes answers to the questions in the instructions (e.g., answers responsive to the questions). For examples, the instructions can include questions such as “when and where were you born?” The information about the subject can include answers to such questions, such as “I was born on Apr. 18, 1980 at Stanford Hospital in Palo Alto, CA to Patrick and Patricia Johnson.” The information about the subject may be referred to as subject-specific information.

In some examples, the client device(s) 105 (e.g., the subject client device) receives and/or records the information about the subject as a string of characters (e.g., text, numbers, symbols, and/or alphanumeric characters), for instance input through a touchscreen (e.g., a virtual keyboard on the touchscreen), a keyboard, a keypad, or a combination thereof. In some examples, the client device(s) 105 (e.g., the subject client device) receives and/or records the information as an audio recording of the voice of the subject (e.g., recorded via a microphone) as the subject verbally responds to the instructions (e.g., verbally provides answers to the questions). In some examples, the client device(s) 105 (e.g., the subject client device) receives and/or records the information to include one or more images (e.g., of the subject and/or of location, people, or other elements in the subject's life), videos (e.g., of the subject and/or of location, people, or other elements in the subject's life), audio files (e.g., including samples of the voice of the subject), documents, and/or other files. For instance, the subject can use a file selector UI element in the discovery UI 215 to select one or more files to include in the information about the subject. The

The client device(s) 105 (e.g., the subject client device) can send the information about the subject to the special-purpose server system(s) 110. In some examples, the client device(s) 105 (e.g., the subject client device) can process the information before sending the information to the special-purpose server system(s) 110, for instance by processing a voice recording of the subject speaking the answers using a speech-to-text algorithm to generate text answers, and sending the text answers in the information to the special-purpose server system(s) 110. In some examples, such processing can be performed by the special-purpose server system(s) 110 after the information is sent from the client device(s) 105 (e.g., the subject client device) to the special-purpose server system(s) 110, by the client device(s) 105, or a combination thereof.

At operation 125, the special-purpose server system(s) 110 processes the information about the subject to extract key data elements and/or convert the format(s) of the information to generate a processed dataset (e.g., processed dataset 230) about the subject. For instance, if the information about the subject includes audio (e.g., a voice recording of the subject speaking the answers), operation 125 can include the special-purpose server system(s) 110 parsing the information about the subject using a speech-to-text algorithm to generate text from the audio in the information about the subject (e.g., text for of the spoken answers). Operation 125 can include the special-purpose server system(s) 110 processing the information about the subject to extract key data elements and/or categorizing those key data elements, for instance into categories such as the subject's identifying information (e.g., name), demographic information (e.g., age, gender, sex, ethnicity), history (e.g., birthdate, birthplace, events that the subject has attended, and so forth), memories (e.g., details of a specific historical event), biases (e.g., the subject's likes or dislikes or preferences), opinions (e.g., the subject's likes, dislikes, preferences, and/or other opinions such as how the subject thinks a certain task should be performed), affiliations, accolades, hobbies, sports, videos, images, documents, digital historical information (e.g., from the internet), additional inputs after the death of the subject (e.g., regarding inheritance or digital inheritance), a role that the personalized ML model(s) should take with respect to a specific topic, or combinations thereof. Operation 125 can include the special-purpose server system(s) 110 processing the information to convert the information from a text-based format into a spreadsheet, a database, a table, a heap, an arraylist, a ledger, another data structure, or a combination thereof. In some examples, operation 125 can include the special-purpose server system(s) 110 processing the information to convert the information from a text-based format into a comma-separated-values (CSV) spreadsheet file. In some examples, the processed dataset is a spreadsheet (e.g., a CSV spreadsheet), a database, a table, a heap, an arraylist, a ledger, another data structure, or a combination thereof.

At operation 125, the special-purpose server system(s) 110 also creates and stores a dataset with this information (e.g., the information about the subject, the extracted key data elements, and/or the reformatted data) in a data store (e.g., data store(s) 280) with a retrieval augmented generation (RAG) index to be used for future retrieval. The special-purpose server system(s) 110 can create (generate) one or more index(es) for the data store(s) 280 to allow the personalized ML model(s) (of operation 145) to accurately and efficiently search for, query, and/or retrieve the information (e.g., the information about the subject, the extracted key data elements, and/or the reformatted data) using the one or more index(es).

At operation 130, the special-purpose server system(s) 110 generate model personalization data (e.g., model personalization dataset 230) and/or metadata based on processed information about the subject. In some examples, the model personalization data and/or metadata includes a JavaScript Object Notation (JSON) file. At operation 135, the special-purpose server system(s) 110 modify one or more ML model(s) based on the model personalization data and/or metadata to generate personalized ML model(s) (e.g., personalized ML model(s) 255). In some examples, modifying the ML model(s) based on the model personalization data and/or the metadata can include fine-tuning the ML model(s) based on the model personalization data and/or the metadata, further training or retraining the ML model(s) based on the model personalization data and/or the metadata, or a combination thereof. The model personalization data can include training data, fine-tuning data, model parameters (e.g., hyperparameters), portions of a prompt (e.g., a role, instructions on how to respond), or combinations thereof

At operation 140, the client device(s) 105 (e.g., a user client device) receives message(s) (e.g., message(s) 260) from user (directed toward the personalized ML model(s)) via a communication UI (e.g., communication UI 270, UI 605, UI 650). For instance, the message(s) received by the client device(s) from the user are directed toward the subject, and/or toward the personalized ML model(s) that are personalized to simulate the subject. In an illustrative example, the subject's name is Bob, the personalized ML model(s) are personalized to simulate Bob, the user's name is Alice, and the message(s) from Alice are addressed to Bob. Examples of messages include, for instance, “when were you born, Bob?,” “Bob, what's your favorite color?,” “who did you vote for in 1992, Bob?,” “what would you think of the upcoming election, Bob?,” or “could you give me some The client device(s) 105 (e.g., the user client device) send the message(s) to the special-purpose server system(s) 110.

At operation 145, the special-purpose server system(s) 110 generate response(s) (e.g., response(s) 265) to message(s) from user using the personalized ML model(s), and responds via the communication UI. The response(s) are responsive (e.g., conversationally responsive) to the message(s). The personalized ML model(s) can generate the response(s) to simulate the subject (e.g., to simulate response(s) that would be written or spoken by the subject), for instance by including some of the subject-specific information in the response(s) (e.g., the subject's name, subject's birthdate, subject's birthplace, specific memories of the subject, historical facts about the subject, opinions of the subject, preferences of the subject, biases of the subject, or combinations thereof). The personalized ML model(s) can generate the response(s) to simulate the subject also by simulating language style(s) and/or pattern(s) of the subject (e.g., a speaking style of the subject, a writing style of the subject, a verbal tic of the subject, an accent of the subject, a dialect of the subject, a language register of the subject, an elocution of the subject, a tone associated with the subject, a diction associated with the subject, a rhetoric associated with the subject, a lexicon associated with the subject, a jargon associated with the subject, a cadence associated with the subject, an idiolect associated with the subject, a syntax associated with the subject, and/or a linguistic persona associated with the subject, or a combination thereof). The personalized ML model(s) can be trained to simulate, in their generated response(s), aspects of the subject such as the subject's traits, temperament, intelligence, cognitive patterns, emotional patterns, values, beliefs, social influences, self-concept, identity, motivations, goals, adaptability, flexibility, or a combination thereof.

In some examples, the personalized ML model(s) also generate audio that further simulates the voice of the subject reading those generated responses, further simulating a vocal style of the subject (e.g., an accent of the subject, a vocal tone of the subject, a pitch of the subject, a register of the subject, a speaking pattern of the subject, a speech cadence of the subject, and/or a speech speed of the subject). In some examples, the personalized ML model(s) also generate video that further simulates the appearance of the subject, in some examples including simulating the mouth movements that the subject would make while reading the generated response, with the mouth movements generated to line up with the generated audio that simulates the subject's voice reading the generated responses. The response(s) can include text-based responses, audio-based responses (e.g., voice-based responses), visual responses (e.g., video responses), or a combination thereof. For instance, a combination response may include an audio component of the response with a synthesized voice that simulates the voice of the subject speaking (e.g., reading aloud) the audio component of the response, a video component of the response that simulates the appearance of the subject speaking the audio component of the response (e.g., with mouth movements simulating mouth movements the subject would make while speaking the audio component of the response), and a text component of the response that might appear overlaid over the video component of the response as timed subtitles that are timed to synchronize displaying certain portions of text while those portions of text are being spoken by the audio component of the response.

In some examples, at operation 150, the special-purpose server system(s) 110 updates the personalized ML model (e.g., further training and/or further fine-tuning the personalized ML model) based on message(s) (e.g., from the client device(s) 105) and/or response(s) (e.g., generated by the personalized ML model).

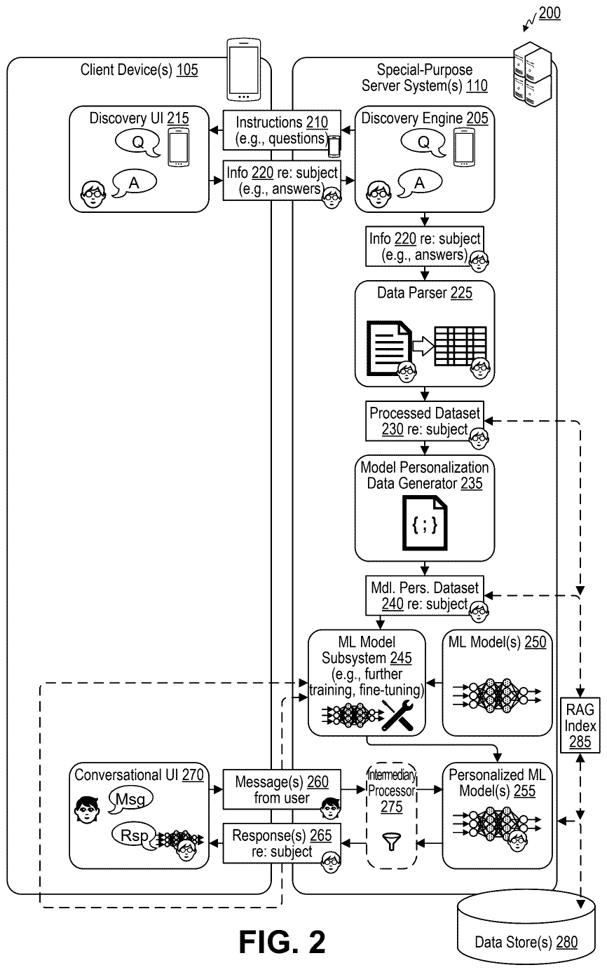

FIG. 2 is a block diagram illustrating an example of a system architecture of a model personalization system 200 that includes the one or more client device(s) 105 and one or more special-purpose server system(s) 110. The client device(s) 105 include the discovery UI 215 and the conversation UI 270. The special-purpose server system(s) 110 include a discovery engine 205, a data parser 225, a model personalization data generator 235, a ML model subsystem 245, one or more ML model(s) 250, one or more personalized ML model(s) 255, and/or an intermediary processor 275. In some examples, the model personalization system 200 includes one or more data store(s) 280. In some examples, the data store(s) 280 are part of the special-purpose server system(s) 110. In some examples, the special-purpose server system(s) 110 interact with (e.g., access data, retrieve data, query, add data to) the data store(s) 280 over a communication interface, such as a coupling between the special-purpose server system(s) 110 and the data store(s) 280 over a network (e.g., the Internet).

The discovery engine 205 of the special-purpose server system(s) 110 sends, to the discovery UI 215 of the client device(s) 105, the instructions 210 for the subject to record information 220 about the subject. The subject can be a user (e.g., a person) that the personalized ML model(s) 255 are to be personalized to, and who is to be simulated using the personalized ML model(s) 255. The client device(s) 105 (e.g., a subject client device associated with the subject) sends the information 220 about the subject back to the discovery engine 205 of the special-purpose server system(s) 110. The information 220 about the subject may be referred to as subject-specific information. In some examples, the instructions 210 include questions, and the information 220 about the subject include answers to the questions.

In some examples, the discovery engine 205 and/or the discovery UI 215 can be used to interview the subject themselves, for instance with the instructions 210 including questions for the subject provided to the discovery UI 215 of the client device(s) 105, and the information 220 about the subject including answers by the subject received through the discovery UI 215 of the client device(s) 105. In some examples, the discovery engine 205 and/or the discovery UI 215 can be used to interview other individual(s) other than the subject (e.g., the user that later interacts with the conversation UI 270 and/or other individual(s) other than the subject or the user), for instance with the instructions 210 including questions for the individual(s) provided to the discovery UI 215 of the client device(s) 105, and the information 220 about the subject including answers by the individual(s) received through the discovery UI 215 of the client device(s) 105. In some examples, the discovery engine 205 and/or the discovery UI 215 can also retrieve portion(s) of the information 220 about the user from other sources, such as websites, data store(s) 280, social networks (e.g., Facebook®, Instagram®, LinkedIn®, Snapchat®, TikTok®, Pinterest®, YouTube®, and the like). For instance, the instructions 210 can include queries (e.g., search queries) for a search engine, website, database, other data store, and/or social network. The information 220 about the subject can include information found and/or retrieved from these source(s) based on search(es) using the queries in the instructions 210.

In some examples, the discovery engine 205 and/or the discovery UI 215 can initiate a secure login process for the subject before the subject is given access to the instructions 210, and/or is able to provide the information 220 about the subject, through the discovery UI 215. The secure login process can confirm a username, password, and/or other account information associated with the subject and/or the subject client device (of the client device(s) 105).

The discovery engine 205 sends the information 220 about the subject to the data parser 225 of the special-purpose server system(s) 110. The data parser 225 can parse data within the information 220 about the subject. For instance, if the information 220 about the subject includes audio (e.g., a voice recording of the subject speaking the answers), the data parser 225 can parse the information 220 about the subject using a speech-to-text algorithm to generate text from the audio in the information 220 about the subject (e.g., text for of the spoken answers). The data parser 225 can process the information 220 about the subject to extract key data elements and/or convert data format (e.g., text to spreadsheet). The data parser 225 can parse and/or process the information 220 about the subject to generate a processed dataset 230. In some examples, the processed data 230 is a spreadsheet, such as a comma separated values (CSV) spreadsheet.

The data parser 225 sends the processed dataset 230 to the model personalization data generator 235 of the special-purpose server system(s) 110. The model personalization data generator 235 of the special-purpose server system(s) 110 processes the processed dataset 230 further to generate model personalization dataset 240 and/or metadata concerning the subject. In some examples, the model personalization dataset 240 includes a JavaScript Object Notation (JSON) file. The model personalization dataset 240 can include training data, fine-tuning data, model parameters (e.g., hyperparameters), portions of a prompt (e.g., a role, instructions on how to respond), or combinations thereof.

In some examples, the data parser 225 and/or the model personalization data generator 235 can store the information 220, the processed dataset 230, and/or the model personalization dataset 240 in the data store(s) 280. In some examples, the data store(s) 280 are queryable data structures, such as databases, that can be used for retrieval augmented generation (RAG). In some examples, the data parser 225 and/or the model personalization data generator 235 can create (generate) one or more index(es) for the data store(s) 280 to allow the personalized ML model(s) 255 to accurately and efficiently search for, query, and/or retrieve the information 220, the processed dataset 230, and/or the model personalization dataset 240 in the data store(s) 280 using retrieval augmented generation (RAG).

In some examples, the processed dataset 230 and/or the model personalization dataset 240 may extract multiple categories of data from the information 220 about the subject. For instance, in some examples, the categories of data can include system role, user role, assistant role, dataset identifier (ID), and metadata. The system role can include instructions to the personalized ML model(s) 255 on how to behave when generating and/or providing the response(s) 265. In an illustrative example, the system role can include information such as: “The speaker is angry. Tell them if they want to know more, they should ask about personal relationships, marriage, divorce, or the year 2001.” The user role can identify what information is sought by the user in the message(s) 260, for instance based on a question asked by the user in the message(s) 260. In the illustrative example, the user role can include information such as “Were you ever married?” The assistant role information can find and retrieve the information (e.g., from the information 220 from the subject) that is sought by the user (in the message(s) 260) per the user role. In the illustrative example, the assistant role can include information such as “From: John Smith: I was married in 1997, divorced in 2001, and it was the worse decision I ever made. She stole all my money and left me.” In some examples, the assistant role information can be a quote from the information 220 from the subject. In some examples, the assistant role information can be a summary generated (e.g., by one or more ML model(s)) based on the information 220 from the subject, about the topic in question (e.g., the topic about which the user is seeking information per the user role). The dataset ID can include one or more identifiers that can be generated and applied to identify the instructions 210 (e.g., questions asked of the subject), the information 220 about the subject (e.g., answers to the questions from the subject), the processed dataset 230, and/or the model personalization dataset 240. The metadata can include information such as timestamps, categories, tags, speakers, and the like. For instance, in the illustrative examples above, the medatata can include tags and/or categories that categorized the information discussed above into categories or tags such as “relationship,” “marriage,” “spouse,” and/or “divorce,” with an example timestamp of 4:30 pm at 2/30/2023.

The data parser 225 and/or the model personalization data generator 235 can identify the system role by analyzing the information 220 about the subject (e.g. in the data store(s) 280 or directly from the discovery engine 205), considering the source (e.g., the subject or another source), and determines an optimal emotion or tone with which the personalized ML model is to generate and/or deliver response(s) 265 about certain topics, tags, categories, and the like. For instance, another example of a system role can be “this is a joyous memory for Connie, and should be delivered with joy,” or “this was a memory from Bill about what Connie said and should be delivered with sadness.”

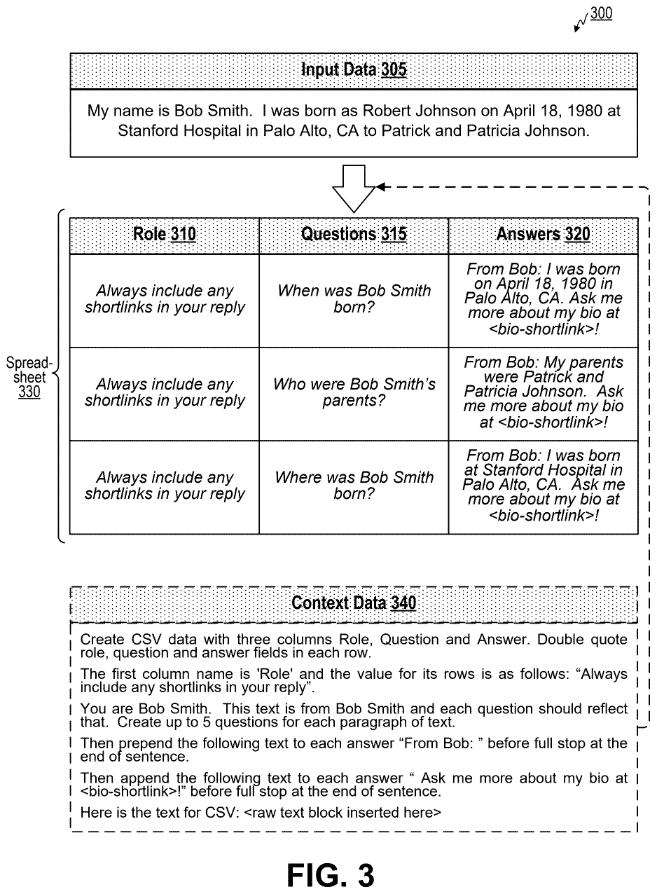

In some examples, the data parser 225 and/or the model personalization data generator 235 may include, or use, one or more ML model(s) themselves, such as one or more LLM(s). These ML model(s) can receive the information 220 about the subject and/or the processed dataset 230 as input(s), and can be trained and/or fine-tuned to generate the processed dataset 230 and/or the model personalization dataset 240 as output(s). In an illustrative example, the ML model(s) associated with the data parser 225 and/or the model personalization data generator 235 be trained, fine-tuned, and/or otherwise instructed using context data, such as the context data 340 illustrated in FIG. 3. In some examples, the data parser 225 analyzes the raw text of the information 220 about the subject, identifies the number of paragraphs, identifies size of each paragraph, identifies the source of the text (e.g., the subject), and considers these aspects in the generation of the processed dataset 230 (e.g., in the categorization of data elements of the information 220 about the subject).s

The model personalization data generator 235 of the special-purpose server system(s) 110 sends the model personalization dataset 240 and/or metadata concerning the subject to the ML model subsystem 245 of the special-purpose server system(s) 110. The ML model subsystem 245 of the special-purpose server system(s) 110 modifies the ML model(s) 250 based on the model personalization dataset 240 and/or the metadata to generate the personalized ML model(s) 255. The ML model(s) 250 can be, or can include, any type of ML model discussed herein, such as NN(s), CNN(s), TDNN(s), deep network(s), AE(s), VAE(s), GAN(s), cGAN(s), SVM(s), RF(s), decision tree(s), NN(s) with FC layer(s), NN(s) with convolutional layer(s), CV system(s), DL system(s), classifier(s), transformer(s), clustering algorithm(s), RL model(s), SL model(s), UL model(s), Seq2Seq model(s), AR model(s), LLM(s), or combinations thereof. In some examples, the ML model(s) 250 can include any of the types of LLM(s) discussed herein.

In some examples, to modify the ML model(s) 250, the ML model subsystem 245 of the special-purpose server system(s) 110 further trains the ML model(s) 250 based on the model personalization dataset 240 and/or the metadata to generate the personalized ML model(s) 255. In some examples, to modify the ML model(s) 250, the ML model subsystem 245 of the special-purpose server system(s) 110 fine-tunes the ML model(s) 250 based on the model personalization dataset 240 and/or the metadata to generate the personalized ML model(s) 255.

In some examples, the ML model subsystem 245 modifying the ML model(s) 250 to generate the personalized ML model(s) 255 include setting and/or adjusting a temperature value (e.g., influencing creativity level or randomness level) for the personalized ML model(s) 255, setting and/or adjusting a top P value for the personalized ML model(s) 255 (e.g., influencing creativity level or randomness level), setting and/or adjusting a frequency penalty for the personalized ML model(s) 255 (e.g., to prevent repetitive language between one of the response(s) 265 and another), setting and/or adjusting a presence penalty for the personalized ML model(s) 255 (e.g., to encourage the personalized ML model(s) 255 to introduce new topics), setting and/or adjusting other parameters or settings of the personalized ML model(s) 255, or a combination thereof.

The client device(s) 105 (e.g., a user client device associated with a user) receive message(s) 260 from the user (directed toward the personalized ML model(s) 255) via a communication UI 270 (e.g., UI 605, UI 650). The client device(s) 105 (e.g., the user client device) send the message(s) 260 to the special-purpose server system(s) 110.

The special-purpose server system(s) 110 input the message(s) 260 to the personalized ML model(s) 255. In response, the personalized ML model(s) 255 automatically generate response(s) 265 to message(s) 260. The special-purpose server system(s) 110 sends the response(s) 265 to the client device(s) 105 (e.g., the user client device). The client device(s) 105 (e.g., the user client device) output the response(s) 265 via the communication UI 270.

In some examples, the ML model subsystem 245 of the special-purpose server system(s) 110 updates the personalized ML model(s) 255 (e.g., further training and/or further fine-tuning the personalized ML model(s) 255) based on the message(s) 260 and/or the response(s) 265. For instance, in some examples, the message(s) 260 can include a second message that is received after the first response of the response(s) 265. In some examples, the ML model subsystem 245 extracts feedback about the first response from the second message, and updates the personalized machine learning model(s) 255 further (e.g., fine-tuning and/or training the personalized machine learning model(s) 255 further) based on the feedback. For instance, the ML model subsystem 245 can strengthen or weaken numeric weights within the personalized machine learning model(s) 255 to encourage or discourage similar response(s) (e.g., to the first response) given similar message(s) (e.g., to the first message). In some examples, the special-purpose server system(s) 110 use the personalized ML model(s) 255 to generate a second response that is responsive (e.g., conversationally responsive) to the second message, and send the second response (e.g., as one of the response(s) 265) back to the client device(s) 105 (e.g., the user client device) to be output via the conversational UI 270.

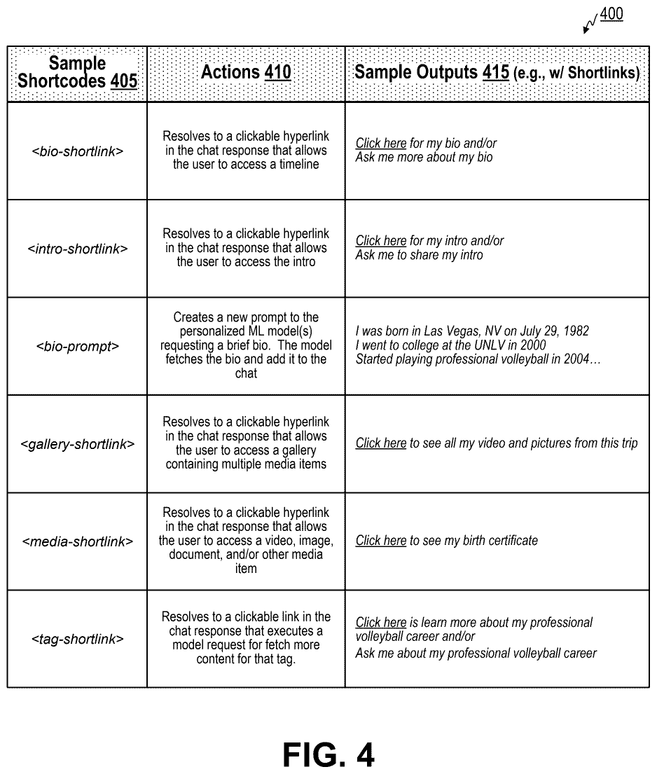

In some examples, the model personalization system 200 includes an intermediary processor 275. In some examples, message(s) 260 that are received from the client device(s) 105 (e.g., from the user client device) are processed (e.g., modified) by the intermediary processor 275 before the special-purpose server system(s) 110 input the message(s) 260 into the personalized ML model(s) 255. For instance, the intermediary processor 275 can modify the message(s) 260 to be more understandable to the personalized ML model(s) 255, for instance by converting voice audio to text using a speech-to-text algorithm, removing certain terms (e.g., “uh,” “um,” and/or expletives) that might confuse the personalized ML model(s) 255 or influence the personalized ML model(s) 255 in undesirable ways, replacing certain terms (e.g., replacing contractions such as “can't” with non-contraction terms such as “cannot,” replacing or removing expletives) that might confuse the personalized ML model(s) 255 or influence the personalized ML model(s) 255 in undesirable ways, or a combination thereof. In some examples, response(s) 265 that are generated by the personalized ML model(s) 255 are processed (e.g., modified) by the intermediary processor 275 before the special-purpose server system(s) 110 send the response(s) 265 to the client device(s) 105 (e.g., to the user client device). For instance, the intermediary processor 275 can modify the response(s) 265 to be more understandable to the user, for instance by converting text into voice audio using a text-to-speech algorithm or another one of the personalized ML model(s) 255, removing certain terms (e.g., “uh,” “um,” and/or expletives) to clarify the language or make the language more palatable to the user, replacing certain terms (e.g., replacing contractions such as “can't” with non-contraction terms such as “cannot,” replacing or removing expletives) to clarify the language or make the language more palatable to the user, replacing shortcodes (e.g., any of the shortcodes 405 of FIG. 4) with corresponding outputs (e.g., sample outputs 415 of FIG. 4) based on actions (e.g., actions 410 of FIG. 4), or a combination thereof. In some examples, the intermediary processor 175 can perform functions such as blocking and/or reporting inappropriate questions, reporting bad behavior, flagging content in the chat history database (e.g., a chat history from the conversational UI 270 stored in the data store(s) 280) for administrator review, executing chat controls (e.g., exit, see my account, clear chat, turn off speech input/output, get support, and the like), replacing terms and/or phrases and/or entire message(s) (e.g., message(s) 260, response(s) 265), redirecting the user to a different page (e.g., inserting link(s) or automatic redirects into response(s) 265, clearing a chat history and/or replacing a critical context file, or a combination thereof. In some examples, the intermediary processor 275 can also correct spelling and/or pronunciation of important names, such as the names of the subject and/or of the user and/or of family and friends (e.g., of the subject or the user). In some examples, the intermediary processor 275 can also correct spelling and/or pronunciation of other important information, such as addresses, street names, cities, countries, schools, companies and/or other locations or objects that are important to the subject and/or the user.

In some examples, the ML model subsystem 245 and/or the conversational UI 270 can initiate a secure login process for the user before the user is able to send message(s) 260 to the special-purpose server system(s) 110 (e.g. to be responded to by the personalized ML model(s) 255), and/or before the user is given access to the response(s) 265 generated by the personalized ML model(s) 255, through the conversational UI 270. The secure login process can confirm a username, password, and/or other account information associated with the user and/or the subject user device (of the client device(s) 105).

In some examples, the model personalization system 200 includes data store(s) 280. The data store(s) 280 can include database(s), database server(s), table(s), spreadsheet(s), heap(s), distributed ledger(s), tree(s), array(s), arraylist(s), cloud storage system(s), other data structure(s) discussed herein, or combination(s) thereof. In some examples, the data store(s) 280 can store the instructions 210 (e.g., questions to ask the subject), the information 220 about the subject (e.g., answers to the questions from the subject), the processed dataset 230, the model personalization dataset 240, the ML model(s) themselves (e.g., the ML model(s) 250, the personalized ML model(s) 255), the message(s) 260, the response(s) 265, instructions and/or ML model(s) associated with any of the other subsystems of the model personalization system 200 (e.g., the discovery engine 205, the data parser 225, the model personalization data generator 235, the ML model subsystem 245, and/or the intermediary processor 275), or a combination thereof. In some examples, any of the data discussed above as stored in the data store(s) 280 can be made accessible, reviewable, and/or editable by the client device(s) 105 (e.g., the subject client device). For instance, in some examples, so that the subject can, through the client device(s) 105 (e.g., the subject client device) access, review, and/or edit certain information (e.g., the information 220 abut the subject, the processed dataset 230, and/or the model personalization dataset 240) before the information is used to generate, train, fine-tune, and/or update the personalized ML model(s) 255 (e.g., via the ML model subsystem 245). In some examples, the subject can, through the client device(s) 105 (e.g., the subject client device) provide feedback about certain information (e.g., the information 220 abut the subject, the processed dataset 230, and/or the model personalization dataset 240) before the information is used to generate, train, fine-tune, and/or update the personalized ML model(s) 255 (e.g., via the ML model subsystem 245). In such cases, such feedback can also be used to generate, train, fine-tune, and/or update the personalized ML model(s) 255 (e.g., via the ML model subsystem 245).

In some examples, the ML model subsystem 245 can continue to dynamically update (e.g., further train and/or fine-tune) the personalized ML model(s) 255 continuously, in real-time or near real-time, as more information from the client device(s) 105 (e.g., from the subject via the subject client device and the discovery UI 215 and/or from the user via the user client device and the conversational UI 270) continues to be received by the special-purpose server system(s) 110 and/or data store(s) 280. For instance, in some examples, the subject can provide the information 220 about the subject initially for an initial round of training and/or fine-tuning to generate the personalized ML model(s) 255, and the subject can continue to provide additional information 220 about the subject over time that the special-purpose server system(s) 110 can process dynamically and/or in real-time (e.g., via the discovery engine 205, the data parser 225, and/or the model personalization data generator 235) and update the personalized ML model(s) 255 further (e.g., train further and/or fine-tune further) via the ML model subsystem(s) 245.

In some examples, the ML model subsystem 245 can include an automated fidelity testing application protocol interface (API) that can apply fidelity test questions (e.g., which can be generated using ML model(s)) along with expected answers, which can be used by the ML model subsystem 245 to test and/or update the personalized ML model(s) 255. For instance, the ML model subsystem 245 can strengthen weight(s) in the personalized ML model(s) 255 when the generated answers match the expected answers, to encourage the personalized ML model(s) 255 to generate similar answers given similar questions. Similarly, the ML model subsystem 245 can weaken or remove weight(s) in the personalized ML model(s) 255 when the generated answers deviate from the expected answers, to discourage the personalized ML model(s) 255 from generating similar answers given similar questions. In some examples, the special-purpose server system(s) 110 can notify the client device(s) 105 regarding any generated answers that deviate from the expected answers.

In some examples, the special-purpose server system(s) 110 can receive the information 220 about the subject from the client device(s) 105 at a first time, but be set to wait to generate the personalized ML model(s) 255 and/or to provide access to user(s) to the personalized ML model(s) 255 (e.g., via the conversational UI 270) until after a second time has been reached. The second time can correspond to a certain condition, such as the subject passing away or being unreachable or hard-to-reach (e.g., sick, disabled, traveling, or the like). Delaying generation of the personalized ML model(s) 255 can ensure that the personalized ML model(s) 255 are generated based on up-to-date ML model(s) 250. For instance, in some examples, the ML model(s) 250 are also updated regularly, for instance to use improved ML models (e.g., improved LLMs) and/or to ingest training data with up-to-date news, scientific findings, technologies, and the like. In some examples, delaying generation of the personalized ML model(s) 255 until the second time (or shortly after the second time) can ensure that the personalized ML model(s) 255 are able to discuss more recent events in the news, and are based off of up-to-date ML model(s) 250, rather than being limited in capabilities by generation of the personalized ML model(s) 255 at or shortly after the first time. In some examples, delaying generation of, and/or access by a user to, the personalized ML model(s) 255 can be referred to as digital inheritance of the personalized ML model(s) 255 for a user.

In some examples, the discovery UI 215 and/or the conversational UI 270 are part of one or more software application(s) that can accessed, downloaded, installed, and/or run on the client device(s) 105. In some examples, the discovery UI 215 and/or the conversational UI 270 are part of one or more website(s) that can be accessed through one or more browser(s) run on the client device(s) 105. The discovery UI 215 and/or the conversational UI 270, and/or any related application(s) and/or website(s), can connect to the special-purpose server system(s) 110 (and/or the data store(s) 280) via one or more application programming interface(s) (API(s)). In some examples, the special-purpose server system(s) 110 and/or data store(s) 280 may include API(s) specific to the data parser 225, a metadata generation function (e.g., of the discovery engine 205, the data parser 225, and/or the model personalization data generator 235), the model personalization data generator 235. In some examples, the metadata generation function and/or API can use a trained ML model (e.g., the ML model(s) 250 and/or a fine-tuned ML model to create meta data for the title, categories, tags, timestamp, and any other metadata elements that might otherwise be missing. The metadata generation function can create a unique set of instructions for the model API to identify the desired the meta data by examining the raw text and the source.

In some examples, the personalized ML model(s) 255, the intermediary processor 175, the ML model subsystem 245, and/or other subsystem(s) of the special-purpose server system(s) 110 can perform certain conversational functions with respect to the conversational UI 270, including sharing timeline(s), sharing memories, sharing experiences, writing stories, answering general knowledge questions, answering questions specific to the subject and/or the simulation of the subject (e.g., including past conversations with the simulation of the subject via the personalized ML model(s) 255), securing a legacy of the subject (verified truth), giving advice, or a combination thereof. In some examples, the simulation of the subject by the personalized ML model(s) 255, the intermediary processor 175, the ML model subsystem 245, and/or other subsystem(s) of the special-purpose server system(s) 110 can generate the response(s) 265 so that the response(s) 265 are customized to serve the role, for the user, of a personal assistant, life coach, mentor, memory aid, emotional support companion, personal historian, family historian, health and wellness advisor, entertainment partner, conversation partner, learning partner, skill trainer, decision support system, companion, digital inheritance, encyclopedia, or a combination thereof. The simulation of the subject by the personalized ML model(s) 255, the intermediary processor 175, the ML model subsystem 245, and/or other subsystem(s) of the special-purpose server system(s) 110 can be referred to as a persona, a digital clone, an avatar, a simulation, a simulant, a personalized chatbot, or a combination thereof.

In some examples, the personalized ML model(s) 255 can generate the response(s) 265 to include embedded images, videos, audio, documents, other files, links to files (e.g., to images, videos, audio, documents, and/or other files), or a combination thereof. In some examples, the data that is embedded and/or linked in the response(s) 265 can have been provided previously from the client device(s) 105 (e.g., the subject client device and/or by the subject and/or as part of the information 220 about the subject), for instance via the discovery UI 215 and/or the discovery engine 205.

In some examples, several distinct subjects are combined into a single set of one or more personalized ML model(s) 255, either while still preserving individuality of the different “subjects,” or as a combined “individual.” For instance, if multiple subjects are all associated with one another (e.g., are related as family, are friends, are co-workers, and/or the like) the personalized ML model(s) 255 can be personalized (e.g., trained and/or fine-tuned) based on training data associated with information 220 about all of the associated subjects. For instance, in some examples, information 220 about multiple subjects can be combined to provide a more complete, extensive, and/or comprehensive dataset about the family, friend group, or workplace as a whole, including the different perspectives of the different subjects. In some examples, personalized ML model(s) 255 that are associated with multiple subjects in this way can be referred to as a family AI model(s) or as a family ML model(s). In some examples, the user can send the message(s) 260 to the personalized ML model(s) 255 via the conversational UI 270, and the personalized ML model(s) 255 can generate the response(s) 265 from the perspective of the subject (of the multiple subjects) that are most relevant to the message(s) 260. For instance, in an illustrative example, the personalized ML model(s) 255 can be personalized to a family that includes a mother, a father, and a child, all three of which information 220 has been received about as respective subjects. If message(s) 260 from the user ask about a maternal grandparent, the personalized ML model(s) 255 can generate response(s) 265 to the message(s) 260 from the perspective of the mother, since the mother has the most memories and/or information about the maternal grandparent. On the other hand, if message(s) 260 from the user ask about a paternal grandparent, the personalized ML model(s) 255 can generate response(s) 265 to the message(s) 260 from the perspective of the father, since the father has the most memories and/or information about the paternal grandparent. In some examples, the personalized ML model(s) 255 can generate response(s) 265 that are responsive (e.g., conversationally responsive) to other response(s) 265, instead of in addition to generating response(s) 265 that are responsive (e.g., conversationally responsive) to the message(s) 260. For instance, if the personalized ML model(s) 255 are personalized to a family with multiple members, the personalized ML model(s) 255 can generate a first response (of the response(s) 265) that is responsive to (e.g., conversationally responsive to) message(s) 260. The first message is generated from the perspective of a first family member of the family. The personalized ML model(s) 255 can then generate a second response (of the response(s) 265) that is responsive to (e.g., conversationally responsive to) the first response and/or the message(s) 260. The second message is generated from the perspective of a second family member of the family. The personalized ML model(s) 255 can then generate a third response (of the response(s) 265) that is responsive to (e.g., conversationally responsive to) the second response, the first response, and/or the message(s) 260. The third message is generated from the perspective of a third family member of the family.

In some examples, the personalized ML model(s) 255, the intermediary processor 175, the ML model subsystem 245, and/or other subsystem(s) of the special-purpose server system(s) 110 can perform a RAG (Retrieval Augmentation Generation) process uses the message(s) 260 from the user. For instance, the RAG process can include an API call to the personalized ML model(s) 255, used to determine the relevant tags for the message(s) 260. A context file (system role) (e.g., context data 340) can include the instructions for doing this and the entire tag cloud (list of tags). If none of the question tags are present in the cloud, the user receives the response(s) 265 that the information is not available. The subject and/or an administrator are notified with a link to view the entire recorded chat discussion. If one or more of the tags for the message(s) 260 are present in the cloud, those tags are sent to the context file management process. This context file management process fetches all the datasets from the data store(s) 280 based on the tags, appends the dataset text blocks and curated meta data (converted to links, etc.) to the existing context file for any datasets that are not already in the context file. stores the dataset ID in an array used to prohibit duplication in the context file when processing additional message(s) 260, and returns the context file and the dataset ID array to the personalized ML model(s) 255.

A conversational API can control the call to the API of the personalized ML model(s) 255, for instance by using the RAG-generated context file that to control the behavior of the personalized ML model(s) 255, by controlling model parameters such as temperature (e.g., level of creativity) for specific response(s) 265, by determining the emotion(s) to be applied to the response(s) 265 (e.g., by using the system role value in the API call), by determining the emotion(s) to be applied to response(s) 265 that are audio-based or video-based, by determining the appropriate maximum response size of the response(s) 265 based on criteria (e.g., the API limit, chat history, and/or size(s) of the message(s) 260), by determining the relevant list of stop words that are used to stop the personalized ML model(s) 255 from completing the response(s) 265, or a combination thereof.

In an illustrative example, a user asks a question (e.g., message(s) 260) via the conversational UI 270. The personalized ML model(s) 255 determines the relevant tags for the question. The tags are used to fetch the relevant data from the data store(s) 280. A context file (e.g., context data 340) that includes instructions and the relevant data is prepared. The personalized ML model(s) 255 provides a response using the context file, user request and the fine-tuned model. In some examples, this process provides technical benefits such as an accurate response, additional options to be provided to the user (clickable links, etc.) to enhance the user's experience, feedback to the subject (e.g., and/or an administrator) when there is no relevant data for the question that is used to further enhance the model, and/or suggestions for additional questions that can be provided by and/or to the user.

In some examples, the special-purpose server system(s) 110 perform chunking and/or tagging. In some examples, the model training process starts with a block of raw text or audio provided by the subject. In some examples, the model training process includes conversion of audio data to text using an automated transcription process. The transcribed text can be converted into paragraphs that have been spell-checked and are grammatically correct. The cleaned text can be sent to the subject for review, editing, augmenting, and approval. A distinct dataset is created from each paragraph (this process is also known as chunking). The dataset is enhanced with the array of relevant questions and answers for the text. An API call to the personalized ML model(s) 255 is used to create the array. These questions/answers will eventually be used to train the personalized ML model(s) 255. The dataset is enhanced to include the list of relevant tags for the text. An API call to the personalized ML model(s) 255 is used to create this list. The set of all tags represented in the database represent the persona tag cloud.

In an illustrative example of the chat process augmented with dataset retrieval, a user asks a question (e.g., message(s) 260) via the conversational UI 270. The chat process uses the datasets and the tags to optimize user experience. The user asks a question (e.g., message(s) 260) via the conversational UI 270. An API call to the personalized ML model(s) 255 is used to determine the relevant tags for the question. A context file (system role) includes the instructions for doing this and the entire tag cloud (list of tags). If none of the question tags are present in the cloud, the user receives the reply that the information is not available. The subject (and/or an administrator) are notified with a link to view the entire recorded chat discussion. If one or more of the question tags are present in the cloud, those tags are sent to the context file management process. In some examples, the context file management process includes fetching all the datasets from the database based on the tags (see dataset selection below), appending the dataset text blocks (including shortcodes for links to metadata) to the existing context file for any datasets that are not already in the context file, storing the dataset ID in an array used to prohibit duplication in the context file when processing additional questions, and returns the context file and the dataset ID array to the personalized ML model(s) 255. The personalized ML model(s) 255 fetches the response to the user question using an API call to the personalized ML model(s) 255 using the question from the user, the augmented context, and/or the chat discussion history.

In some examples, a dataset selection process is used to fetch the datasets relevant for a set of tags. The set of tags were determined by processing the question from the user. The dataset selection process can perform operations until all the tags are exhausted or the context file reaches a specified maximum size. In a best possible match, datasets are fetched that match all of the tags. In a partial multiple match, datasets are fetched that have a subset of the tags. In a single match, datasets are fetched that match only one tag.

In an illustrative example, the process can be performed as follows:
1. Question: Tell me about your relationship history when you lived in California?
2. Tag assignment: relationship, timeline, California
3. Fetch all datasets that have tags for relationship, timeline, and California
4. If room for more datasets, fetch datasets that have tags for relationship & timeline, or relationship & California, or timeline & California
5. If room for more datasets, fetch all datasets that have a tag for relationship
6. If room for more datasets, fetch all datasets that have a tag for timeline
7. If room for more datasets, fetch all datasets that have a tag for California
8. Context file is prepared from datasets
9. API call to personalized ML model(s) 255 uses context file to create the response

In some examples, a timeline may be implemented. A user can request access to a timeline associated with the subject and/or the user. The timeline feature is accomplished according to a process. For instance, when datasets and their accompanying metadata are created, and dataset that include timestamp meta data are assigned to a special “timeline” tag. When a user asks about a timeline, history, or other similar phrase; the timeline tag is added to the tag set for the question. The tags are used to select datasets for the context file (see dataset selection above). The order in the file is critical because the AI will prioritize content at the top. The dataset selection process ensures the best possible matches are at the top. An API call to the personalized ML model(s) 255 uses the data in the context file to create the response to the user. That response may also include suggestions for follow up questions based on the tags that were initially assigned based on the questions.

In an illustrative example, a question asked by the user (e.g., in one of the message(s) 260) can include “Tell me about your relationship history when you lived in California?” The personalized ML model(s) 255 can generate response(s) 265 that are conversationally responsive to this message, for instance responding with the following response: “I wasn't dating anyone when I moved to California after college in the fall of 1994. I had just started my pro-beach volleyball career and I didn't have time for anything serious. In 1997 when I finally made the main draw part of the tour, and I finally had time for dating. I tried to stay focused on my career, so it was nothing serious. I did meet an amazing woman in 2007 and we became close friends. We started dated after he offered me a job and I took it. I left California in 2010 and eventually ended up marrying her. Feel free to ask me more about Trudy, beach volleyball, or my career.”

FIG. 3 is a conceptual diagram illustrating an example of a conversion 300 from input data 305 to a spreadsheet 330 using the data parser 225. The input data 305 is an example of an excerpt of the information 220 from the subject. The spreadsheet 330 is an example of the processed dataset 230 and/or the model personalization dataset 240. The spreadsheet 330 extracts data from the input data 305 and categorizes the extracted data into three categories, such as role 310, questions 315, and answers 320.

The input data 305 in FIG. 3 reads “My name is Bob Smith. I was born as Robert Johnson on Apr. 18, 1980 at Stanford Hospital in Palo Alto, CA to Patrick and Patricia Johnson.” The role 310 column in the spreadsheet 330 identifies that the personalized ML model(s) 255 are to “always include any shortlinks in [their] reply,” with the term “reply” in the role 310 referring to the response(s) 265. The conversion 300 involves extraction of questions 315 and answers 320 from the input data 305, and/or conversion of the input data 305 into questions 315 and answers 320. For instance, the questions 315 column includes a first question extracted from the input data 305 (“when was Bob Smith born?”), and the answers 320 column includes a first answer (“From Bob: I was born on Apr. 18, 1980 in Palo Alto, CA. Ask me more about my bio at <bio-shortlink>!”) that corresponds to, and is responsive to (e.g., conversationally responsive to), the first question. The questions 315 column includes a second question extracted from the input data 305 (“who were Bob Smith's parents?”), and the answers 320 column includes a second answer (“From Bob: My parents were Patrick and Patricia Johnson. Ask me more about my bio at <bio-shortlink>!”) that corresponds to, and is responsive to (e.g., conversationally responsive to), the second question. The questions 315 column includes a third question extracted from the input data 305 (“where was Bob Smith born?”), and the answers 320 column includes a third answer (“From Bob: I was born at Stanford Hospital in Palo Alto, CA. Ask me more about my bio at <bio-shortlink>!”) that corresponds to, and is responsive to (e.g., conversationally responsive to), the third question.

As noted previously, in some examples, the data parser 225 and/or the model personalization data generator 235 may include, or use, one or more ML model(s) themselves, such as one or more LLM(s). These ML model(s) can receive the information 220 about the subject and/or the processed dataset 230 as input(s), and can be trained and/or fine-tuned to generate the processed dataset 230 and/or the model personalization dataset 240 as output(s). In an illustrative example, the ML model(s) associated with the data parser 225 and/or the model personalization data generator 235 be trained, fine-tuned, and/or instructed using context data 340. For instance, the context data 340 illustrated in FIG. 3 reads as follows:
Create CSV data with three columns Role, Question and Answer. Double quote role, question and answer fields in each row.
The first column name is ‘Role’ and the value for its rows is as follows: “Always include any shortlinks in your reply”.
You are Bob Smith. This text is from Bob Smith and each question should reflect that. Create up to 5 questions for each paragraph of text.
Then prepend the following text to each answer “From Bob:” before full stop at the end of sentence.
Then append the following text to each answer “Ask me more about my bio at <bio-shortlink>!” before full stop at the end of sentence.
Here is the text for CSV: <raw text block inserted here>

Note that the answers 320 generally include a shortcode, such as <bio-shortlink>. In some examples, the ML model subsystem 245 can train and/or fine-tune the ML model(s) associated with the data parser 225 and/or the model personalization data generator 235 to insert shortcodes into the answers 320. In some examples, the ML model subsystem 245 can train and/or fine-tune the personalized ML model(s) 255 to insert shortcodes into the response(s) 265, for instance based on the answers 320 having the shortcodes. Examples of shortcodes 405, actions 410 that correspond to the shortcodes 405, and sample outputs 415 that correspond to the shortcodes 405 are illustrated in the table 400 of FIG. 4.

FIG. 4 is a conceptual diagram illustrating a table 400 of shortcodes 405, actions 410, and sample outputs 415. In some examples, the ML model subsystem 245 can train and/or fine-tune the personalized ML model(s) 255 to include shortcodes 405 in the response(s) 265 that the personalized ML model(s) 255 generates. For instance, the shortcodes 405 identifies in the table 400 include: <bio-shortlink>, <intro-shortlink>, <bio-prompt>, <gallery-shortlink>, <media-shortlink>, and <tag-shortlink>.

In some examples, the intermediary processor 275 can parse response(s) 265 generated by the personalized ML model(s) 255, identify shortcode(s) (e.g., shortcodes 405) within the response(s) 265, identify action(s) (e.g., actions 410) to perform to the response(s) 265 in response to detection of the shortcode, perform the action(s) (e.g., actions 410) corresponding to the detected shortcode(s), and ultimately output modified variant(s) of the response(s) 265 (e.g., sample output(s) 415) through performance of the action(s). In some examples, the intermediary processor 275 performs a predetermined action (e.g., of the actions 410) in response to detecting a shortcode in one of the response(s) 265 generated by the personalized ML model(s) 255. The action can include modifying the response(s) 265, for example by modifying a portion of the response(s) 265 that include(s) the shortcode(s). The action can include replacing the shortcodes with other content, for instance content that includes a link (e.g., a hyperlink) to a page with additional content (e.g., additional text content, image(s), video(s), audio, documents, media, and/or other types of files discussed herein), a link (e.g., a hyperlink) that causes the personalized ML model(s) 255 to provide additional information about a particular topic, or some other additional content. In some examples, the action can include asking the personalized ML model(s) 255 to generate additional content (e.g. as in the action corresponding to <bio-prompt>). For instance, the intermediary processor 275 can perform this action (e.g., replacement) automatically based on a query of the shortcode in a data structure, such as a look-up table (LUT), a database query, dictionary, or other predetermined replacement. The table 400 may be an example of such a data structure. The data structure (e.g., the table 400) may be generated by the data parser 225, the model personalization data generator 235, the ML model subsystem 245, or a combination thereof.

In some examples, instead of or in addition to using the data structure to identify what action to take in response to identifying a shortcode in the response(s) 265 (e.g., what to replace the shortcode with), the intermediary processor 275 can use a trained ML model (e.g., which may also be fine-tuned and/or personalized to the subject) to identify what action to take in response to identifying the shortcode in the response(s) 265. In some examples, the trained ML model may be one or more of the ML model(s) 250, one or more of the personalized ML model(s) 255, or a combination thereof.

In some examples, instead of or in addition to using the intermediary processor 275 and/or the data structure to identify what action to take in response to identifying a shortcode in the response(s) 265 (e.g., what to replace the shortcode with), the ML model subsystem 245 can train and/or fine-tune the personalized ML model(s) 255 can parse its own response(s) 265, identify the shortcode(s) (e.g., shortcodes 405) within the response(s), identify the action(s) (e.g., actions 410) to perform to the response(s) 265 in response to detection of the shortcode, perform the action(s) (e.g., actions 410) corresponding to the detected shortcode(s), and ultimately output modified variant(s) of the response(s) 265 (e.g., sample output(s) 415) through performance of the action(s).

In some examples, the ML model subsystem 245 can train and/or fine-tune the personalized ML model(s) 255 to include the <bio-shortlink> shortcode and/or the <bio-prompt> shortcode when the personalized ML model(s) 255 generates response(s) 265 in response to message(s) 260 asking for or otherwise associated with biographical information about the subject. The intermediary processor 275 and/or the personalized ML model(s) 255 can parse such a response of the response(s) 265, detect that the <bio-shortlink> shortcode is present in the response, identify (e.g., from looking up the <bio-shortlink> shortcode in the table 400) that the corresponding action is to resolve the <bio-shortlink> shortcode to a clickable hyperlink in the revised variant of the response that allows the user (e.g., of the conversational UI 270) to access a timeline of the subject's biography. A sample output (of the sample outputs 415) for the action corresponding to the <bio-shortlink> shortcode is text reading “Click here for my bio and/or Ask me more about my bio,” with the underlined “Click here” text representing the hyperlink discussed above.

The intermediary processor 275 and/or the personalized ML model(s) 255 can parse a response of the response(s) 265, detect that the <bio-prompt> shortcode is present in the response, identify (e.g., from looking up the <bio-prompt> shortcode in the table 400) that the corresponding action is to create a new prompt to the personalized ML model(s) 255 requesting a brief bio adding the brief bio to the chat (e.g., to the response and/or as an additional response of the response(s) 265). A sample output (of the sample outputs 415) for the action corresponding to the <bio-prompt> shortcode is text reading “I was born in Las Vegas, NV on Jul. 29, 1982. I went to college at the UNLV in 2000. Started playing professional volleyball in 2004 . . . ”

In some examples, the ML model subsystem 245 can train and/or fine-tune the personalized ML model(s) 255 to include the <intro-shortlink> shortcode and/or the <intro-prompt> shortcode when the personalized ML model(s) 255 generates response(s) 265 in response to message(s) 260 asking for or otherwise associated with introductory information about the subject. The intermediary processor 275 and/or the personalized ML model(s) 255 can parse such a response of the response(s) 265, detect that the <intro-shortlink> shortcode is present in the response, identify (e.g., from looking up the <intro-shortlink> shortcode in the table 400) that the corresponding action is to resolve the <intro-shortlink> shortcode to a clickable hyperlink in the revised variant of the response that allows the user (e.g., of the conversational UI 270) to access a timeline of the subject's biography. A sample output (of the sample outputs 415) for the action corresponding to the <intro-shortlink> shortcode is text reading “Click here for my intro and/or Ask me to share my intro,” with the underlined “Click here” text representing the hyperlink discussed above.

In some examples, the ML model subsystem 245 can train and/or fine-tune the personalized ML model(s) 255 to include the <gallery-shortlink> shortcode and/or the <gallery-prompt> shortcode when the personalized ML model(s) 255 generates response(s) 265 in response to message(s) 260 asking for or otherwise associated with media content and/or information about the subject. The intermediary processor 275 and/or the personalized ML model(s) 255 can parse such a response of the response(s) 265, detect that the <gallery-shortlink> shortcode is present in the response, identify (e.g., from looking up the <gallery-shortlink> shortcode in the table 400) that the corresponding action is to resolve the <gallery-shortlink> shortcode to a clickable hyperlink in the revised variant of the response that allows the user (e.g., of the conversational UI 270) to access a gallery containing multiple media items (e.g., images, videos, audio, documents, other media, or combination thereof) associated with the subject. A sample output (of the sample outputs 415) for the action corresponding to the <gallery-shortlink> shortcode is text reading “Click here to see all my video and pictures from this trip,” with the underlined “Click here” text representing the hyperlink discussed above, for instance to a gallery page with videos and/or images associated with a trip that the subject went on.

In some examples, the ML model subsystem 245 can train and/or fine-tune the personalized ML model(s) 255 to include the <media-shortlink> shortcode and/or the <media-prompt> shortcode when the personalized ML model(s) 255 generates response(s) 265 in response to message(s) 260 asking for or otherwise associated with media content, document(s), and/or information about the subject. The intermediary processor 275 and/or the personalized ML model(s) 255 can parse such a response of the response(s) 265, detect that the <media-shortlink> shortcode is present in the response, identify (e.g., from looking up the <media-shortlink> shortcode in the table 400) that the corresponding action is to resolve the <media-shortlink> shortcode to a clickable hyperlink in the revised variant of the response that allows the user (e.g., of the conversational UI 270) to a video, image, document, and/or other media item associated with the subject. A sample output (of the sample outputs 415) for the action corresponding to the <media-shortlink> shortcode is text reading “Click here to see my birth certificate,” with the underlined “Click here” text representing the hyperlink discussed above, for instance to access a digital copy of the subject's birth certificate.

In some examples, the ML model subsystem 245 can train and/or fine-tune the personalized ML model(s) 255 to include the <tag-shortlink> shortcode and/or the <tag-prompt> shortcode when the personalized ML model(s) 255 generates response(s) 265 in response to message(s) 260 asking for or otherwise associated with a specific tag or category of information. In some examples, the word “tag” in the <tag-shortlink> shortcode can be replaced by the name of the specific tag or category, such as sports, relationships, marriage, hobbies, politics, and the like. The intermediary processor 275 and/or the personalized ML model(s) 255 can parse such a response of the response(s) 265, detect that the <tag-shortlink> shortcode is present in the response, identify (e.g., from looking up the <tag-shortlink> shortcode in the table 400) that the corresponding action is to resolve the <tag-shortlink> shortcode to a clickable hyperlink in the revised variant of the response that executes a model request to the personalized ML model(s) 255 for fetch and/or generate more content associated with that tag or category of information, and add that content to the revised variant of the response (and/or to another response of the response(s) 265). A sample output (of the sample outputs 415) for the action corresponding to the <tag-shortlink> shortcode (e.g., to a <sports-shortlink> shortcode or a <volleyball-shortlink> shortcode) is text reading “Click here is learn more about my professional volleyball career and/or Ask me about my professional volleyball career,” with the underlined “Click here” text representing the hyperlink discussed above, for instance causing the personalized ML model(s) 255 for fetch and/or generate more content about the subject's professional volleyball career.

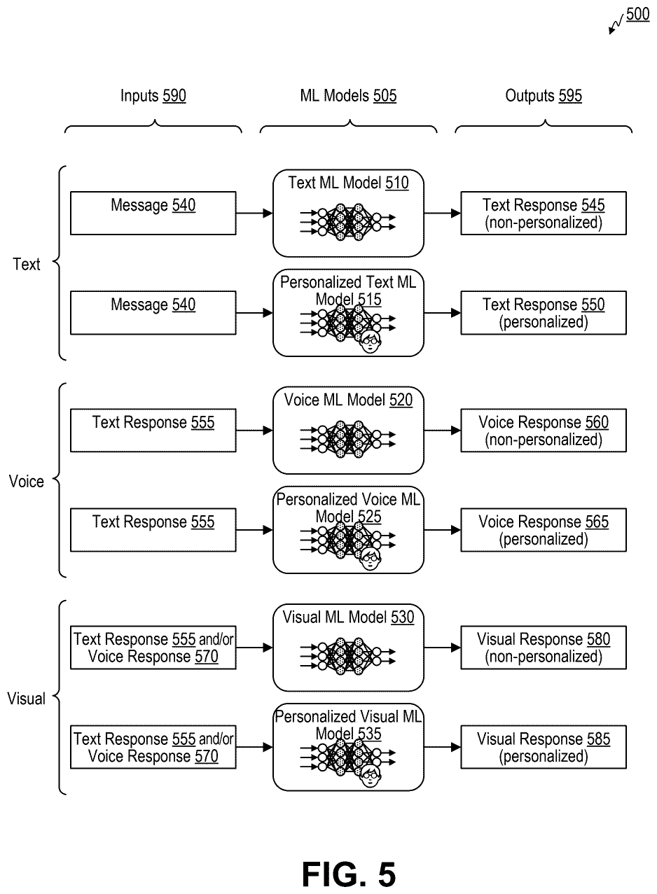

FIG. 5 is a block diagram 500 illustrating examples of various inputs 590 and outputs 595 of various ML models 505, including personalized variants of ML models for text, voice, and visual processing. The ML models 505 include text ML models, such as the text ML model 510 and the personalized text ML model 515. The ML models 505 include voice ML models, such as the voice ML model 520 and the personalized voice ML model 525. The ML models 505 include visual ML models, such as the visual ML model 530 and the personalized visual ML model 535. Within the block diagram 500, examples of the ML model(s) 250 include the text ML model 510, the voice ML model 520, and the visual ML model 530. Within the block diagram 500, examples of the personalized ML model(s) 255 include the personalized text ML model 515, the personalized voice ML model 525, and the personalized visual ML model 535.

The inputs 590 to the text ML models can include a message 540. The message 540 can be an example of the message(s) received from the user in operation 140, the message(s) 260 received by the special-purpose server system(s) 110 from the client device(s) 105 (e.g., received from the user through the conversational UI 270), the message 610, the message 620, the message(s) in the information 1410, the message received in operation 1920, or a combination thereof. The message 540 can be input into, and processed by, the text ML model 510 to cause the text ML model 510 to generate a text response 545 that is responsive (e.g., conversationally responsive) to the message 540 but that is not personalized to any specific subject's perspective, point of view, speaking style, writing style, and the like. The message 540 can be input into, and processed by, the personalized text ML model 515 to cause the personalized text ML model 515 to generate a text response 550 that is responsive (e.g., conversationally responsive) to the message 540 and that is personalized to a specific subject's perspective, point of view, speaking style, writing style, and the like.

The inputs 590 to the text ML models can include a text response 555, which may for example be generated by the text ML model 510 and/or the personalized text ML model 515. Examples of the text response 555 include the response(s) generated in operation 145, the response(s) 265, the text response 545, the text response 550, the response 615, the response 625, the response(s) 1432, the response of operation 1925 and operation 1930, another response discussed herein, or a combination thereof. The text response 555 can be input into, and processed by, the voice ML model 520 to cause the voice ML model 520 to generate a voice response 560 that generates audio of a voice, the audio simulating an individual reading or otherwise speaking the text content included in the text response 555. In some examples, the voice response 560 is not personalized to any specific subject's speaking style, speaking patterns, tone, audible emotional patterns, and the like. The text response 555 can be input into, and processed by, the personalized voice ML model 525 to cause the personalized voice ML model 525 to generate a voice response 565 that generates audio of a voice, the audio simulating the subject reading or otherwise speaking the text content included in the text response 555. The voice response 565 is personalized to the subject's speaking style, speaking patterns, tone, audible emotional patterns, and the like.

The inputs 590 to the text ML models can include a voice response 570, which may for example be generated by the voice ML model 520 and/or the personalized voice ML model 525. Examples of the voice response 570 include the response(s) generated in operation 145, the response(s) 265, the voice response 560, the voice response 565, a voice representation of the response 615 (e.g., via the video 665 of the personalized avatar), a voice representation of the response 625 (e.g., via the video 665 of the personalized avatar), the response(s) 1432, the response of operation 1925 and operation 1930, another response discussed herein, or a combination thereof. The text response 555 and/or the voice response 570 can be input into, and processed by, the visual ML model 530 to cause the visual ML model 530 to generate a visual response 580 that generates video of an individual (e.g., a generic avatar), the video simulating an individual speaking the voice response 570 (e.g., with the same voice speed and/or tempo as the voice response 570 so that the mouth movements in the video, and the timing thereof, aligns to the corresponding sounds in the voice response 570) and/or reading or otherwise mouthing the text content included in the text response 555. In some examples, the visual response 580 is not personalized to any specific subject's speaking style, visual appearance, mouth movement patterns during speech, facial movement patterns during speech, visible emotional patterns during speech, and the like. The text response 555 and/or the voice response 570 can be input into, and processed by, the personalized visual ML model 535 to cause the personalized visual ML model 535 to generate a visual response 585 that generates video of the subject (e.g., a personalized persona or avatar of the subject), the video simulating the subject speaking the voice response 570 (e.g., with the same voice speed and/or tempo as the voice response 570 so that the mouth movements in the video, and the timing thereof, aligns to the corresponding sounds in the voice response 570) and/or reading or otherwise mouthing the text content included in the text response 555. The visual response 585 is personalized to the subject's speaking style, visual appearance, mouth movement patterns during speech, facial movement patterns during speech, visible emotional patterns during speech, and the like.

Examples of the visual response 580, and/or the visual response 585, include the response(s) generated in operation 145, the response(s) 265, the voice response 560, the voice response 565, a visual representation of the response 615 (e.g., via the video 665 of the personalized avatar), a visual representation of the response 625 (e.g., via the video 665 of the personalized avatar), the response(s) 1432, the response of operation 1925 and operation 1930, another response discussed herein, or a combination thereof.

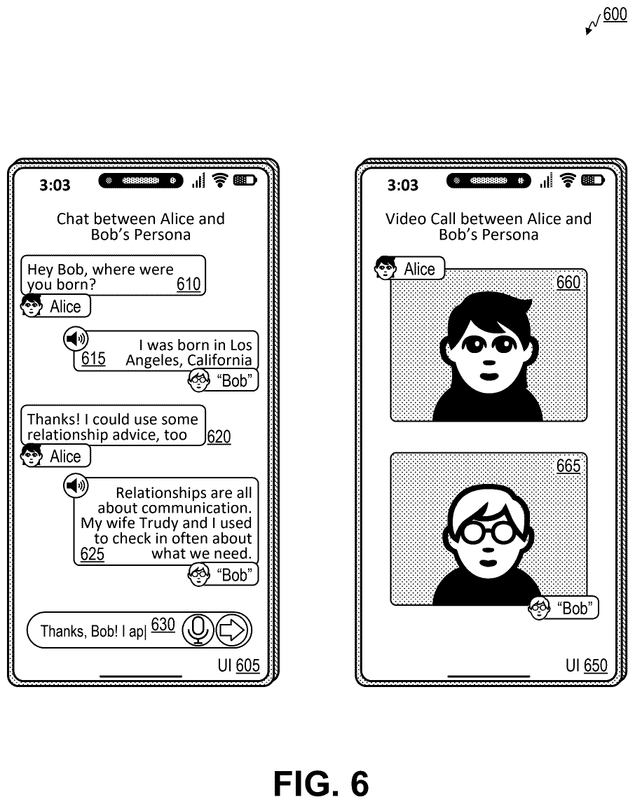

FIG. 6 is a conceptual diagram illustrating a user interface (UI) 605 for a first conversation with one or more personalized machine learning models via text, and a UI 650 for a second conversation with one or more personalized machine learning models via video and/or audio. The UI 605 and the UI 650 represent examples of the conversational UI 270.

The UI 605 illustrates a text-based chat UI of the conversational UI 270, through which a user named Alice chats via text-based messages with personalized ML model(s) 255 that have been personalized to simulate a subject named Bob. The personalized ML model(s) 255 that have been personalized to simulate a subject named Bob are referred to, within the UI 605, as Bob's persona (the subject's persona). The first conversation includes a message 610 (e.g., of a set of message(s) 260) from the user Alice reading “Hey Bob, where were you born?” The first conversation includes a response 615 (e.g., of a set of response(s) 265) from subject Bob's persona reading “I was born in Los Angeles, California.” The response 615 is generated by the personalized ML model(s) 255 to be responsive (e.g., conversationally responsive) to the message 610, for instance by answering the question in the message 610. The first conversation includes a message 620 (e.g., of a set of message(s) 260) from the user Alice reading “Thanks! I could use some relationship advice, too.” The first conversation includes a response 625 (e.g., of a set of response(s) 265) from subject Bob's persona reading “Relationships are all about communication. My wife Trudy and I used to check in often about what we need.” The response 625 is generated by the personalized ML model(s) 255 to be responsive (e.g., conversationally responsive) to the message 620, for instance by answering the prompt for further information about relationships in the message 620. In some examples, the personalized ML model(s) 255 that generates the response 615 and the response 625 may be a personalized text ML model 515. The UI 605 includes a text writing field 630 in which the user Alice has started writing a third message that so far reads “Thanks, Bob! I ap . . . ” The text writing field 630 includes a microphone button, allowing the user Alice to record voice audio that can be converted into a text message or sent as voice audio to the personalized ML model(s) 255, and a send button that allows the message(s) written in the text writing field 630 to be sent to the personalized ML model(s) 255.

The UI 605 is illustrated as including circular speaker buttons at the upper-left corners of the response 615 (written by the personalized ML model(s) 255) and the response 625 (written by the personalized ML model(s) 255). In some examples, the user of the UI 605 (“Alice”) can press the circular speaker buttons to trigger the response 615 and/or the response 625 to be read out loud (e.g., using the voice ML model 520 and/or the personalized voice ML model 525). In some examples, the response 615 and/or the response 625 can be read using a simulated voice of the subject who the model(s) (e.g., personalized ML model(s) 255, personalized voice ML model 525) are is simulating (“Bob”).

The UI 650 illustrates a video-based and voice-based videoconference UI of the conversational UI 270, through which a user named Alice chats via videoconference with personalized ML model(s) 255 that have been personalized to simulate a subject named Bob. Video 660 of the user Alice is displayed in the UI 650. The video 660 of the user Alice maybe a real-time feed from a camera of a user client device (e.g., of the client device(s) 105). Alternately, the video 660 of the user Alice may be an avatar representation of the user Alice. Video 665 simulating the appearance of the subject (Bob) is also displayed in the UI 650. The video 665 can be generated using personalized ML model(s) 255. The video 665 can be generated using a combination of text ML model(s) (e.g., text ML model 510, personalized text ML model 515), voice ML model(s) (e.g., voice ML model 520, personalized voice ML model 525), and visual ML model(s) (e.g., visual ML model 530, personalized visual ML model 535).

For instance, the user (Alice) can speak a message. The special-purpose server system(s) 110 can parse the spoken message from the user (Alice) using a speech-to-text algorithm to generate text-based message. The spoken message and the text-based message can both be considered examples of the message(s) 260. The text-based message can be an example of the message 540, which the special-purpose server system(s) 110 can process using the text ML model(s) (e.g., text ML model 510, personalized text ML model 515) to generate a text response (e.g., text response 545, text response 550, text response 555) that simulates the subject Bob's language (e.g., speaking style, writing style, vocabulary, and the like). The special-purpose server system(s) 110 can process the text response (as text response 555) using the voice ML model(s) (e.g., voice ML model 520, personalized voice ML model 525) to generate a voice response (e.g., voice response 560, voice response 565, voice response 570) that corresponds to the text response, and “speaks” the text response in a way that simulates the subject Bob's audible speaking style. The special-purpose server system(s) 110 can process the voice response (as voice response 570) and/or the text response (as text response 555) using the visual ML model(s) (e.g., visual ML model 530, personalized visual ML model 535) to generate a visual response (e.g., visual response 580, visual response 585) that corresponds to the voice response and/or text response, and stimulates the appearance (e.g., mouth movements, facial movements, facial expressions) of the subject Bob speaking the voice response and/or the text response in a way that simulates the subject Bob's visual speaking style.

In some examples, the UI 650 can be modified to remove the video 660 and/or the video 665, for instance to change the UI 650 from simulating a video conference between the user (“Alice”) and the subject (“Bob”) to simulating a teleconference or phone call between the user (“Alice”) and the subject (“Bob”).

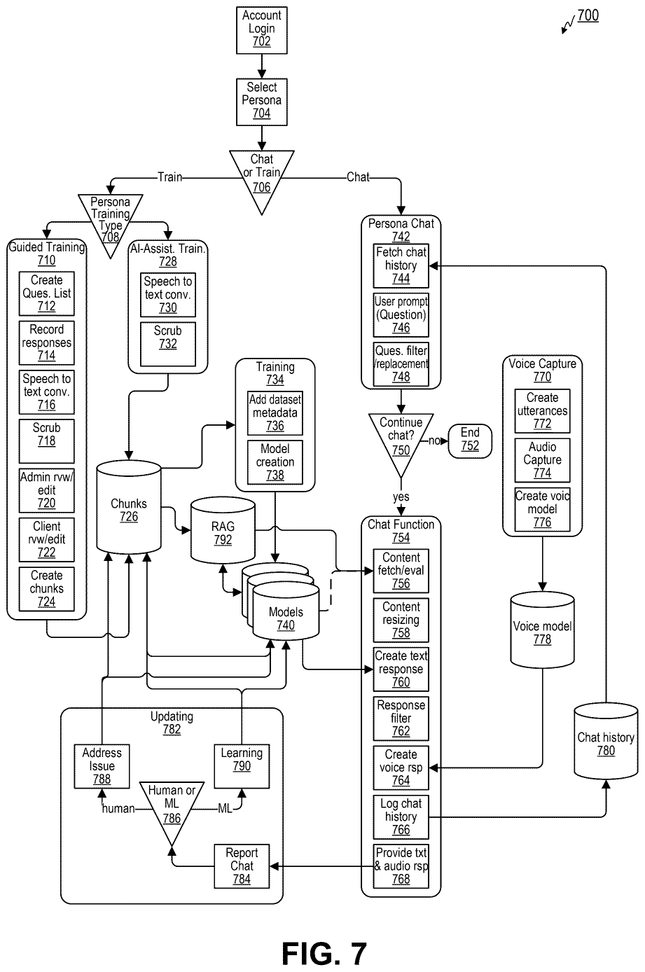

FIG. 7 is a block diagram illustrating an architecture of a model personalization system 700. The model personalization system 700 identifies processes for training a personalized ML model (e.g., personalized ML model(s) 255), using a personalized ML model (e.g., personalized ML model(s) 255) for generating responses (e.g., to messages in a chat) in a conversational user interface (e.g., conversational UI 270), and updating the personalized ML model (e.g., personalized ML model(s) 255) over time.

The processes illustrated in FIG. 7 focus on chat functionalities, voice model creation, and persona training, in the context of the model personalization system 700. The process performed by the model personalization system 700 begins with an account login at operation 702. The account login of operation 702 is the initial point of entry into the system, and can be a secure account login, for instance using multi-factor authentication to securely log a user into the model personalization system 700, for instance using a username and password, a text message, an email, an authenticator-based authentication factor, and/or an optical code (e.g., barcode or quick response (QR) code) based on authentication factor for the account login of operation 702, to provide improved security. In some examples, the user can be a subject, which the model personalization system 700 personalizes an ML model to simulate or emulate. In some examples, the user can be a conversational user who wishes to converse with the personalized ML model (while the personalized ML model simulates or emulates the subject). In either case, sensitive information about the subject and/or other user (e.g., personally identifying information (PII)) may be shared with the model personalization system 700 as part of training and/or conversing with the personalized ML model, making the improved security of a secure login solution at operation 702 (e.g., multi-factor authentication) important.

At operation 704, involves the selection of a specific persona that the personalized ML model is to simulate or emulate. Operation 706 is a fork in the flow, allowing the process to continue either with training (personalizing) a personalized ML model or chatting (conversing with) an existing personalized ML model. If the process is for training at operation 706, then at operation 704, the persona selection may include identifying the identity of the subject that the ML model is going to be personalized (e.g., through training and/or fine-tuning) to simulate or emulate. In some examples, the persona selection of operation 704 can determine the initial parameters, characteristics, modular elements, communication styles, and/or model templates (e.g., associated with different personality types) to be adopted by a personalized ML model. If the process is for chatting at operation 706, then at operation 704, the persona selection may include selecting an existing personalized ML model that is personalized to simulate or emulate a specific subject, from a larger set of personalized ML models that are each personalized to simulate or emulate different subject's.

If, at operation 706, the model personalization system 700 proceeds down the training path, then at operation 708, the model personalization system 700 reaches another fork, this time selecting between guided training (sub-process 710) and AI-assisted training (sub-process 728). The guided training (sub-process 710) includes multiple operations. The guided training (sub-process 710) includes operation 712, in which the model personalization system 700 creates (generates) a question list, with a set of questions (e.g., the instructions 210) to ask the subject (e.g., through the discovery UI 215). The guided training (sub-process 710) includes operation 714, in which the model personalization system 700 receives (e.g., through the discovery UI 215) and records (e.g., into the data store(s) 280) the subject's responses (e.g., information 220) to the questions (of operation 712). If the subject's responses are provided, received, and/or recorded a audio recordings of the subject speaking (verbally), then at operation 716, the model personalization system 700 uses a speech to text conversion algorithm to convert the audio recordings into text. The guided training (sub-process 710) includes operation 718, in which the model personalization system 700 scrubs the text of the responses (e.g., the information 220), for instance to filter out and/or remove filler words (e.g., “um,” “uh,” etc.), repeated words (e.g., from the subject stuttering or thinking), profanity (e.g., swearing), sensitive data (e.g., cryptographic key data, credit card numbers, or other information that could raise privacy or security concerns), and/or other terms that can negatively affect the personalization (e.g., training, fine-tuning) of the ML model (of the ML models 740).

The guided training (sub-process 710) includes operation 720, in which the model personalization system 700 has the scrubbed responses from the subject (e.g., information 220, processed dataset 230) undergo administrative review and/or editing by an administrator, such as an engineer associated with the model personalization system 700, who can further edit the scrubbed responses to correct any issues not caught or corrected in operation 718 (the scrubbing), for instance by correcting formatting issues or removing/replacing terminology that might confuse the model personalization system 700. The guided training (sub-process 710) includes operation 722, in which the model personalization system 700 has the scrubbed responses from the subject (e.g., information 220, processed dataset 230) undergo client review and/or editing by a client (e.g., the subject or another user associated with the subject), who can further edit the scrubbed responses to correct any issues not caught or corrected in operation 718 (the scrubbing) or operation 720 (the administrative review and/or editing), such as corrections to the accuracy of certain information given in the responses (which the model personalization system 700 and/or the administrator might not know).

The guided training (sub-process 710) includes operation 724, in which the model personalization system 700 creates chunks from the scrubbed and edited responses. The model personalization system 700 stores these chunks in a chunks data store 726 (or chunks data structure). The chunks refer to segmented data pieces that are used as input for the ML models 740, allowing the ML models 740 to process the information in the chunks (from the scrubbed and edited responses) in a structured and efficient manner. The processing of the responses as chunks improves the model's ability to handle complex data sets and generate accurate responses, ultimately improving the accuracy and efficiency of the personalization of the ML models 740. In some examples, the processing of the responses as chunks improves the throughput of the personalization of the ML models 740, allowing more of the ML models 740 to be personalized (e.g., trained, fine-tuned, and/or otherwise customized) at a faster pace.

In some examples, the model personalization system 700 stores the chunks data store 726 in a RAG data store 792. In some examples, the model personalization system 700 create (generates) indexes or indices for the chunks (that are in the chunks data store 726), and stores the indexes or indices in the RAG data store 792. The indexes or indices can be referred to as RAG indexes or RAG indices.

The AI-assisted training (sub-process 728) includes multiple operations. The AI-assisted training (sub-process 728) includes operation 730, in which the model personalization system 700, like in operation 716, uses a speech to text conversion algorithm to convert audio recordings (from questions to and/or answers from the subject obtained through the discovery UI 215) into text. The AI-assisted training (sub-process 728) includes operation 732, in which the model personalization system 700, like in operation 718, scrubs the text of the responses (e.g., the information 220), for instance to filter out and/or remove filler words, repeated words, profanity, sensitive data, and/or other terms that can negatively affect the personalization (e.g., training, fine-tuning) of the ML model (of the ML models 740).

The model personalization system 700 uses the chunks from the chunks data store 726 to perform training (sub-process 734). The training (sub-process 734) includes multiple operations. The training (sub-process 734) includes operation 736, in which the model personalization system 700 adds dataset metadata associated with the chunks of the chunks data store 726. The added dataset metadata can include further information associated with the gathering of the responses through the discovery UI 215, further information about previous conversations with the subject, additional information about the subject (e.g., from a search of a database or a web search), additional information about the content discussed by the subject in the responses (e.g., from a search of a database or a web search), or a combination thereof. Operation 736 can provides context and structure to the dataset, facilitating more accurate and efficient training of the ML models 740. The use of metadata is a powerful tool for optimizing the model's learning and response generation capabilities. The training (sub-process 734) includes operation 738, in which the model personalization system 700 creates personalized ML models, stored and/or maintained among a set of ML models 740 of the model personalization system 700.

Returning to the fork of operation 706—if, at operation 706, the model personalization system 700 proceeds down the chat path, then the model personalization system 700 initiates a persona chat (sub-process 742). The persona chat (sub-process 742) includes multiple operations, and can be associated with the conversational UI 270. The persona chat (sub-process 742) includes operation 744, in which the model personalization system 700 fetches a chat history of with a user from a chat history data store 780, such as the user from which the message(s) 260 are received (through the conversational UI 270) in the model personalization system 200. The persona chat (sub-process 742) includes operation 746, in which the model personalization system 700 receives a user prompt (e.g., the message(s) 260), which can include a question, from the user through the conversational UI 270. The persona chat (sub-process 742) includes operation 748, in which the model personalization system 700 processes the user prompt (e.g., the message(s) 260), for instance to modify the question(s) and/or other contents of the message to improve the ability of the personalized ML model (of the ML models 740) to answer the question. For instance, similarly to the scrubbing of operation 716 and operation 732, the model personalization system 700 can, at operation 748, modify the user prompt (e.g., the message(s) 260) to filter out and/or remove certain types of data, and/or to add additional context (e.g., from the chat history, from the training data, and/or from data store(s) such as the data store(s) 280). Data that the model personalization system 700 can filter out or remove from the user prompt (e.g., the message(s) 260) at operation 748 can include, for instance, filler words (e.g., “um,” “uh,” etc.), repeated words (e.g., from the subject stuttering or thinking), profanity (e.g., swearing), sensitive data (e.g., cryptographic key data, credit card numbers, or other information that could raise privacy or security concerns), requests for sensitive data, and/or other terms or questions that could cause the personalized ML model to provide an inappropriate or inaccurate response or divulge sensitive information, that could confuse the personalized ML model, or that could potentially cause other issues with the response given by the personalized ML model.

At operation 750, the model personalization system 700 includes a decision as to whether to continue the chat. If, at operation 750, the decision is to not continue the chat—for instance, if the user closes the conversational UI 270, requests to terminate the chat, says a certain key word (e.g., “goodbye,” “bye,” “see you next time,” “see you tomorrow,” “see you later”), or otherwise indicates a desire to end the chat, the at operation 752, the model personalization system 700 can end or terminate the chat (e.g., end and/or terminate the conversational UI 270 and/or the connection between the client device(s) 105 and the server system(s) 110). If, at operation 750, the decision is to continue the chat, then the model personalization system 700 can continue on to a chat function (sub-process 754).

The chat function (sub-process 754) includes multiple operations. For instance, the chat function (sub-process 754) includes an operation 756 for content fetching and/or evaluation. In operation 756, the model personalization system 700 obtains content relevant to a message (e.g., question) from a user (e.g., relevant to the message(s) 260), such as model personalization data (e.g., training data, parameters, prompt customizations) associated with the ML models 740, the chunks from the chunks data store 726, data obtained through RAG queries (e.g., data from the data store(s) 280, RAG query(s) 1445, query 1530) using the RAG indexes and/or other data in the RAG data store 792 (and/or the chunk data in the chunks data store 726), chat history data, other types of data about the subject, other types of data about the user that the personalized ML model is conversing with, other types of data about other topic(s) being discussed, or a combination thereof. The chat function (sub-process 754) includes an operation 756 for content resizing, in which content can be scrubbed or trimmed, for instance to fit within limited size allowed for ingestion into the personalized ML model (e.g., based on limitations of the ML models 740).

The chat function (sub-process 754) includes an operation 760 for creating (generating) a text-based response (e.g., response(s) 265) that is responsive to the message(s) (e.g., message(s) 260) from the user, in some cases after additional processing is done to the message(s) (e.g., at operation 756 and/or operation 758). The response created at operation 760 is generated to be conversationally responsive to the message(s) (e.g., message(s) 260). The chat function (sub-process 754) includes an operation 762 for filtering the generated response, for instance to remove profanity (e.g., swearing), sensitive data (e.g., cryptographic key data, credit card numbers, or other information that could raise privacy or security concerns), and/or other terms that could negatively impact privacy and/or security. The chat function (sub-process 754) includes an operation 764 for generating a voice response using a voice model 778, which may also be personalized to the subject, for instance based on voice capture of the subject (sub-process 770).

The voice capture of the subject (sub-process 770) includes multiple operations. For instance, the voice capture of the subject (sub-process 770) includes operation 772, in which the model personalization system 700 creates (generates) utterances for the subject to read aloud and/or say. The voice capture of the subject (sub-process 770) includes operation 772, in which the model personalization system 700 captures (records) audio of the subject speaking the utterances (e.g., reading the utterances aloud). The utterances can be generated and/or selected to include a variety of different sounds (e.g., letters, words, phonemes, etc.), for instance so that the recorded audio includes recordings of examples of the subject speaking every letter in the alphabet, examples of the subject speaking different words and/or phonemes, examples of the subject's accent, examples of the subject's speaking style, examples of the subject's disfluencies (e.g., stutter), or a combination thereof.

The voice capture of the subject (sub-process 770) includes operation 774, in which the model personalization system 700 creates (generates, personalizes, trains, fine-tunes, adjust parameters of, or a combination thereof) the voice model 778 for the subject. The model personalization system 700 can personalize (e.g., train, fine-tune, adjust parameters of, adjust prompts for, or a combination thereof) the voice model 778 for the subject to personalize and/or customize the voice model 778 to simulate and/or emulate the speaking style of the subject. Ultimately, the model personalization system 700 can personalize the ML models 740 and/or the voice model 778 for the subject to simulate and/or emulate a speaking style of the subject, a writing style of the subject, a verbal tic of the subject, an accent of the subject, a dialect of the subject, a language register of the subject, an elocution of the subject, a tone associated with the subject, a diction associated with the subject, a rhetoric associated with the subject, a lexicon associated with the subject, a jargon associated with the subject, a cadence associated with the subject, an idiolect associated with the subject, a syntax associated with the subject, a linguistic persona associated with the subject, or a combination thereof.

The chat function (sub-process 754) includes an operation 766 in which the model personalization system 700 logs new message(s) (e.g., message(s) 260) and/or responses (e.g., response(s) 265) into the chat history data store 780. The chat function (sub-process 754) includes an operation 766 in which the model personalization system 700 provides new message(s) (e.g., message(s) 260) and/or responses (e.g., response(s) 265) for use in updating (sub-process 782) of the chunks data store 726 and/or the ML models 740.

The updating (sub-process 782) includes multiple operations. For instance, the updating (sub-process 782) includes an operation 784, in which new message(s) (e.g., message(s) 260) and/or responses (e.g., response(s) 265) are retrieved from the conversational UI 270 (e.g., from the chat function of sub-process 754). The updating (sub-process 782) includes an operation 786, at which the model personalization system 700 determines whether there is feedback from a human (e.g., UI-based), for instance through the conversational UI 270 (e.g., from the chat function of sub-process 754) or from an administrator. If feedback has been received, the updating (sub-process 782) includes an operation 788 in which the model personalization system 700 addresses the specific issue identified in the feedback. If there is no feedback at operation 786, then the updating (sub-process 782) includes an operation 790 in which the model personalization system 700 performs learning based on analyses of the interactions within the conversational UI 270 (e.g., from the chat function of sub-process 754) themselves, for instance based on how newer responses (e.g., response(s) 265) compare to the older responses (e.g., in the chat history data store 780) (e.g., in terms of response length, emotions expressed, and so forth), whether the newer responses (e.g., response(s) 265) answer the questions asked in the messages (e.g., message(s) 260) from the user, and so forth.

For instance, in an illustrative example, if the feedback (of operation 788) and/or the analysis (of operation 790) indicates that the responses (e.g., response(s) 265) from the personalized ML model (e.g., the ML models 740 and/or the voice model 778) are too concise or terse (non-verbose), then at operation 788, the model personalization system 700 can adjust the chunks and/or the models (e.g., the chunks data store 726, the ML models 740, and/or the voice model 778) to be more verbose (less concise or terse). In a second illustrative example, if the feedback (of operation 788) and/or the analysis (of operation 790) indicates that the responses (e.g., response(s) 265) from the personalized ML model (e.g., the ML models 740 and/or the voice model 778) are too verbose (non-terse or non-concise), then at operation 788, the model personalization system 700 can adjust the chunks and/or the models (e.g., the chunks data store 726, the ML models 740, and/or the voice model 778) to be more concise (less verbose). In a third illustrative example, if the feedback (of operation 788) and/or the analysis (of operation 790) indicates that the responses (e.g., response(s) 265) from the personalized ML model (e.g., the ML models 740 and/or the voice model 778) are expressing too much of a specific emotion or feeling (e.g., anger), then at operation 788, the model personalization system 700 can adjust the chunks and/or the models (e.g., the chunks data store 726, the ML models 740, and/or the voice model 778) to express that specific emotion or feeling less (less angry). In a fourth illustrative example, if the feedback (of operation 788) and/or the analysis (of operation 790) indicates that the responses (e.g., response(s) 265) from the personalized ML model (e.g., the ML models 740 and/or the voice model 778) are expressing too much of a specific emotion or feeling (e.g., anger), then at operation 788, the model personalization system 700 can adjust the chunks and/or the models (e.g., the chunks data store 726, the ML models 740, and/or the voice model 778) to express that specific emotion or feeling less (less angry).

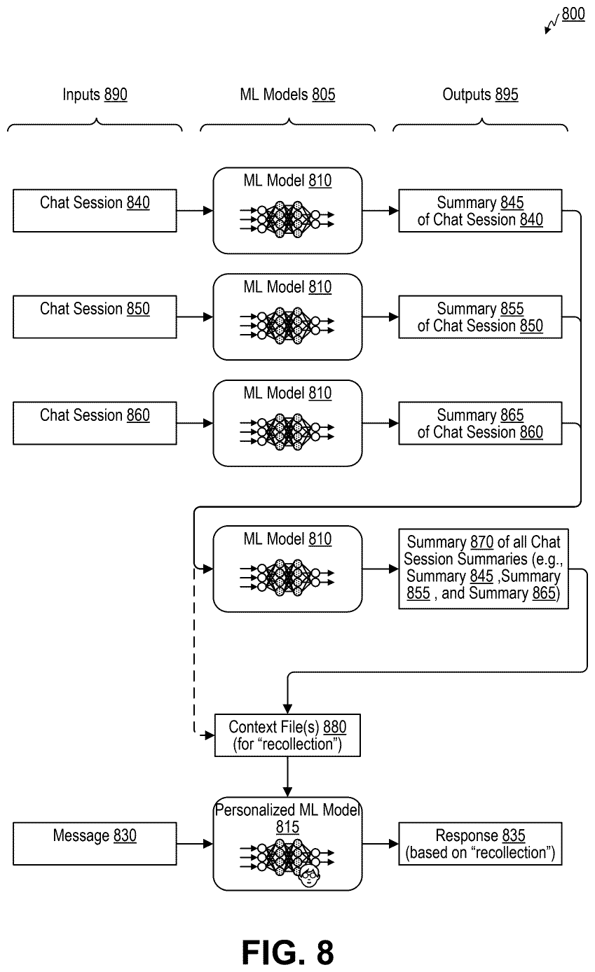

FIG. 8 is a block diagram illustrating an ML-based recollection system 800 that uses ML model(s) (e.g., ML model 810) to generate summaries (e.g., summary 845, summary 855, and summary 865) of different chat sessions (e.g., chat session 840, chat session 850, and chat session 860), and that uses ML model(s) (e.g., ML model 810) to generate a summary 870 of the different chat session summaries (e.g., summary 845, summary 855, and summary 865), for use by a personalized ML model (e.g., personalized ML model 815) for recollection of past conversations. The ML-based recollection system 800 can include, for instance, the client device(s) 105, the special-purpose server system(s) 110, the model personalization system 200, and/or the model personalization system 700. The ML model 810 and the personalized ML model 815 are ML models 805 of the ML-based recollection system 800, and process inputs 890 to generate outputs 895.

For a personalized ML model (e.g., such as the personalized ML model(s) 255 and/or the personalized ML model 815) to accurately simulate or emulate a person (e.g., the subject of FIG. 2), it is important that the personalized ML model avoid behaviors that break immersion by behaving in unrealistic ways—that is, ways that a human being would not, or could not. For instance, human beings have imperfect memory, while computers can retrieve exact details, provided they have sufficient storage space available. Furthermore, human recollection tends to focus on remembering the main points of a conversation or other event, such as the main topic discussed, without necessarily remembering minute details, such as whether one specific word or another specific word was used.

To simulate the imperfect recollection of a human being, and focus the recollection on the main points of prior conversations, in some examples, the ML-based recollection system 800 can use one or more ML model(s) (e.g., ML model 810) to generate summaries of different chat conversations. For instance, the ML model(s) (e.g., ML model 810) can generate a summary 845 of a chat session 840, a summary 855 of a chat session 850, and a summary 865 of a chat session 860. The ML model(s) (e.g., ML model 810) can generate a summary 870 of the various summaries (e.g., the summary 845, the summary 855, and the summary 865).

The summary 870—and in some cases, the summaries it's based on (e.g., the summary 845, the summary 855, and the summary 865)—can be used by a personalized ML model 815 to recollect prior conversations imperfectly, and to recollect the main points of the prior conversations (without necessarily recollecting the entirety of those conversations), thereby improving the simulation or emulation of the subject by sitting or eliminating the imperfect and more focused recollection of a human being. For instance, in some examples, the summary 870 and/or the summaries that the summary 870 is based on (e.g., the summary 845, the summary 855, and the summary 865) can be added to one or more context file(s) 880 that are input into the personalized ML model 815 and/or that are added to a prompt for the personalized ML model 815. When the personalized ML model 815 receives a message 830 (e.g., message(s) 260) from a user through the conversational UI 270, the personalized ML model 815 generates a response 835 (e.g., response(s) 265) that is conversationally responsive to the message 830 based on the message 830 itself and the recollection (e.g., the context file(s) 880 and/or the summary 870). In some examples, the context file(s) 880 and/or the summary 870 can input as part of the prompt to the personalized ML model 815, or can be part of the training data that updates the personalized ML model 815 before the message 830 is received by the personalized ML model 815. In some examples, the context file(s) 880 are stored in data store(s) (e.g., data store(s) 280, chunks data store 726, RAG data store 792) and indexed via RAG indexes, and the personalized ML model 815 can use RAG queries to retrieve the context file(s) 880 (or portions thereof) from the data store(s) as needed to generate the response 835.

In some examples, in addition to improving immersion (e.g., by improving the simulation of the subject's recollection), use of the context file(s) 880 and/or the summary 870 for recollection of prior conversations can also improve efficiency and reduce latency and/or throughput for the personalized ML model 815 to generate the response 835 (and later responses) compared use of the full conversation history or even the summaries of the individual conversations (e.g., the summary 845, the summary 855, and the summary 865), as the personalized ML model 815 ultimately has less data to process.

In some examples, if the personalized ML model 815 requires more information about a particular conversation, the ML-based recollection system 800 can retrieve the summary of that particular conversation (e.g., the summary 845, the summary 855, or the summary 865), and can add (e.g., append) it to the context file(s) 880 and/or summary 870 for use in recollection. For example, if a message (e.g., the message 830) from the user inquires about a topic discussed during a particular conversation (e.g., the chat session 850), and the context file(s) 880 and/or summary 870 does not have sufficient detail about that topic, the ML-based recollection system 800 can retrieve the summary of that conversation (e.g., the summary 855) and add or append (e.g., within the context file(s) 880) that summary (e.g., summary 855) to the overall context file(s) 880 and/or summary 870 used for recollection, and the personalized ML model 815 can use both summaries (e.g., the summary 870 and the summary 855) to generate the response 835 to the message 830. In some examples, if the personalized ML model 815 still requires more information about that particular conversation, for instance if further messages from the user (e.g., 830) inquire about a topic discussed during that conversation (e.g., chat session 850) in even more detail than is in the summary of that conversation (e.g., summary 855), then the ML-based recollection system 800 can also append (e.g., within the context file(s) 880) the conversation history of that chat session (e.g., chat session 850) to the recollection data (e.g., to the summary 870 and the summary 855) for use in recollection. For example, if a message (e.g., the message 830) from the user inquires about a topic discussed during a particular conversation (e.g., the chat session 850), and the summary 870 and the summary of that conversation (e.g., the summary 855) do not have sufficient detail about that topic, the ML-based recollection system 800 can retrieve the chat history of that conversation (e.g., the chat session 850) and add or append it (e.g., within the context file(s) 880) to the overall summary 870 and/or conversation-specific summary (e.g., chat session 850) used for recollection, and the personalized ML model 815 can use both summaries (e.g., the summary 870 and the summary 855) and the chat history of the specific conversation (e.g., the chat session 850) to generate the response 835 to the message 830. In this way, the ML-based recollection system 800 can improve efficiency, reduce latency, and improve throughput by only retrieving additional data if needed. Furthermore, this can simulate or emulate a human being's recollection in that a human being may recall additional details if given some additional time to think, and/or some additional context.

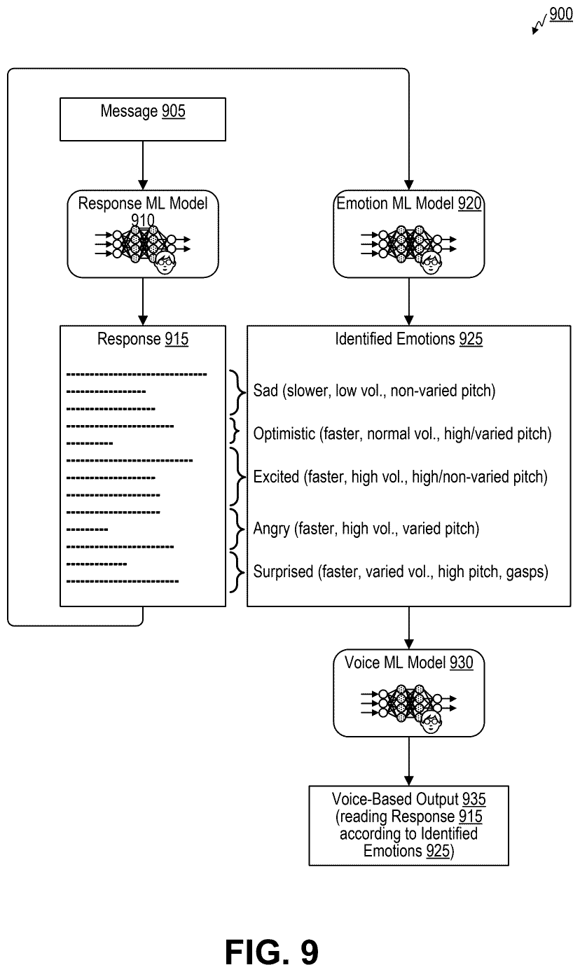

FIG. 9 is a block diagram illustrating an ML-based emotion system 900 that uses of a response ML model 910 to generate a response 915 to a message 905, that uses an emotion ML model 920 to identify emotions 925 corresponding to portions of the response 915, and that uses a voice ML model 930 to determine how to read the response 915 based on the identified emotions 925. The ML-based emotion system 900 can include the client device(s) 105, the special-purpose server system(s) 110, the model personalization system 200, the model personalization system 700, the ML-based recollection system 800, or a combination thereof.

One technical weakness of traditional text-to-speech algorithms and/or models is lack of emotion in the reading or vocalizing of the text. For instance, if a human being reads some text content, such as a speech or an excerpt of a book, the human being naturally reads different portions of the text with different pitches, different volumes, different pitch variabilities or ranges, different intonations, or combinations thereof. For instance, a human speaks with different volume, pitch, pitch range, and/or intonation when the human being is speaking angrily than when the human being is speaking calmly.

Thus, to improve simulation and/or emulation of human behavior, the ML-based emotion system 900 uses the emotion ML model 920 to identify emotions in the response 915, affecting how the voice ML model 930 generates a voice-based output 935 reads the response 915. The ML model 910 generates the response 915 to include text that is responsive to the message 905. The response 915 can be an example of the response(s) 265, the answers 320, the sample outputs 415, the text response 545, the text response 550, the response created at operation 760, the response 835, and/or other responses discussed herein, or vice versa. The response 915 is illustrated in FIG. 9 as a length block of lines representing lines of text in a paragraph of text.

The ML-based emotion system 900 processes the response 915 through the emotion ML model 920. In some examples, the emotion ML model 920 may be an ML model that is trained to identify emotions corresponding to portions of text generally, for instance based on training data with pre-identified emotions corresponding to portions of text. In some examples, the emotion ML model 920 may be personalized to the subject, for example based on the processed dataset 230 and/or the model personalization dataset 240. In examples where the emotion ML model 920 may be personalized to the subject, the emotion ML model 920 can identify emotions that the subject would most likely express with respect to certain types of language. For instance, if the subject is or was quick to anger, and the emotion ML model 920 is personalized to the subject, then the emotions 925 may identify anger more often than a non-personalized (generalized) version of the emotion ML model 920. Similarly, if the subject is or was a very calm person, and the emotion ML model 920 is personalized to the subject, then the emotions 925 may identify anger or other strong emotions less often than a non-personalized (generalized) version of the emotion ML model 920.

The emotion ML model 920 tag different portions (e.g., paragraphs, sentences, words, tokens, and/or portions thereof) of the response 915 with different emotions 925. The emotions 925 identified by the emotion ML model 920 include sadness, optimism, excitement, anger, and surprise. For instance, the emotion ML model 920 tags a first portion of the response 915 as corresponding to sadness, indicating that the voice ML model 930 is to generate the voice-based output 935 to read that first portion of the response 915 in a sad way. Sadness can correspond to a slow voice speed (e.g., slower than a threshold voice speed, such as slower than normal voice speed or baseline voice speed), a quiet volume (e.g., lower than a threshold volume, such as lower than normal volume or baseline volume), and a narrow pitch range (e.g., narrower than a normal pitch range or baseline pitch range, based on the thresholds of the range being closer together, resulting in less variability in pitch).

The emotion ML model 920 tags a second portion of the response 915 as corresponding to optimism, indicating that the voice ML model 930 is to generate the voice-based output 935 to read that second portion of the response 915 in an optimistic way. Optimism can correspond to a fast voice speed (e.g., faster than a threshold voice speed, such as faster than normal voice speed or baseline voice speed), a normal volume (e.g., a threshold volume, such as a normal volume or baseline volume), a generally higher pitch (e.g., higher than a threshold pitch, such as higher than normal pitch or baseline pitch), and a wide pitch range (e.g., wider than a normal pitch range or baseline pitch range, based on the thresholds of the range being farther apart, resulting in more variability in pitch).

The emotion ML model 920 tags a third portion of the response 915 as corresponding to excitement, indicating that the voice ML model 930 is to generate the voice-based output 935 to read that third portion of the response 915 in an excited way. Excitement can correspond to a fast voice speed (e.g., faster than a threshold voice speed, such as faster than normal voice speed or baseline voice speed), a loud volume (e.g., higher than a threshold volume, such as higher than normal volume or baseline volume), a generally higher pitch, and a narrow pitch range.

The emotion ML model 920 tags a fourth portion of the response 915 as corresponding to anger, indicating that the voice ML model 930 is to generate the voice-based output 935 to read that fourth portion of the response 915 in an angry way. Anger can correspond to a fast voice speed, a loud volume, and a wide pitch range. The emotion ML model 920 tags a fifth portion of the response 915 as corresponding to surprise, indicating that the voice ML model 930 is to generate the voice-based output 935 to read that fifth portion of the response 915 in a surprised way. Surpriuse can correspond to a fast voice speed, a varied volume (e.g., wider than a normal volume range or baseline volume range, based on the thresholds of the range being farther apart, resulting in more variability in volume), a generally high pitch, and non-verbal utterances (e.g., gasps, grunts, whoops, exclamations).

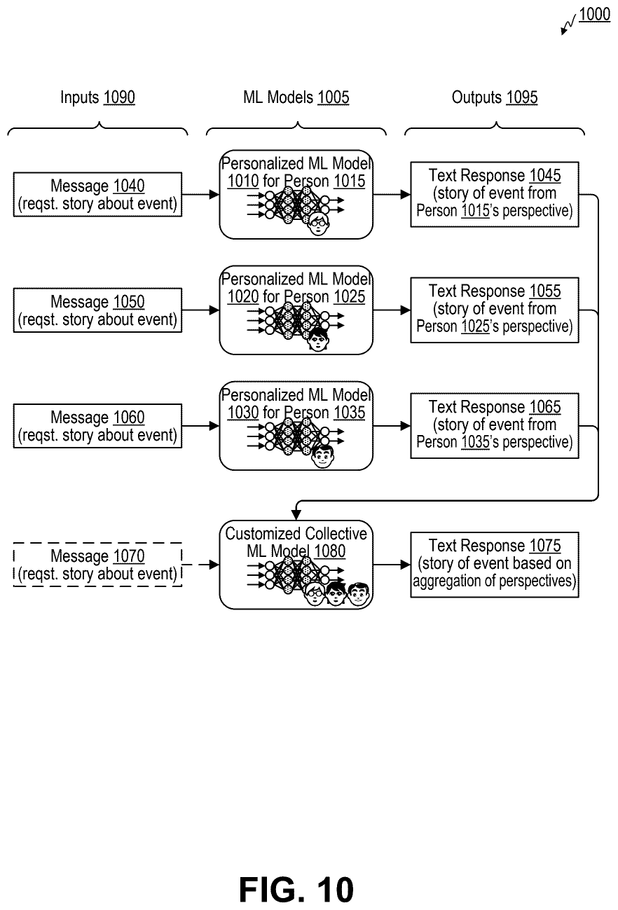

FIG. 10 is a block diagram illustrating a collective ML model personalization system 1000 that combines personalized ML models (e.g., personalized ML model 1010 for person 1015, personalized ML model 1020 for person 1025, and personalized ML model 1030 for person 1035), each associated with different people (e.g., a first person 1015, a second person 1025, and a third person 1035), to form a customized collective ML model 1080 associated with a group of people (e.g., the first person 1015, the second person 1025, and the third person 1035), for instance focused on recollections of an event by the group of people. The collective ML model personalization system 1000 can include the client device(s) 105, the special-purpose server system(s) 110, the model personalization system 200, the model personalization system 700, the ML-based recollection system 800, the ML-based emotion system 900, or a combination thereof. The personalized ML model 1010, the personalized ML model 1020, the personalized ML model 1030, and the customized collective ML model 1080 are ML models 1005 of the ML-based recollection system 1000, and process inputs 1090 to generate outputs 1095.

In some examples, the inputs 1090 to the personalized ML models (e.g., the personalized ML model 1010, the personalized ML model 1020, and the personalized ML model 1030) can include messages (e.g., message 1040, message 1050, and message 1060) that all ask about a specific topic, such as an event that the people (e.g., the first person 1015, the second person 1025, and the third person 1035) all remember and/or participated in. For instance, the personalized ML model 1010 processes the message 1040 to generate a text response 1045 recounting a story of the event from the perspective of the person 1015 (who the personalized ML model 1010 is personalized to simulate). The personalized ML model 1020 processes the message 1050 to generate a text response 1055 recounting a story of the event from the perspective of the person 1025 (who the personalized ML model 1020 is personalized to simulate). The personalized ML model 1030 processes the message 1060 to generate a text response 1065 recounting a story of the event from the perspective of the person 1035 (who the personalized ML model 1030 is personalized to simulate).

In some examples, the responses (e.g., the text response 1045, the text response 1055, and the text response 1065) are used to personalize (e.g., train, fine-tune, or otherwise personalize) the customized collective ML model 1080 to simulate or emulate a group of people that includes the first person 1015, the second person 1025, and the third person 1035. In some examples, multiple messages (e.g., questions) are processed by each of the personalized ML models (e.g., the personalized ML model 1010, the personalized ML model 1020, and/or the personalized ML model 1030), and the responses to each of these messages (e.g., questions) are used to personalize (e.g., train, fine-tune, or otherwise personalize) the customized collective ML model 1080 to simulate or emulate the group of people, similarly to the use of the information 220 from the discovery UI 215 to train the personalized ML model(s) 255. In some examples, personalization data corresponding to the personalized ML models (e.g., the personalized ML model 1010, the personalized ML model 1020, and/or the personalized ML model 1030) is used to personalize (e.g., train, fine-tune, or otherwise personalize) the customized collective ML model 1080 to simulate or emulate the group of people.

One the collective ML model personalization system 1000 generates the customized collective ML model 1080, the customized collective ML model 1080 can be used to generate a text response 1075 about the topic (e.g., about the event), for instance in response to a message 1070 (e.g., a question) inquiring about the topic (e.g., about the event). The text response 1075 can be based memories, opinions, and/or knowledge of all of the people in the group, including the first person 1015, the second person 1025, and the third person 1035.

In an illustrative example, the people (e.g., the first person 1015, the second person 1025, and the third person 1035) can be veterans, and the event can be a war or battle that all of the people participated in. The customized collective ML model 1080 can be generated to memorialize and/or immortalize the recollections of the group of veterans of the war or battle, so that this important information is not lost to time.

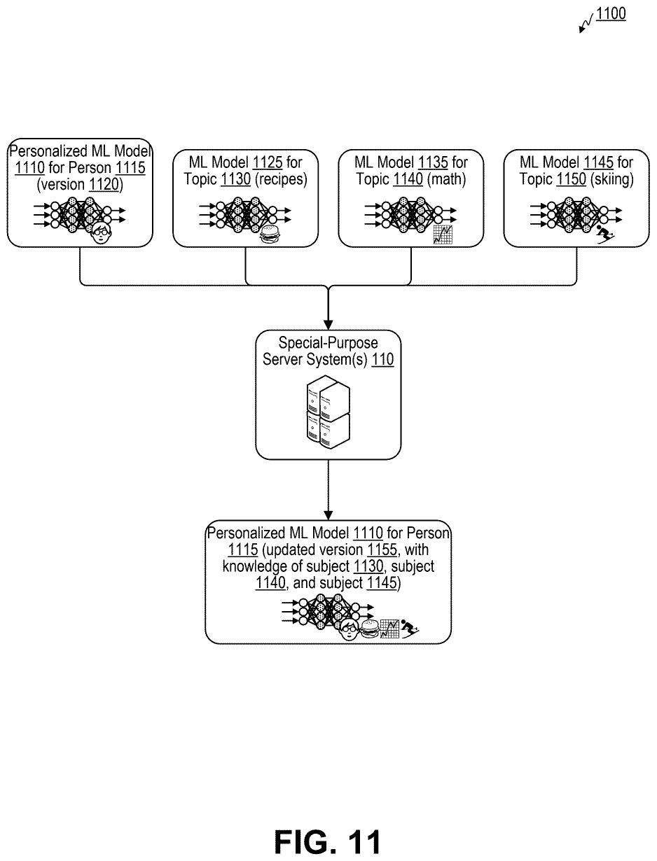

FIG. 11 is a block diagram illustrating a modular ML model personalization system 1100 that combines of model-specific data (e.g., training data, fine-tuning data, model parameters, and/or other model customization data) from a version 1120 of a personalized ML model 1110 and a number of subject-specific models, on a modular basis, to form an updated version 1155 of the personalized ML model 1110. The personalized ML model 1110 includes special-purpose server system(s) 110, which can be used to combine these models in a modular fashion.

The personalized ML model 1110 can be personalized to a specific person 1115. Different subject-specific models can be customized to include specialized knowledge or understanding of specific subjects or topics. The ML model 1125 is specialized to the topic 1130 of recipes and/or cooking, for instance being trained and/or fine-tuned based on information from cookbooks and/or recipes. The ML model 1135 is specialized to the topic 1140 of mathematics, for instance being trained and/or fine-tuned based on information from mathematics textbooks or lectures. The ML model 1145 is specialized to the topic 1150 of skiing, for instance being trained and/or fine-tuned based on information specific to skiing.

The special-purpose server system(s) 110 can identify, for instance based on the information 220 from the discovery UI 215, that the person 1115 is knowledgeable in, and/or skilled at, cooking, mathematics, and skiing. Thus, to updated and/or improve the personalized ML model 1110, the special-purpose server system(s) 110 combines model-specific data (e.g., training data, fine-tuning data, model parameters, and/or other model customization data) from the version 1120 of the personalized ML model 1110 with model-specific data from the ML model 1125, the ML model 1135, and the ML model 1145, to generate an updated version 1155 of the personalized ML model 1110 that is upgraded to include improved knowledge in cooking/recipes, mathematics, and skiing. In this way, the simulation and/or emulation of the specific person 1115 by the updated version 1155 of the personalized ML model 1110 is improved compared to the version 1120 of the personalized ML model 1110, based on the improved knowledge of cooking/recipes, mathematics, and skiing.

In some examples, the content is added in a way that can be removed in a modular manner. For instance, the content from the ML model 1125 about cooking and/or recipes can be tagged before being incorporated into the updated version 1155 of the personalized ML model 1110 so that this content can be later removed from a further version of the personalized ML model 1110 if desired. Similarly, the content from the ML model 1135 about mathematics can be tagged before being incorporated into the updated version 1155 of the personalized ML model 1110 so that this content can be later removed from a further version of the personalized ML model 1110 if desired—and so forth. In some examples, the content from the subject-specific or topic-specific models can be added to instructions in prompts given to the updated version 1155 of the personalized ML model 1110, to allow such modular additions and removals to be performed quickly and efficiently. In some examples, the subject-specific or topic-specific models have access to subject-specific or topic-specific data stores (e.g., to query via RAG queries), and the updated version 1155 of the personalized ML model 1110 is updated to have access to these subject-specific or topic-specific data stores (e.g., to query via RAG queries). If it is later desired to remove this content, the access to these subject-specific or topic-specific data stores can be removed for the personalized ML model 1110, preventing the RAG queries of those subject-specific or topic-specific data stores in connection with the personalized ML model 1110.

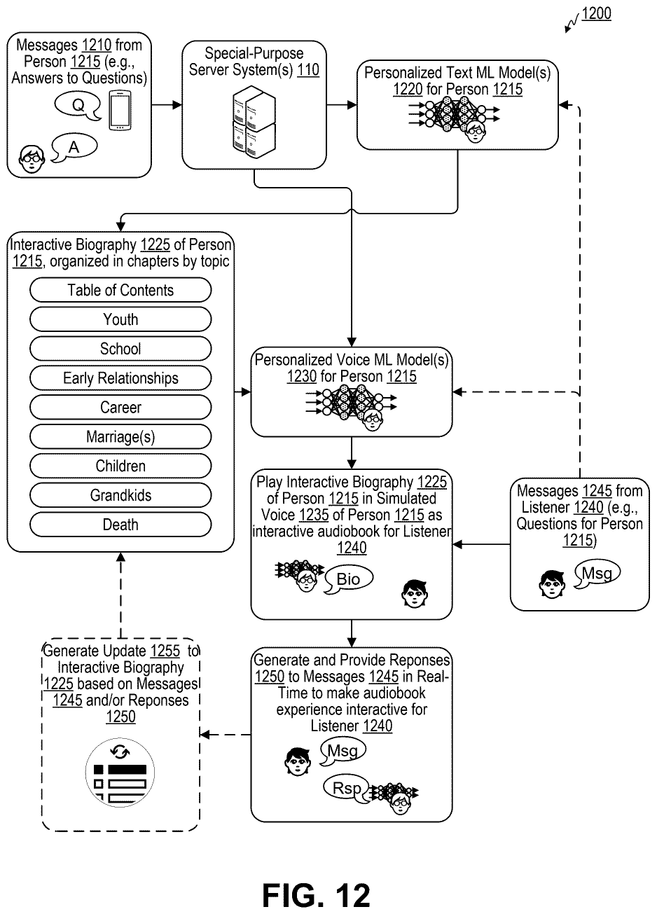

FIG. 12 is a block diagram illustrating a biographical ML model personalization system 1200 that uses trained machine learning models (e.g., personalized text ML model(s) 1220, personalized voice ML model(s) 1230) to generate an interactive biography 1225 of a subject (person 1215), where a listener 1240 can interrupt an output of the interactive biography with messages 1245 (e.g., questions) and receive responses 1250 in real-time. The interactive biography 1225 can be referred to an interactive autobiography.

The biographical ML model personalization system 1200 includes special-purpose server system(s) 110 that receive and process messages 1210 received through a user interface (e.g., discovery UI 215) from a person 1215, for instance in a question-and-answer form as in the information 220 (e.g., answers) received from the subject through the discovery UI 215. The instructions 210 can include text-based messages and/or audio-based messages (e.g., of the voice of the person 1215 speaking the that receive and process messages 1210). The special-purpose server system(s) 110 receive and process the messages 1210, for instance using a speech-to-text algorithm to convert speech into text, using the data parser 225 to convert the messages 1210 into the processed dataset 230, using the model personalization data generator 235 to convert the messages 1210 and/or the processed dataset 230 into the model personalization dataset 240, and so forth. The biographical ML model personalization system 1200 (e.g., the special-purpose server system(s) 110) uses the resulting data to generate the personalized text ML model(s) 1220 and the personalized voice ML model(s) 1230, both of which are personalized to the person 1215.

The personalized text ML model(s) 1220 generate the interactive biography 1225 of the person 1215. The personalized text ML model(s) 1220 generate the interactive biography 1225 in a way that is divided into chapters by topic or subject. For instance, the interactive biography 1225 is generated by the personalized text ML model(s) 1220 into chapters corresponding to different aspects of the life of the person 1215, such as youth, school, early relationships, career, marriage(s), children, grandchildren, and/or death. In some examples, the personalized text ML model(s) 1220 can generate the interactive biography 1225 to include a table of contents with links (e.g., hyperlinks) and/or cross-references to the various chapters of the interactive biography 1225. In some examples, clicking, touching, verbally selecting, or otherwise interacting with one of the links in the table of contents can allow a reader user interface (e.g., used by the listener 1240) to skip to the chapter that corresponds to that link.

The interactive biography 1225 can be played as an audiobook for the listener 1240, through an audio interface. In some examples, the personalized voice ML model(s) 1230 can be used to play the interactive biography 1225 as an audiobook, read using a simulation of the voice 1235 of the person 1215, for the listener 1240. The personalized voice ML model(s) 1230 can trained, fine-tuned, and/or otherwise personalized to simulate the voice 1235 of the person 1215 based on recordings of the voice 1235 of the person 1215 in the messages 1210, and/or based on recordings of other utterances spoken by the person 1215 (e.g., the utterances of operation 772). Furthermore, in some examples, clicking, touching, verbally selecting, or otherwise interacting with one of the links in the table of contents of the interactive biography 1225 can allow audio of the interactive biography 1225 (e.g., in the form of an audiobook listened to by the listener 1240) to skip to the chapter that corresponds to that link.

In some examples, while the interactive biography 1225 is being played as an audiobook for the listener 1240, the biographical ML model personalization system 1200 (e.g., the special-purpose server system(s) 110) can receive messages 1245 (e.g., message(s) 260) from the listener 1240. The messages 1245 can be, for instance, questions or comments about the contents of the interactive biography 1225. The messages 1245 can be processed by the personalized text ML model(s) 1220, in some cases along with context from a portion of the interactive biography 1225 that was recently read to the listener 1240 (e.g., the current chapter of the interactive biography 1225), to generate responses 1250 (e.g., response(s) 265) to the messages 1245. The personalized voice ML model(s) 1230 can be used to play the responses 1250 to the listener 1240, in some cases using the simulation of the voice 1235 of the person 1215. After the personalized voice ML model(s) 1230 is used to play the responses 1250 to the listener 1240, the personalized voice ML model(s) 1230 can be used to resume playback of the interactive biography 1225 from the portion of the interactive biography 1225 (e.g., a timestamp within the playback of the interactive biography 1225, or a specific chapter, paragraph, sentence, word, or token most recently read) that the listener 1240 interrupted with the messages 1245, or in some cases, a predetermined amount of time before or after.

In some examples, the biographical ML model personalization system 1200 generates an update 1255 to the interactive biography 1225 based on the messages 1245 and/or the responses 1250, and updates the interactive biography 1225 to include the update 1255. In a first illustrative example, if the messages 1245 ask to clarify a section that was unclear or ambiguous in a first version of the interactive biography 1225, and the responses 1250 clarify that section, then the interactive biography 1225 can be modified using an update 1255 (that is based on the responses 1250 and/or the messages 1245) to generate a second version of the interactive biography 1225 in which the ambiguity or unclear content is removed and/or replaced with clear and/or unambiguous content. In a second illustrative example, if the messages 1245 ask to expand on (provide additional content about) a specific topic associated with (mentioned in or related to) a first version of the interactive biography 1225, and the responses 1250 expand on that topic (provide the requested additional content about that topic), then the interactive biography 1225 can be modified using an update 1255 (that is based on the responses 1250 and/or the messages 1245) to generate a second version of the interactive biography 1225 that includes the expansion on that topic (that includes the additional content about that topic) from the responses 1250.

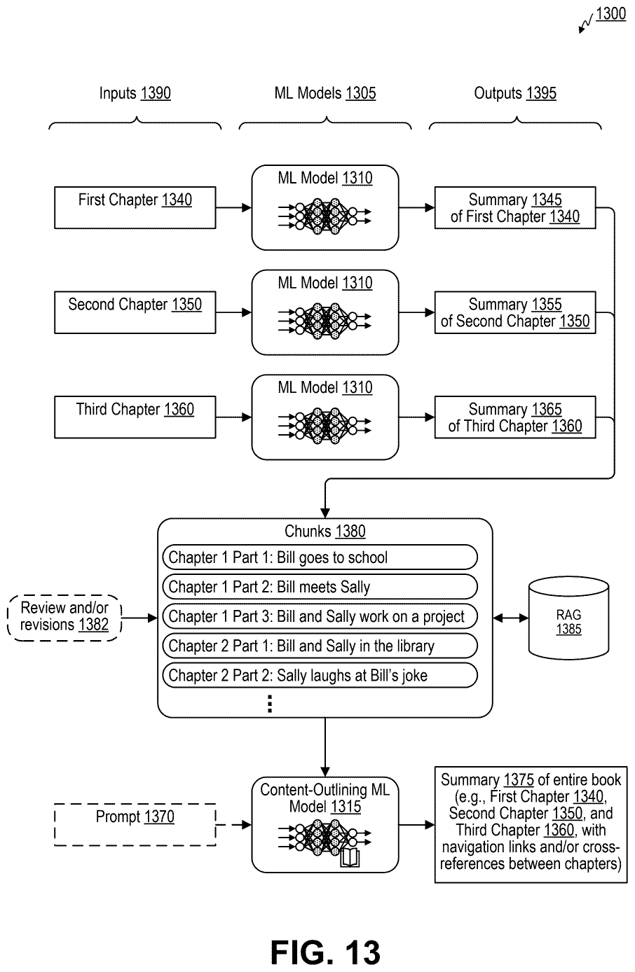

FIG. 13 is a block diagram illustrating a content summarizing ML model personalization system 1300 that uses of trained machine learning models to summarize a book or other media content, first on a portion-by-portion (e.g., chapter-by-chapter) basis, then to generate a summary of the entirety. The ML model personalization system 1300 can include the client device(s) 105, the special-purpose server system(s) 110, the model personalization system 200, the model personalization system 700, the ML-based recollection system 800, the ML-based emotion system 900, the collective ML model personalization system 1000, the modular ML model personalization system 1100, the biographical ML model personalization system 1200, or a combination thereof. The ML model 1310 and a content-outlining ML model 1315 are ML models 1305 of the ML-based recollection system 1300, and process inputs 1390 to generate outputs 1395.

In some examples, a first portion of a piece of content, such as a first chapter 1340 of a book, is processed by a ML model 1310 to generate a summary 1345 of the first chapter 1340. A second portion of the piece of content, such as a second chapter 1350 of the book, is processed by the ML model 1310 to generate a summary 1355 of the second chapter 1350. A third portion of the piece of content, such as a third chapter 1360 of the book, is processed by the ML model 1310 to generate a summary 1365 of the third chapter 1360.

In some examples, a content-outlining ML model 1315 (and/or the ML model 1310) processes the summaries (e.g., the summary 1345 of the first chapter 1340, the summary 1355 of the second chapter 1350, and the summary 1365 of the third chapter 1360), in some cases along with the full content itself (e.g., the first chapter 1340, the second chapter 1350, and/or the third chapter 1360), to generate a summary 1375 of the entire piece of content (e.g., of the entire book), including the first chapter 1340, the second chapter 1350, and/or the third chapter 1360. In some examples, the content-outlining ML model 1315 can generate the summary 1375 of the entire piece of content (e.g., of the entire book) in response to a prompt 1370 (e.g., one of the message(s) 260 from the user received through the conversational UI 270), for instance a prompt 1370 requesting such a summary. In some examples, the content-outlining ML model 1315 can generate the summary 1375 to include links (e.g., hyperlinks) and/or cross-references to specific portions of the content (e.g., within the first chapter 1340, the second chapter 1350, and/or the third chapter 1360) and/or to specific chapter summaries (e.g., the summary 1345 of the first chapter 1340, the summary 1355 of the second chapter 1350, and/or the summary 1365 of the third chapter 1360), which can provide an improved user interface for efficiently experiencing (e.g., reading) the piece of content (e.g., the book) and being able to navigate around the piece of content (e.g., the book).

In some examples, the ML model 1310 of the ML model personalization system 1300 divides the sections of the content (e.g., the first chapter 1340, the second chapter 1350, and the third chapter 1360) further into chunks 1380, for instance to be stored in and/or indexed in a RAG data store 1385. The RAG data store 1385 is an example of the data store(s) 280, the chunks data store 726, the RAG data store 792, the data store system(s) 1515, or a combination thereof. The chapters can be split into the chunks 1380 based on an optimal size for a chunk, which can be a predetermined threshold number of characters, number of tokens, or a combination thereof. The ML model 1310 can divide the chapters into chunks 1380 before, after, and/or in parallel with generating the summaries of the chapters (e.g., the summary 1345 of the first chapter 1340, the summary 1355 of the second chapter 1350, and the summary 1365 of the third chapter 1360). In some examples, the ML model 1310 generates titles for each of the chunks 1380, based on the contents of that chunk (e.g., summarizing the content in that chunk into the title). For instance, in the example illustrated in FIG. 13, the ML model 1310 divides the first chapter 1340 into “Chapter 1 Part 1: Bill goes to school,” “Chapter 1 Part 2: Bill meets Sally,” and “Chapter 1 Part 3: Bill and Sally work on a project.” In the example illustrated in FIG. 13, the ML model 1310 divides the second chapter 1350 into “Chapter 2 Part 1: Bill and Sally in the library” and “Chapter 2 Part 2: Sally laughs at Bill's joke.”

In some examples, the ML model personalization system 1300 allows a user to perform a review and/or make revisions 1382 to the chunks 1380. The user can be, for example, the subject that uses the discovery UI 215, the user that uses the conversational UI 270, an administrator (e.g., as in operation 720), a client (e.g., as in operation 722), or a combination thereof. In some examples, the ML model personalization system 1300 adds the chunks 1380 to the RAG data store 1385. In some examples, the model personalization system 1300 creates (generates) indexes for each of the chunks 1380 in the RAG data store 1385. The content-outlining ML model 1315 can then retrieve relevant chunks of the chunks 1380 in the RAG data store 1385 through a RAG query process.

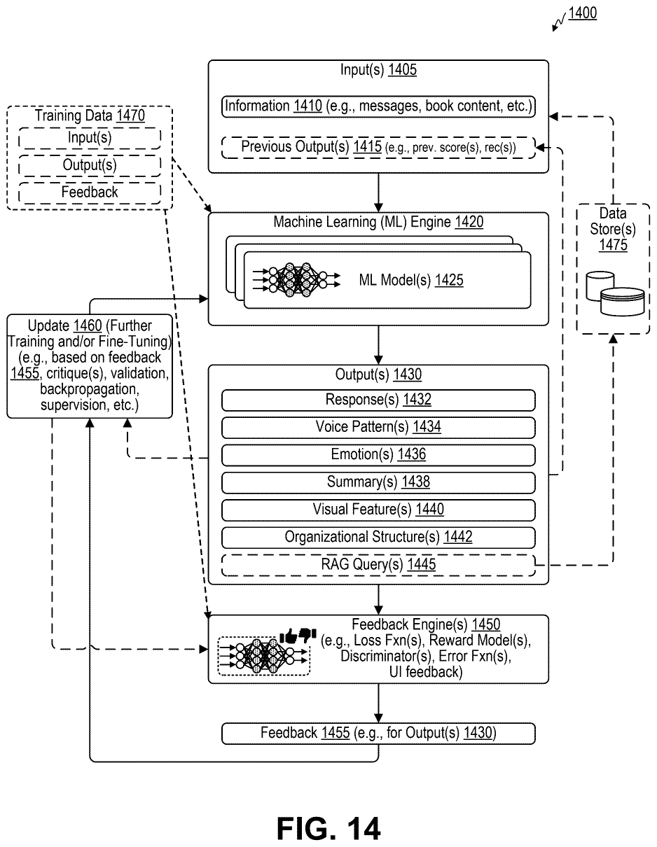

FIG. 14 is a block diagram illustrating an example of a machine learning system 1400 for training and use of one or more machine learning model(s) 1425 used to generate one or more response(s) 1432 responsive to one or more message(s) (of the information 1410). The machine learning (ML) system 1400 includes an ML engine 1420 that generates, trains, uses, and/or updates one or more ML model(s) 1425. In some examples, the special-purpose server system(s) 110, the ML model subsystem 245, the ML model(s) 250, the personalized ML model(s) 255, the ML models 505, the text ML model 510, the personalized text ML model 515, the voice ML model 520, the personalized voice ML model 525, the visual ML model 530, the personalized visual ML model 535, the ML models 740, the voice model 778, the ML models 805, the ML model 810, the personalized ML model 815, the response ML model 910, the emotion ML model 920, the voice ML model 930, the personalized ML model 1010, the personalized ML model 1020, the personalized ML model 1030, the customized collective ML model 1080, the personalized ML model 1110, the ML model 1125, the ML model 1135, the ML model 1145, the personalized text ML model(s) 1220, the personalized voice ML model(s) 1230, the ML models 1305, the ML model 1310, the content-outlining ML model 1315, the system 1500, the LLM engine 1520, the LLM(s) 1525, the personalized machine learning model 1640, the personalized machine learning model of the process 1900, another machine learning model or machine learning system discussed herein, or a combination thereof, can include the ML system 1400, the ML engine 1420, the ML model(s) 1425, and/or the feedback engine(s) 1450, or vice versa.

The machine learning system 1400 a machine learning (ML) engine 1420 that generates, trains, uses, and/or updates one or more ML model(s) 1425. The ML model(s) 1425 can include, for instance, one or more neural network (NN(s)), convolutional NN(s) (CNN(s)), trained time delay NN(s) (TDNN(s)), deep network(s), autoencoder(s) (AE(s)), variational AE(s) (VAE(s)), deep belief net(s) (DBN(s)), recurrent NN(s) (RNN(s)), generative adversarial network(s) (GAN(s)), conditional GAN(s) (cGAN(s)), support vector machine(s) (SVM(s)), random forest(s) (RF(s)), decision tree(s), NN(s) with fully connected (FC) layer(s), NN(s) with convolutional layer(s), computer vision (CV) system(s), deep learning (DL) system(s), classifier(s), transformer(s), clustering algorithm(s), reinforcement learning (RL) model(s), supervised learning (SL) model(s), unsupervised learning (UL) model(s), gradient boosting model(s), sequence-to-sequence (Seq2Seq) model(s), autoregressive (AR) model(s), large language model(s) (LLMs), one or more deep learning system(s), one or more classifier(s), one or more transformer(s), or combinations thereof.

In some examples, the ML model(s) 1425 can include a U-Network (U-Net) structure and/or architecture that includes a contracting path and an expansive path. If the ML model(s) 1425 is a U-Net, the ML model(s) 1425 may include, for instance, combination of convolution, up-convolution, pooling and skip connections that allows the ML model(s) 1425 to extract and capture complex features, while also keeping and reconstructing spatial information.

In examples where the ML model(s) 1425 include LLMs, the LLMs can include, for instance, a Generative Pre-Trained Transformer (GPT) (e.g., GPT-2, GPT-3, GPT-3.5, GPT-4, ChatGPT, and/or other GPT variant(s)), DaVinci, LLMs using Massachusetts Institute of Technology (MIT) langchain, Google® Bard®, Google® Gemini®, Pathways Language Model (PaLM), Large Language Model Meta AI (LLaMA), LLaMA 2, LLaMA 3, LLaMA 4, Megalodon, Language Model for Dialogue Applications (LaMDA), Bidirectional Encoder Representations from Transformers (BERT), Falcon (e.g., 40B, 7B, 1B), Orca, Phi-1, StableLM, DeepSeek® R1, Alibaba® Qwen®, ByteDance® Doubao®, another LLM, variant(s) of any of the previously-listed LLMs, or combinations thereof.

The ML engine 1420 can be an example of the ML model subsystem 245, or vice versa. The ML model(s) 1425 can be example(s) of the ML model(s) 250, the personalized ML model(s) 255, the ML models 505, the text ML model 510, the personalized text ML model 515, the voice ML model 520, the personalized voice ML model 525, the visual ML model 530, the personalized visual ML model 535, the personalized ML model 1640, the trained ML model of operation 1915, the personalized ML model of operation 1915, or a combination thereof.

Within FIG. 14, a graphic representing the ML model(s) 1425 illustrates a set of circles connected to one another. Each of the circles can represent a node, a neuron, a perceptron, a layer, a portion thereof, or a combination thereof. The circles are arranged in columns. The leftmost column of white circles represent an input layer. The rightmost column of white circles represent an output layer. Two columns of shaded circled between the leftmost column of white circles and the rightmost column of white circles each represent hidden layers. An ML model can include more or fewer hidden layers than the two illustrated, but includes at least one hidden layer. In some examples, the layers and/or nodes represent interconnected filters, and information associated with the filters is shared among the different layers with each layer retaining information as the information is processed. The lines between nodes can represent node-to-node interconnections along which information is shared. The lines between nodes can also represent weights (e.g., numeric weights) between nodes, which can be tuned, updated, added, and/or removed as the ML model(s) 1425 are trained and/or updated. In some cases, certain nodes (e.g., nodes of a hidden layer) can transform the information of each input node by applying activation functions (e.g., filters) to this information, for instance applying convolutional functions, downscaling, upscaling, data transformation, and/or any other suitable functions.

In some examples, the ML model(s) 1425 can include a feed-forward network, in which case there are no feedback connections where outputs of the network are fed back into itself. In some cases, the ML model(s) 1425 can include a recurrent neural network, which can have loops that allow information to be carried across nodes while reading in input. In some cases, the network can include a convolutional neural network, which may not link every node in one layer to every other node in the next layer.

One or more input(s) 1405 can be provided to the ML model(s) 1425. The ML model(s) 1425 can be trained by the ML engine 1420 (e.g., based on training data 1470) to generate one or more output(s) 1430. The training data 1470 can include the model personalization dataset 240 and/or other training data and/or model personalization data.

In some examples, the input(s) 1405 include information 1410 to be processed and/or previous output(s) 1415. The information 1410 can include message(s) from a user, such as the message(s) of operation 140, the message(s) 260, the message 540, the message 610, the message 620, message(s) from the user received via the video 660 in the UI 650, the visitor prompt of operation 746, other conversation messages associated with sub-process 742 and/or sub-process 754, the message 830, the message 905, the message 1040, the message 1050, the message 1060, the message 1070, the inputs 1090, the messages 1210, the messages 1245, the inputs 1390, the prompt 1535, the message of operation 1920, or a combination thereof. In some examples, the input(s) 1405 can include previous output(s), such as response(s) previously-generated buy the ML model(s) 1425, and/or other types of response(s) generated by the ML model(s) 1425. In some examples, the input(s) 1405 can include partially-processed data that is to be processed further, such as various features, weights, intermediate data, layer data from specific layer(s) of the ML model(s) 1425, or a combinations thereof. In some examples, the input(s) 1405 can include prompt(s) (e.g., to an LLM). In some examples, the input(s) 1405 can include information retrieved from data store(s) 1475, for instance via retrieval augmented generation (RAG) (e.g., via RAG query(s) 1445). In some examples, the input(s) 1405 can include prompt(s) that are modified and/or enhanced using information retrieved from data store(s) 1475, for instance via retrieval augmented generation (RAG) (e.g., via RAG query(s) 1445).

The output(s) 1430 generated by the ML model(s) 1425 in response to input of the input(s) 1405 (e.g., in response to the information 1410 and/or the previous output(s) 1415) into the ML model(s) 1425 can include one or more response(s) 1432 to the message(s) (of the information 1410). The response(s) 1432 can be generated to be conversationally responsive to the message(s) (of the information 1410), and in some examples can be personalized to simulate a subject person (e.g., the subject of operation 120, the subject person using the discovery UI 215, the persona for the persona training of FIG. 7, the person 1015, the person 1025, the person 1035, the person 1115, the person 1215, the subject of operation 1905) as discussed with respect to the personalized ML model(s) 255, the personalized text ML model 515, the personalized voice ML model 525, the personalized visual ML model 535, the ML models 740, the voice model 778, the ML models 805, the ML model 810, the personalized ML model 815, the response ML model 910, the emotion ML model 920, the voice ML model 930, the personalized ML model 1010, the personalized ML model 1020, the personalized ML model 1030, the customized collective ML model 1080, the personalized ML model 1110, the ML model 1125, the ML model 1135, the ML model 1145, the personalized text ML model(s) 1220, the personalized voice ML model(s) 1230, the ML models 1305, the ML model 1310, the content-outlining ML model 1315, the system 1500, the LLM engine 1520, the LLM(s) 1525, the personalized machine learning model 1640, the personalized machine learning model of the process 1900, the personalized ML model 1640, or the personalized ML model of operation 1915 and operation 1925. The response(s) 1432 can include text response(s) (e.g., text response 545, text response 550, text response 555), voice response(s) (e.g., voice response 560, voice response 565, voice response 570), visual response(s) (e.g., visual response 580, visual response 585), or combinations thereof.

The output(s) 1430 generated by the ML model(s) 1425 in response to input of the input(s) 1405 (e.g., in response to the information 1410 and/or the previous output(s) 1415) can also include voice pattern(s) 1434, emotion(s) 1436, summary(s) 1438, visual feature(s) 1440, organizational structure(s) 1442, and/or RAG query(s) 1445. The voice pattern(s) 1434 can be used to personalize a voice ML model, such as the voice ML model 520, the personalized voice ML model 525, the voice model 778, the voice ML model 930, the personalized voice ML model(s) 1230, or a combination thereof. The voice pattern(s) 1434 can include, for example a speaking style of the subject, a writing style of the subject, a verbal tic of the subject, an accent of the subject, a dialect of the subject, a language register of the subject, an elocution of the subject, a tone associated with the subject, a diction associated with the subject, a rhetoric associated with the subject, a lexicon associated with the subject, a jargon associated with the subject, a cadence associated with the subject, an idiolect associated with the subject, a syntax associated with the subject, a linguistic persona associated with the subject, or a combination thereof.

The emotion(s) 1436 can include emotions corresponding to text of a response, and can indicate how a text response is to be read. The emotion(s) 1436, can include, for example, the emotions 925 identified corresponding to the response 915. The summary(s) 1438, can include, for example, summaries of chat sessions (e.g., summary 845, summary 855, summary 865), summaries of books chapters or other content (e.g., summary 1345, summary 1355, summary 1365), summaries of other summaries (e.g., summary 870, context file(s) 880, summary 1375), or combinations thereof. The visual feature(s) 1440 can include visual features of a person used to simulate or emulate the visual likeness of a person, for instance including hair color, eye color, skin color, relative positioning of different facial features, relative positioning of different body parts, skin texture, and the like, for instance as used by the visual ML model 530 and/or the personalized visual ML model 535 to generate the visual response 580 and/or the visual response 585. The organizational structure(s) 1442, can include, for example, breaking down of content into chapters, with tables of contents having links and/or cross-references, as in the interactive biography 1225 and/or the summary 1375 of the book. The ML model(s) 1425 can generate each of the output(s) 1430 based on the information 1410, information from the data store(s) 1475, and/or other types of input(s) 1405 (e.g., previous output(s) 1415).

In some examples, the ML model(s) 1425 can identify something in the input(s) 1405 about which the data store(s) 1475 include additional information, and can fashion at least one query (e.g., the RAG query(s) 1445) for the data store(s) 1475 to retrieve the additional information from the data store(s) 1475. For instance, if the information 1410 references a specific model of device, the RAG query(s) 1445 can include one or more queries of the data store(s) 1475 for additional information about the specific model of device, for instance to retrieve its components, configurations, settings, firmware updates, ranges of optimal operating parameters (e.g., temperature, clock speed, and so forth), or a combination thereof. The additional information retrieved from the data store(s) 1475 using the RAG query(s) 1445 can be used as part of the input(s) 1405 (e.g., as part of the information 1410 and/or part of the previous output(s) 1415) for further passes of data processing by the ML model(s) 1425.

In some examples, the ML model(s) 1425 can identify something in the input(s) 1405 about which the data store(s) 1475 include additional information, and can fashion at least one query (e.g., the RAG query(s) 1445) for the data store(s) 1475 to retrieve the additional information from the data store(s) 1475. For instance, if the information 1410 references a specific model of device, the RAG query(s) 1445 can include one or more queries of the data store(s) 1475 for additional information about the specific model of device, for instance to retrieve its components, configurations, settings, firmware updates, ranges of optimal operating parameters (e.g., temperature, clock speed, and so forth), or a combination thereof. The additional information retrieved from the data store(s) 1475 using the RAG query(s) 1445 can be used as part of the input(s) 1405 (e.g., as part of the information 1410 and/or part of the previous output(s) 1415) for further passes of data processing by the ML model(s) 1425.

In some examples, the ML system that includes the ML engine 1420 and/or ML model(s) 1425 adds the output(s) 1430 to the data store(s) 1475 (e.g., the data store(s) 280). Data can be drawn from these data store(s) to use as input(s) 1405 for the ML model(s) 1425 for generating future output(s) 1430 (e.g., as the previous output(s) 1415).

In some examples, the ML system repeats the process illustrated in FIG. 14 multiple times to generate the output(s) 1430 in multiple passes, using some of the output(s) 1430 from earlier passes as some of the input(s) 1405 in later passes (e.g., as the previous output(s) 1415). For instance, in an illustrative example, in a first pass, the ML model(s) 1425 can process the information 1410 to generate response(s) 1432 that are text-based (e.g., text response 545, text response 550, text response 555, response 915, outputs 1095, interactive biography 1225) using generative artificial intelligence (AI) content generation techniques, and to extract voice pattern(s) 1434 using audio/voice feature extraction techniques. In a second pass, the ML model(s) 1425 can add (e.g., append) the text-based response(s) from the first pass to the input(s) 1405 and/or the voice pattern(s) 1434 (e.g., as the previous output(s) 1415), and can identify emotion(s) 1436 (e.g., emotions 925) corresponding to different portions of the response, and in some cases can identify how those emotions are to influence how the portions of the response are to be read. In a third pass, ML model(s) 1425 can add (e.g., append) the text-based response(s) from the first pass to the input(s) 1405 and/or the voice pattern(s) 1434 and/or the emotion(s) 1436 (e.g., as the previous output(s) 1415), and can generate the response(s) 1432 that are voice-based (e.g., voice response 560, voice response 565, voice response 570, voice-based output 935 based on the emotions 925, the play of the interactive biography 1225 in the voice 1235 for the listener 1240) based on input of the input(s) 1405 (e.g., updated to include the information 1410 and the previous output(s) 1415 from the previous passes) into the ML model(s) 1425. In a fourth pass, the ML model(s) 1425 can add (e.g., append) the voice-based response(s) from the third pass to the input(s) 1405 (e.g., as the previous output(s) 1415), can generate feature(s) 1440 and can thus generate the response(s) 1432 that are visual (e.g., visual response 580, visual response 585) based on input of the input(s) 1405 (e.g., updated to include the information 1410 and the previous output(s) 1415 from previous passes) into the ML model(s) 1425. In a fifth pass, the ML model(s) 1425 can use the information 1410 and the previous output(s) 1415 (from previous passes) to generate the organization structure(s) 1442, for instance to organize the text response, the voice response, and/or the visual response into sections or chapters, in some cases with interactive links that allow a user to jump around between the different sections or chapters, as in the interactive biography 1225 or the summary 1375. The generation of the RAG query(s) 1445 can be included as part of, in between, before, or after any of the previous passes, wherever additional information from the data store(s) 1475 is useful.

In some examples, the ML system includes one or more feedback engine(s) 1450 that generate and/or provide feedback 1455 about the output(s) 1430. In some examples, the feedback 1455 indicates how well the output(s) 1430 align to corresponding expected output(s), how well the output(s) 1430 serve their intended purpose, or a combination thereof. In some examples, the feedback engine(s) 1450 include loss function(s), reward model(s) (e.g., other ML model(s) that are used to score the output(s) 1430), discriminator(s), error function(s) (e.g., in back-propagation), user interface feedback received via a user interface from a user, or a combination thereof. In some examples, the feedback 1455 can include one or more alignment score(s) that score a level of alignment between the output(s) 1430 and the expected output(s) and/or intended purpose.

The ML engine 1420 of the ML system can update (further train) the ML model(s) 1425 based on the feedback 1455 to perform an update 1460 (e.g., further training) of the ML model(s) 1425 based on the feedback 1455. In some examples, the feedback 1455 includes positive feedback, for instance indicating that the output(s) 1430 closely align with expected output(s) and/or that the output(s) 1430 serve their intended purpose. In some examples, the feedback 1455 includes negative feedback, for instance indicating a mismatch between the output(s) 1430 and the expected output(s), and/or that the output(s) 1430 do not serve their intended purpose. For instance, high amounts of loss and/or error (e.g., exceeding a threshold) can be interpreted as negative feedback, while low amounts of loss and/or error (e.g., less than a threshold) can be interpreted as positive feedback. Similarly, high amounts of alignment (e.g., exceeding a threshold) can be interpreted as positive feedback, while low amounts of alignment (e.g., less than a threshold) can be interpreted as negative feedback.

In response to positive feedback in the feedback 1455, the ML engine 1420 can perform the update 1460 to update the ML model(s) 1425 to strengthen and/or reinforce weights (and/or connections and/or hyperparameters) associated with generation of the output(s) 1430 to encourage the ML engine 1420 to generate similar output(s) 1430 given similar input(s) 1405. In this way, the update 1460 can improve the ML model(s) 1425 itself by improving the accuracy of the ML model(s) 1425 in generating output(s) 1430 that are similarly accurate given similar input(s) 1405. In response to negative feedback in the feedback 1455, the ML engine 1420 can perform the update 1460 to update the ML model(s) 1425 to weaken and/or remove weights (and/or connections and/or hyperparameters) associated with generation of the output(s) 1430 to discourage the ML engine 1420 from generating similar output(s) 1430 given similar input(s) 1405. In this way, the update 1460 can improve the ML model(s) 1425 itself by improving the accuracy of the ML model(s) 1425 in generating output(s) 1430 are more accurate given similar input(s) 1405. In some examples, for instance, the update 1460 can improve the accuracy of the ML model(s) 1425 in generating output(s) 1430 by reducing false positive(s) and/or false negative(s) in the output(s) 1430.

In an illustrative example, if the ML model(s) 1425 generate response(s) 1432 that are responsive to the message(s) (of the information 1410), and the feedback 1455 (e.g., further message(s) from the user) indicates that the user found the response(s) 1432 to be responsive and/or helpful, the feedback 1455 can be interpreted as positive feedback, strengthening the weights (e.g., numeric weights) of the ML model(s) 1425 that were responsible for generating the response(s) 1432 to encourage generation of similar output(s) 1430 given similar input(s) 1405. On the other hand, if the feedback 1455 (e.g., further message(s) from the user) indicates that the user found the response(s) 1432 to be non-responsive (e.g., to their message(s) in the information 1410, for instance not answering a question that was asked) and/or not helpful, the feedback 1455 can be interpreted as negative feedback, weakening or removing the weights of the ML model(s) 1425 that were responsible for generating the response(s) 1432 to discourage generation of similar output(s) 1430 given similar input(s) 1405.

In some examples, the ML engine 1420 can also perform an initial training of the ML model(s) 1425 before the ML model(s) 1425 are used to generate the output(s) 1430 based on the input(s) 1405. During the initial training, the ML engine 1420 can train the ML model(s) 1425 based on training data 1465. In some examples, the training data 1465 includes examples of input(s) (of any input types discussed with respect to the input(s) 1405), output(s) (of any output types discussed with respect to the output(s) 1430), and/or feedback (of any feedback types discussed with respect to the feedback 1455). In some cases, positive feedback in the training data 1465 can be used to perform positive training, to encourage the ML model(s) 1425 to generate output(s) similar to the output(s) in the training data given input of the corresponding input(s) in the training data. In some cases, negative feedback in the training data 1465 can be used to perform negative training, to discourage the ML model(s) 1425 from generating output(s) similar to the output(s) in the training data given input of the corresponding input(s) in the training data. In some examples, the training of the ML model(s) 1425 (e.g., the initial training with the training data 1465, update(s) 1460 based on the feedback 1455, and/or other modification(s)) can include fine-tuning of the ML model(s) 1425, retraining of the ML model(s) 1425, or a combination thereof.

In some examples, the ML model(s) 1425 can generate the output(s) 1430 dynamically and in real-time as the input(s) 1405 continue to be received by the ML model(s) 1425. This can ensure that the output(s) 1430 are generated based on up-to-date input(s) 1405.

In some examples, the ML model(s) 1425 can include an ensemble of multiple ML models, and the ML engine 1420 can curate and manage the ML model(s) 1425 in the ensemble. The ensemble can include ML model(s) 1425 that are different from one another to produce different respective outputs, which the ML engine 1420 can average (e.g., mean, median, and/or mode) to identify the output(s) 1430. In some examples, the ML engine 1420 can calculate the standard deviation of the respective outputs of the different ML model(s) 1425 in the ensemble to identify a level of confidence in the output(s) 1430. In some examples, the standard deviation can have an inverse relationship with confidence. For instance, if the respective outputs of the different ML model(s) 1425 are very different from one another (and thus have a high standard deviation above a threshold), the confidence that the output(s) 1430 are accurate may be low (e.g., below a threshold). On the other hand, if the respective outputs of the different ML model(s) 1425 are equal or very similar to one another (and thus have a low standard deviation below a threshold), the confidence that the output(s) 1430 are accurate may be high (e.g., above a threshold).

In some examples, different ML models(s) 1425 in the ensemble can include different types of models. For instance, in some examples, an ensemble can include a NN and a SVM that are both trained to process the input(s) 1405 to generate at least a subset of the output(s) 1430. In some examples, the ensemble may include different ML model(s) 1425 that are trained to process different inputs of the input(s) 1405 and/or to generate different outputs of the output(s) 1430. For instance, in some examples, a first model (or set of models) can process the input(s) 1405 to generate the response(s) 1432, a second model (or set of models) can process the input(s) 1405 to generate the voice patterns(s) 1434, a third model (or set of models) can process the input(s) 1405 to generate the emotion(s) 1436, a fourth model (or set of models) can process the input(s) 1405 to generate the summary(s) 1438, a fifth model (or set of models) can process the input(s) 1405 to generate the visual feature(s) 1440, a sixth model (or set of models) can process the input(s) 1405 to generate the organizational structure(s) 1442, and a seventh model (or set of models) can process the input(s) 1405 to generate the RAG query(s) 1445. In some examples, the ML engine 1420 can choose specific ML model(s) 1425 to be included in the ensemble because the chosen ML model(s) 1425 are effective at accurately processing particular types of input(s) 1405, are effective at accurately generating particular types of output(s) 1430, are generally accurate, process input(s) 1405 quickly, generate output(s) 1430 quickly, are computationally efficient, have higher or lower degrees of uncertainty than other models in the ensemble, or a combination thereof.

In some examples, one or more of the ML model(s) 1425 can be initialized with weights, connections, and/or hyperparameters that are selected randomly. This can be referred to as random initialization. These weights, connections, and/or hyperparameters are modified over time through training (e.g., initial training with the training data 1465 and/or update(s) 1460 based on the feedback 1455), but the random initialization can still influence the way the ML model(s) 1425 process data, and thus can still cause different ML model(s) 1425 (with different random initializations) to produce different output(s) 1430. Thus, in some examples, different ML model(s) 1425 in an ensemble can have different random initializations.

As an ML model (of the ML model(s) 1425) is trained (e.g., along the initial training with the training data 1465, update(s) 1460 based on the feedback 1455, and/or other modification(s)), different versions of the ML model at different stages of training can be referred to as checkpoints. In some examples, after each new update to a model (e.g., update 1460) generates a new checkpoint for the model, the ML engine 1420 tests the new checkpoint (e.g., against testing data and/or validation data where the correct output(s) are known) to identify whether the new checkpoint improves over older checkpoints or not, and/or if the new checkpoint introduces new errors (e.g., false positive(s) and/or false negative(s)). This testing can be referred to as checkpoint benchmark scoring. In some examples, in checkpoint benchmark scoring, the ML engine 1420 produces a benchmark score for one or more checkpoint(s) of one or more ML model(s) 1425, and keeps the checkpoint(s) that have the best (e.g., highest or lowest) benchmark scores in the ensemble. In some examples, if a new checkpoint is worse than an older checkpoint, the ML engine 1420 can revert to the older checkpoint. The benchmark score for a can represent a level of accuracy of the checkpoint and/or number of errors (e.g., false positive or false negative) by the checkpoint during the testing (e.g., against the testing data and/or the validation data). In some examples, an ensemble of the ML model(s) 1425 can include multiple checkpoints of the same ML model.

In some examples, the ML model(s) 1425 can be modified, either through the initial training (with the training data 1465), an update 1460 based on the feedback 1455, or another modification to introduce randomness, variability, and/or uncertainty into an ensemble of the ML model(s) 1425. In some examples, such modification(s) to the ML model(s) 1425 can include dropout (e.g., Monte Carlo dropout), in which one or more weights or connections are selected at random and removed. In some examples, dropout can also be performed during inference, for instance to modify the output(s) 1430 generated by the ML model(s) 1425. The term Bayesian Machine Learning (BML) can refer to random dropout, random initialization, and/or other randomization-based modifications to the ML model(s) 1425. In some examples, the modification(s) to the ML model(s) 1425 can include a hyperparameter search and/or adjustment of hyperparameters. The hyperparameter search can involve training and/or updating different ML models 1425 with different values for hyperparameters and evaluating the relative performance of the ML models 1425 (e.g., against testing data and/or validation data where the correct output(s) are known) to identify which of the ML models 1425 performs best. Hyperparameters can include, for instance, temperature (e.g., influencing level creativity and/or randomness), top P (e.g., influencing level creativity and/or randomness), frequency penalty (e.g., to prevent repetitive language between one of the output(s) 1430 and another), presence penalty (e.g., to encourage the ML model(s) 1425 to introduce new data in the output(s) 1430), other parameters or settings, or a combination thereof.

In some examples, the ML engine 1420 can perform retrieval-augmented generation (RAG) using the model(s) 1425. For instance, in some examples, the ML engine 1420 can pre-process the input(s) 1405 by retrieving additional information from one or more data store(s) 1475 (e.g., any of the databases and/or other data structures discussed herein) and using the additional information to enhance the input(s) 1405 before the input(s) 1405 are processed by the ML model(s) 1425 to generate the output(s) 1430. For instance, in some examples, the enhanced versions of the input(s) 1405 can include the additional information that the ML engine 1420 retrieved from the one or more data store(s) 1475. In some examples, the machine learning system 1400 can retrieve the additional information from one or more data store(s) 1475 by querying the data store(s) 1475 using RAG query(s) 1445 generated by the ML model(s) 1425 (or extracted from the input(s) 1405 using the ML model(s) 1425). In some examples, this RAG process provides the ML model(s) 1425 with more relevant information, allowing the ML model(s) 1425 to generate more accurate and/or personalized output(s) 1430.

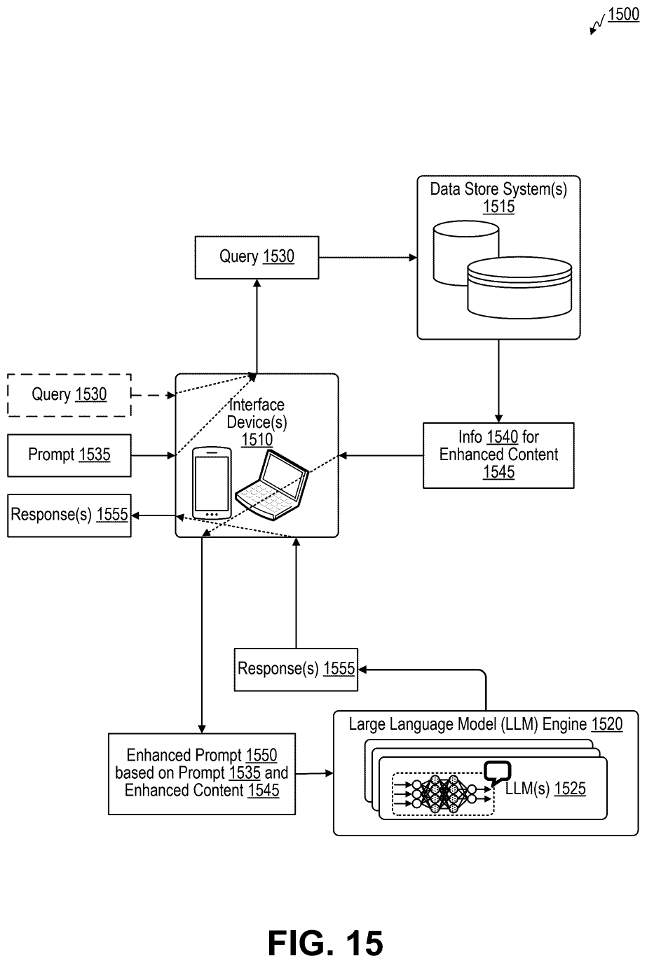

FIG. 15 is a block diagram illustrating a retrieval augmented generation (RAG) system 1500 that may be used to implement some aspects of the technology. The RAG system 1500 includes one or more interface device(s) 1510 that can receive input(s) from a user and/or a user device 128, for instance by receiving a prompt 1535 and/or a query 1530 from the user and/or the system. The prompt 1535 can be an example of a prompt in the information 1410. The query 1530 can be an example of the RAG query(s) 1445 and/or queries in the information 1410. In some examples, the interface device(s) 1510 extract the query 1530 from the prompt 1535. In some examples, the interface device(s) 1510 generate the query 1530 based on the prompt 1535 (e.g., generate the RAG query(s) 1445 based on a prompt in the information 1410).

The interface device(s) 1510 can send the query 1530 to one or more data store system(s) 1515 that include, and/or that have access to (e.g., over a network connection), various data store(s) (e.g., database(s), table(s), spreadsheet(s), tree(s), ledger(s), heap(s), and/or other data structure(s)). The data store system(s) 1515 searches the data store(s) according to the query 1530. In some examples, the interface device(s) 1510 and/or the system(s) 1515 convert the query 1530 into tensor format (e.g., vector format and/or matrix format). In some examples, the data store system(s) 1515 searches the data store(s) (e.g., the data store(s) 280) according to the query 1530 by matching the query 1530 with data in tensor format (e.g., vector format and/or matrix format) stored in the data store(s) that are accessible to the data store system(s) 1515 (e.g., data store(s) 280). The data store system(s) 1515 retrieve, from the data store(s) and based on the query 1530, information 1540 that is relevant to generating enhanced content 1545.

In some examples, the data store system(s) 1515 provide the information 1540 and/or the enhanced content 1545 to the interface device(s) 1510. In some examples, the data store system(s) 1515 provide the information 1540 to the interface device(s) 1510, and the interface device(s) 1510 generate the enhanced content 1545 based on the information 1540. The interface device(s) 1510 process the query 1530, the prompt 1535, the information 1540, and/or the enhanced content 1545 to generate an enhanced prompt 1550. The enhanced prompt 1550 is a modified version of the prompt 1535 that is modified (by the interface device(s) 1510) to add the enhanced content 1545 based on the information 1540 from the data store system(s) 1515. In some examples, the information 1540 refers to the contents of the data store(s) themselves (e.g., the data store(s) 280), while the enhanced content 1545 refers to content generated (e.g., by the data store system(s) 1515 and/or the interface device(s) 1510) to add to the prompt 1535 to generate the enhanced prompt 1550. The interface device(s) 1510 sends the enhanced prompt 1550 to large language model(s) (LLM(s) 1525) (e.g., ML model(s) 1425) of an LLM engine 1520 (e.g., ML engine 1420). The LLM(s) 1525 process the enhanced prompt 1550 to generate response(s) 1555 that are responsive to the prompt 1535. In some examples, the response(s) 1555 may be, or may include, details and/or additional details of an object that the query is based on.

In some examples, the LLM(s) 1525 generate the response(s) 1555 (e.g., including the details of an object) based on the query 1530, the prompt 1535, the information 1540, the enhanced content 1545, and/or the enhanced prompt 1550. In some examples, the LLM(s) 1525 generate the response(s) 1555 to include, be based on, and/or be conversationally responsive to, the information 1540 and/or the enhanced content 1545. The LLM(s) 1525 provides the response(s) 1555 to the interface device(s) 1510. In some examples, the interface device(s) 1510 output the response(s) 1555 to the user (e.g., to the user device of the user) that provided the query 1530 and/or the prompt 1535. In some examples, the interface device(s) 1510 output the response(s) 1555 to the system (e.g., the other ML model) that provided the query 1530 and/or the prompt 1535 to the interface device(s) 1510. In some examples, the data store system(s) 1515 may include one or more ML model(s) that are trained to perform the search of the data store(s) based on the query 1530. In some examples, the LLM(s) 1525 can be, or can include, other types of ML model(s), such as any of the types of ML models discussed with respect to the ML model(s) 1425.

In an illustrative example, the prompt 1535 is an example of the message(s) 260 (from the user received through the conversational UI 270), while the response(s) 1555 are examples of the response(s) 265 (from the personalized ML model(s) 255 output through the conversational UI 270). In some examples, the interface device(s) 1510 are examples of the client device(s) 105 and/or are associated with the conversational UI 270.

In some examples, the interface device(s) 1510 and/or the data store system(s) 1515 provide the information 1540 and/or the enhanced content 1545 directly to the LLM(s) 1525, and the interface device(s) 1510 provide the query 1530 and/or the prompt 1535 to the LLM(s) 1525. The ML engine 1520 may be an example of the ML engine 1420, or vice versa. The LLM(s) 1525 may be example(s) of the ML model(s) 1425, or vice versa.

In an illustrative example, the interface device(s) 1510 may receive the prompt 1535 as a message (of the message(s) 260) through the conversational UI 270. The prompt 1535 can, for instance, ask the personalized ML model(s) 255 to share a story from the subject's childhood. The interface device(s) 1510 can generate, based on the prompt 1535 (e.g., extract from the prompt 1535), a query 1530 to seek out more information about the story from the subject's childhood in the data store(s) (e.g., data store(s) 280) that the data store system(s) 1515 have access to. For instance, if the prompt 1535 refers to a story (e.g., “tell me the story of when you were riding your bike in Yosemite back in 1992”), the query 1530 can identify the story by a name (e.g., “the Yosemite biking story”) or set of keywords related to the story (e.g., “story,” “riding,” “bike,” “Yosemite,” and “1992,” for a story about the subject riding their bike in Yosemite in 1992). The data store system(s) 1515 can retrieve, from the data store(s) (e.g., data store(s) 280) in response to the query 1530, information 1540 about the story from the subject's childhood (e.g., details of the story about the subject riding their bike in Yosemite in 1992 from the information 220 previously obtained in previous conversations with the subject using the discovery UI 215). The interface device(s) 1510 and/or the data store system(s) 1515 can modify and/or reformat the information 1540 to match the format of the prompt 1535, thereby generating the enhanced content 1545. For instance, while the information 1540 can be in the form of a previous conversation history (e.g., in the information 220, the processed dataset 230, and/or the model personalization dataset 240), optionally with some processing already done, the prompt 1535 can tie terms in the prompt 1535 to the information 1540, for instance modifying the information 1540 to use the same terminology (e.g., “story,” “riding,” “bike,” “1992”) rather than other terms that might have been used in the information 1540 (e.g., “anecdote,” “cycling,” “bicycle,” “when I was 12 years old”). The interface device(s) 1510 and/or the data store system(s) 1515 can append the enhanced content 1545 onto the prompt 1535, or otherwise modify the prompt 1535 to incorporate the enhanced content 1545, to generate the enhanced prompt 1550. The interface device(s) 1510 can input the enhanced prompt 1550 into the LLM(s) 1525 (of the LLM engine 1520). The LLM(s) 1525 generate the response(s) 1555 based on the enhanced prompt 1550. The response(s) 1555 are conversationally responsive to the prompt 1535 and/or the enhanced prompt 1550. Because the response(s) 1555 are generated based on the enhanced prompt 1550 (e.g., with the prompt 1535 as well as the enhanced content 1545), the LLM(s) 1525 have more information to draw from (e.g., the information 1540 and/or enhanced content 1545) when generating the response(s) 1555, ultimately resulting in the response(s) 1555 being more detailed, more accurate, and more personalized than they would be otherwise.

The data store system(s) 1515 can output this information 1540 to the interface device(s) 1510, which can generate enhanced content 1545 and/or enhanced prompt 1550. In some examples, the enhanced content 1545 adds or appends the information 1540 to the prompt 1535 and/or the query 1530. In some examples, the data store system(s) 1515 and/or the interface device(s) 1510 generate the enhanced content 1545 and/or enhanced prompt 1550 by modifying the query 1530 and/or the prompt 1535 before providing the query 1530 and/or the prompt 1535 to the LLM(s) 1525. For instance, the data store system(s) 1515 and/or the interface device(s) 1510 can generate the enhanced content 1545 by modifying the query 1530 and/or the prompt 1535 to instruct the LLM(s) 1525 to generate the response(s) 1555 with specific SIO element(s). In this way, the LLM(s) 1525 do not need to seek out specific components of the object, because the query 1530 and/or the prompt 1535 are already modified to include this information. In this way, the LLM(s) 1525 are more optimally configured to generate response(s) 1555 that are accurate and factor in up-to-date SIO element(s) from the data store(s) that the data store system(s) 1515 have access to.

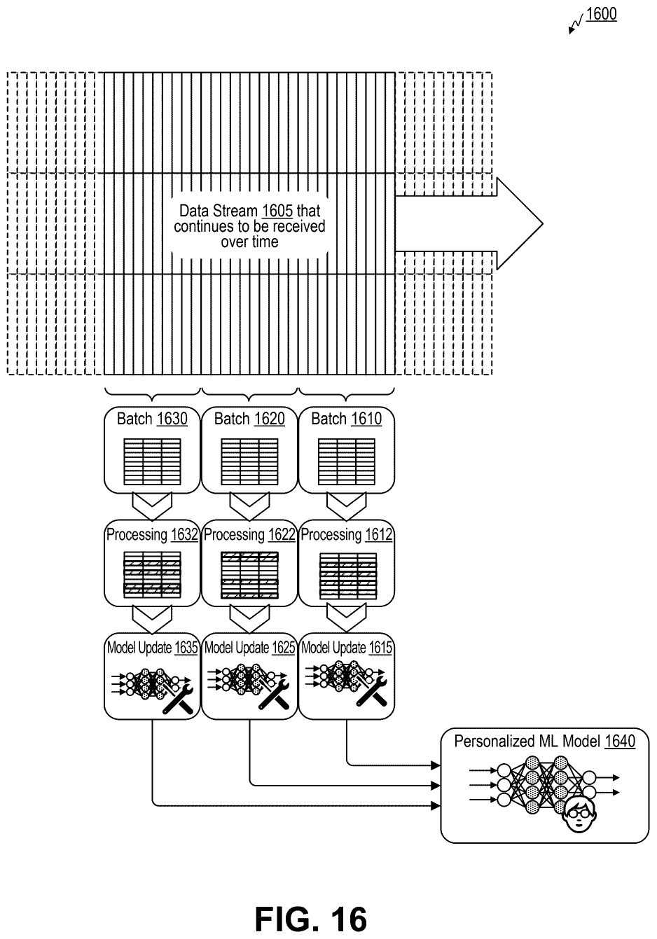

FIG. 16 is a conceptual diagram illustrating a process 1600 for dynamically updating a personalized machine learning model 1640 in a continuous fashion as further data continues to be received over time. A data stream 1605 is illustrated, which can represent, for instance, a stream of data to be input into the personalized machine learning model 1640 and/or that the personalized machine learning model 1640 is to be trained, retrained, fine-tuned, and/or updated based on. The data stream 1605 includes large quantities of data that continue to come on over a long period of time. In some examples, a system (e.g., the special-purpose server system(s) 110) can extract batches of data (e.g., batch 1610, batch 1620, batch 1630) from the data stream dynamically and in real-time (or near-real-time) as the data from the data stream 1605 continues to be received by the system. In some examples, the system (e.g., the special-purpose server system(s) 110) can process the batches of data dynamically and in real-time (or near-real-time) as the data from the data stream 1605 continues to be received by the system to generate model updates. The model updates can include training data, fine-tuning data, context data, model parameters (e.g., temperature, top P, frequency penalty, presence penalty and/or other parameters or settings) for training, re-training, fine-tuning, and/or updating the personalized machine learning model 1640. For instance, the batch 1610 undergoes processing 1612 to generate the model update 1615. The batch 1620 undergoes processing 1622 to generate the model update 1625. The batch 1630 undergoes processing 1632 to generate the model update 1635. The system (e.g., the ML model subsystem 245 of the special-purpose server system(s) 110) trains, retrains, fine-tunes, and/or updates the personalized machine learning model 1640 based on the model update 1615, the model update 1625, and/or the model update 1635, sequentially, in parallel, and/or in further batches of model updates. In this way, the system (e.g., the ML model subsystem 245 of the special-purpose server system(s) 110) continues to dynamically train, retrain, fine-tune, and/or update the personalized machine learning model 1640 in real-time (or near-real-time) as the data from the data stream 1605 continues to be received by the system.

In some examples, the processing 1612, the processing 1622, and/or the processing 1632, can include processing operations such as those discussed with respect to operation 125, operation 130, the data parser 225, the model personalization data generator 235, and/or the intermediary processor 275. In some examples, the data stream 1605 may include, for instance, information 220 about the subject that can continue to be received over time (e.g., from further interviews with the subject and/or other users, from further information found from other sources such as websites or network databases, and the like), message(s) 260 from the user via the conversational UI 270, previous response(s) 265, data stored in the data store(s) 280, any of the inputs 590, any of the outputs 595, messages received via the UI 605, messages received via the UI 650, any of the input(s) 1405, any of the output(s) 1430, the feedback 1455, the input data of operation 1905 and operation 1910, the message of operation 1920, the response of operation 1925 and operating 1930, any other type of data discussed herein, or a combination thereof.

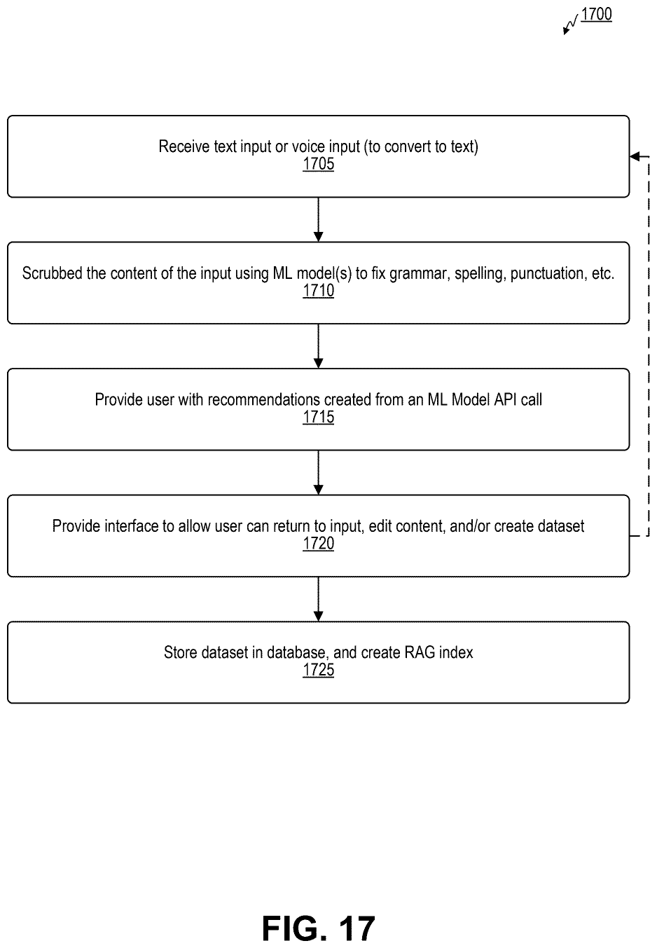

FIG. 17 is a flow diagram illustrating a process 1700 for machine learning model training. The process 1900 may be performed by a machine learning model personalization system. In some examples, the machine learning model personalization system can include, for example, the client device(s) 105, the special-purpose server system(s) 110, the model personalization system 200, the discovery UI 215, the discovery engine 205, the data parser 225, the model personalization data generator 235, the ML model subsystem 245, the ML model(s) 250, the personalized ML model(s) 255, the conversational UI 270, the data store(s) 280, the ML models 505, the text ML model 510, the personalized text ML model 515, the voice ML model 520, the personalized voice ML model 525, the visual ML model 530, the personalized visual ML model 535, the UI 605, the UI 650, the ML engine 1420, the ML model(s) 1425, the feedback engine(s) 1450, the personalized ML model 1640, the machine learning model personalization system that performs the process 1800, the machine learning model personalization system that performs the process 1900, the computing system 2000, the processor 2010, an apparatus, a system, a memory storing instructions to be performed by a processor, a non-transitory computer-readable medium storing instructions to be performed by a processor, an artificial intelligence (AI) accelerator, a central processing unit (CPU), a graphics processing unit (GPU), an accelerated processing unit (APU), a neural processing unit (NPU), a sub-system or component of any of the previously-listed systems, or a combination thereof.

At operation 1705, the machine learning model personalization system (or a component or subsystem thereof) is configured to, and can, receive a text input and/or a voice input. In some examples, the machine learning model personalization system (or a component or subsystem thereof) is configured to, and can, use a speech-to-text algorithm (e.g., of the data parser 225) to convert a voice input into text (e.g., a transcript of the voice input).

At operation 1710, the machine learning model personalization system (or a component or subsystem thereof) is configured to, and can, scrub the content of the input(s) (of operation 1705), for instance using trained machine learning model(s) (e.g., the ML model subsystem 245, the ML model(s) 250, the personalized ML model(s) 255, the ML models 505, the text ML model 510, the personalized text ML model 515, the voice ML model 520, the personalized voice ML model 525, the visual ML model 530, the personalized visual ML model 535, the ML engine 1420, the ML model(s) 1425, the LLM(s) 1525, the personalized ML model 1640, other ML model(s) discussed herein, or combination(s) thereof). The scrubbing can be used to correct issues with grammar, spelling, punctuation, remove terms (e.g., profanity or sensitive data), and the like, for instance as discussed with respect to operation 718.

At operation 1715, the machine learning model personalization system (or a component or subsystem thereof) is configured to, and can, provide the user with recommendations created from an ML model application programming interface (API) call.

At operation 1720, the machine learning model personalization system (or a component or subsystem thereof) is configured to, and can, provide an interactive interface that allows user can return to inputting additional data (e.g., returning to operation 1705), editing content, and/or creating a dataset.

At operation 1725, the machine learning model personalization system (or a component or subsystem thereof) is configured to, and can, store the dataset in database (e.g., the data store(s) 280, the chunks data store 726, the chat history data store 780, the RAG data store 792, the RAG data store 1385, the data store(s) 1475, the data store system(s) 1515), and create RAG index.

Some datasets can optionally have one (and only one) media item. Nearly all file types (images, video, documents, presentations are supported. The text content for a media item can include a description of the media content.

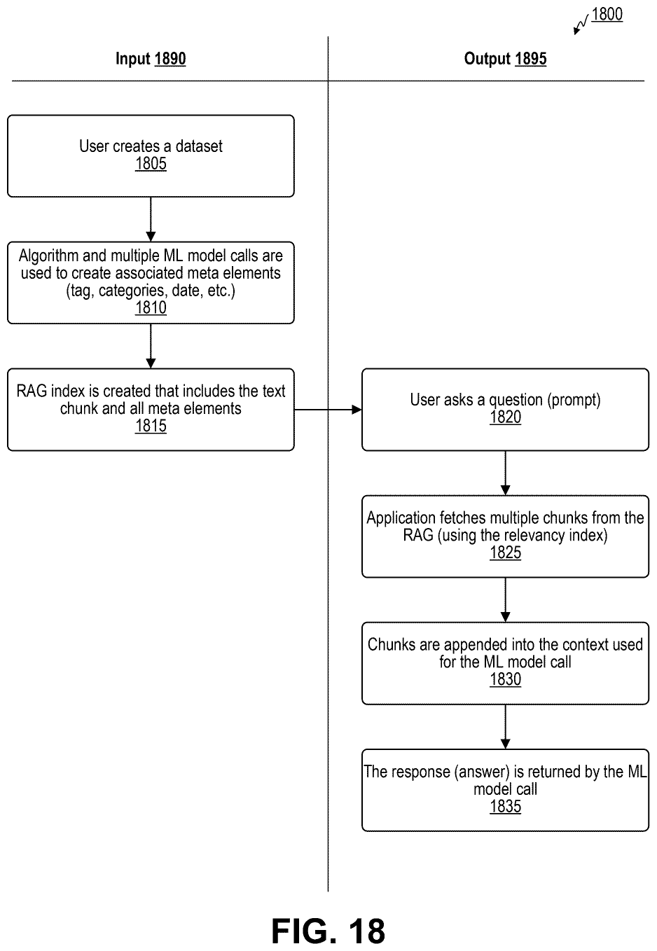

FIG. 18 is a swim lane diagram illustrating a process 1800 for retrieval augmented generation (RAG). The process 1900 may be performed by a machine learning model personalization system. In some examples, the machine learning model personalization system can include, for example, the client device(s) 105, the special-purpose server system(s) 110, the model personalization system 200, the discovery UI 215, the discovery engine 205, the data parser 225, the model personalization data generator 235, the ML model subsystem 245, the ML model(s) 250, the personalized ML model(s) 255, the conversational UI 270, the data store(s) 280, the ML models 505, the text ML model 510, the personalized text ML model 515, the voice ML model 520, the personalized voice ML model 525, the visual ML model 530, the personalized visual ML model 535, the UI 605, the UI 650, the ML engine 1420, the ML model(s) 1425, the feedback engine(s) 1450, the personalized ML model 1640, the machine learning model personalization system that performs the process 1700, the machine learning model personalization system that performs the process 1900, the computing system 2000, the processor 2010, an apparatus, a system, a memory storing instructions to be performed by a processor, a non-transitory computer-readable medium storing instructions to be performed by a processor, an artificial intelligence (AI) accelerator, a central processing unit (CPU), a graphics processing unit (GPU), an accelerated processing unit (APU), a neural processing unit (NPU), a sub-system or component of any of the previously-listed systems, or a combination thereof.

At operation 1805, in the input lane 1890, the machine learning model personalization system (or a component or subsystem thereof) is configured to, and can, create a dataset through user input.

At operation 1810, in the input lane 1890, the machine learning model personalization system (or a component or subsystem thereof) is configured to, and can, create a dataset through user input, use algorithm(s) and ML model call(s) to create associated meta elements (e.g., tag, categories, date, and the like). Meta elements can be referred to as metadata or metadata elements.

At operation 1815, in the input lane 1890, the machine learning model personalization system (or a component or subsystem thereof) is configured to, and can, create a RAG index that includes the text chunk and all meta elements. RAG text chunks can differ from the dataset text chunk, as they can include additional content such as a link (e.g., hyperlink) to a uniform resource identifier (URI) or unfirm resource location (URL) for a media file (e.g., an image, a video, an audio file, a document, or a combination thereof).

At operation 1820, in the output lane 1895, the machine learning model personalization system (or a component or subsystem thereof) is configured to, and can, receive a question (e.g., message(s) 260) from the user through a user interface (e.g., conversational UI 270).

At operation 1825, in the output lane 1895, the machine learning model personalization system (or a component or subsystem thereof) is configured to, and can, call an application to fetch multiple chunks from RAG data store(s) (e.g., the data store(s) 280, the chunks data store 726, the chat history data store 780, the RAG data store 792, the RAG data store 1385, the data store(s) 1475, the data store system(s) 1515), for instance fetching the chunks based on a relevancy index (e.g., fetching the chunks for which a relevancy index or metric exceeds a threshold).

At operation 1830, in the output lane 1895, the machine learning model personalization system (or a component or subsystem thereof) is configured to, and can, append chunks into the context (e.g., into the context file(s) 880) used for the ML model call.

At operation 1835, in the output lane 1895, the machine learning model personalization system (or a component or subsystem thereof) is configured to, and can, generate a response using for the ML model call, and return the response through a conversational UI (e.g., conversational UI 270) as received from the ML model call.

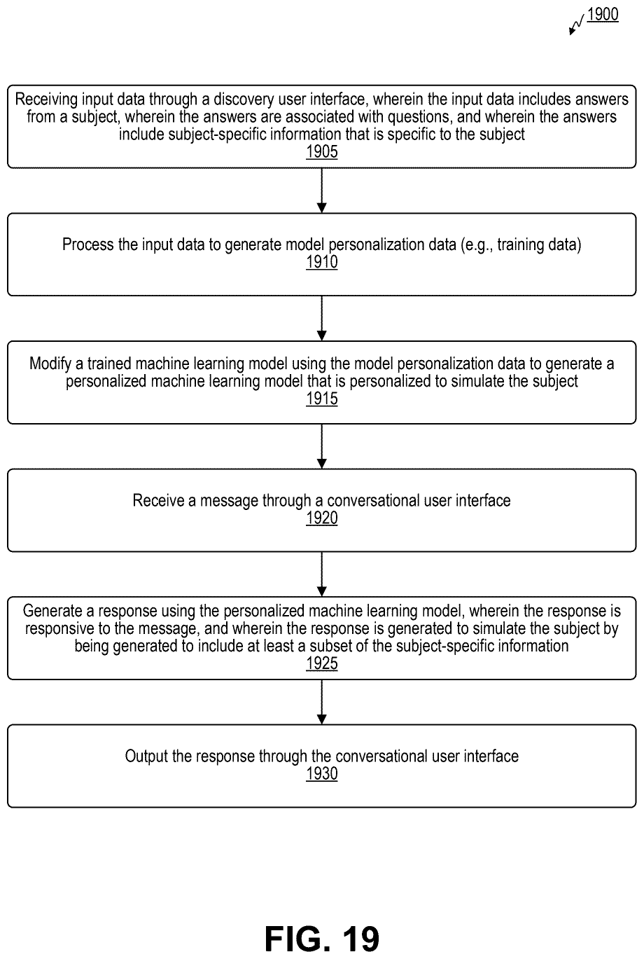

FIG. 19 is a flow diagram illustrating a process 1900 for machine learning model personalization. The process 1900 may be performed by a machine learning model personalization system. In some examples, the machine learning model personalization system can include, for example, the client device(s) 105, the special-purpose server system(s) 110, the model personalization system 200, the discovery UI 215, the discovery engine 205, the data parser 225, the model personalization data generator 235, the ML model subsystem 245, the ML model(s) 250, the personalized ML model(s) 255, the conversational UI 270, the data store(s) 280, the ML models 505, the text ML model 510, the personalized text ML model 515, the voice ML model 520, the personalized voice ML model 525, the visual ML model 530, the personalized visual ML model 535, the UI 605, the UI 650, the ML engine 1420, the ML model(s) 1425, the feedback engine(s) 1450, the personalized ML model 1640, the machine learning model personalization system that performs the process 1700, the machine learning model personalization system that performs the process 1800, the computing system 2000, the processor 2010, an apparatus, a system, a memory storing instructions to be performed by a processor, a non-transitory computer-readable medium storing instructions to be performed by a processor, an artificial intelligence (AI) accelerator, a central processing unit (CPU), a graphics processing unit (GPU), an accelerated processing unit (APU), a neural processing unit (NPU), a sub-system or component of any of the previously-listed systems, or a combination thereof.

At operation 1905, the machine learning model personalization system (or a component or subsystem thereof) is configured to, and can, receive input data through a discovery user interface (e.g., discovery UI 215). In some examples, input data includes answers (e.g., information 220) from a subject (e.g., a person). The answers are associated with (e.g., responsive to) questions (e.g., the instructions 210). The answers include subject-specific information that is specific to the subject. Examples of the subject include the subject of operation 120, the subject person using the discovery UI 215, the persona for the persona training of FIG. 7, the person 1015, the person 1025, the person 1035, the person 1115, and/or the person 1215.

In some examples, the subject-specific information includes at least one of a memory of the subject, an experience of the subject, a bias of the subject, an opinion of the subject, a hobby of the subject, a sport associated with the subject, an affiliation of the subject, an accolade associated with the subject, an image of the subject, a video of the subject, a document associated with the subject, a website associated with the subject, or a combination thereof. In some examples, the subject-specific information includes information from one or more previous responses previously generated using the personalized machine learning model (e.g., previous output(s) 1415).

At operation 1910, the machine learning model personalization system (or a component or subsystem thereof) is configured to, and can, process the input data to generate model personalization data. The model personalization data can include training data, fine-tuning data, model parameters (e.g., hyperparameters), portions of a prompt (e.g., a role, instructions on how to respond), or combinations thereof. Examples of the input data, the subject-specific information, and/or the model personalization data include the information about the subject received in operation 120, the processed information of operation 125, the training data of operation 130, the information 220 about the subject, the processed dataset 230, the model personalization dataset 240, the input data 305, the spreadsheet 330, the context data 340, the table 400, the input(s) 590, the input(s) 1405, the previous output(s) 1415, the training data 1470, information about the subject in the data stream 1605, other subject-specific information discussed herein, other training data and/or model personalization data discussed herein, or a combination thereof. The processing of the input data to generate the model personalization data can include the parsing and/or analyzing of the data as in the data parser 225, the generation of training data as in the model personalization data generator 235, filtering out of portions of the input data that are not necessary for the model personalization data (e.g., to improve efficiency of model personalization), operations of the guided training sub-process 710, operations of the AI-assisted training sub-process 728, operations of the training sub-process 734, the operations of the updating sub-process 782, other operations discussed herein, or a combination thereof.

In some examples, processing the input data (as in operation 1910) includes parsing the input data to extract a plurality of data elements, and categorizing the plurality of data elements into a plurality of categories of data. In some examples, processing the input data (as in operation 1910) includes converting the input data into a spreadsheet (e.g., the processed dataset 230 and/or a CSV file) (e.g., as in the data parser 225). In some examples, processing the training data (as in operation 1910) includes converting the input data into a JavaScript Object Notation (JSON) file (e.g., the model personalization dataset 240) (e.g., as in the model personalization data generator 235).

At operation 1915, the machine learning model personalization system (or a component or subsystem thereof) is configured to, and can, modify a trained machine learning model using the model personalization data to generate a personalized machine learning model that is personalized to simulate the subject. In some examples, modifying the trained machine learning model using the model personalization data can include further training (e.g., updating) of the trained machine learning model using training data of the model personalization data, fine-tuning of the trained machine learning model using fine-tuning data of the model personalization data, adjusting model parameters (e.g., hyperparameters) of the trained machine learning model using model parameters (e.g., hyperparameters) or changes thereto identified in the model personalization data, modifying prompt(s) provided to the trained machine learning model to add or include portions of a prompt (e.g., a role, instructions on how to respond) identified in the model personalization data, or a combination thereof.

In some examples, the processing of operation 1910 improves efficiency of personalizing the model at operation 1915, for instance by filtering out unnecessary data, such as content that is not specific to the subject (e.g., content that would result in a more a non-personalized model). In some examples, the processing of operation 1910 and/or the personalizing the model at operation 1915 can filter out content from the (non-personalized) trained machine learning model, and can improve the efficiency, speed, and/or throughput of the personalized machine learning model relative to the (non-personalized) trained machine learning model based on this filtering.

Examples of the trained machine learning model (before the modification of operation 1915) include the ML model subsystem 245, the ML model(s) 250, some of the ML models 505, the text ML model 510, the voice ML model 520, the visual ML model 530, the ML engine 1420, some of the ML model(s) 1425, the LLM(s) 1525, other ML model(s) discussed herein, or combination(s) thereof. Examples of the personalized machine learning model (after the modification of operation 1915) include the ML model subsystem 245, the personalized ML model(s) 255, some of the ML models 505, the personalized text ML model 515, the personalized voice ML model 525, the personalized visual ML model 535, the ML engine 1420, some of the ML model(s) 1425, the LLM(s) 1525, the personalized ML model 1640, other personalized ML model(s) discussed herein, or combination(s) thereof. In some examples, the trained machine learning model is a large language model (LLM) (e.g., the LLM(s) 1525).

In some examples, modifying the trained machine learning model using the model personalization data (as in operation 1915) includes fine-tuning the trained machine learning model using the model personalization data. In some examples, modifying the trained machine learning model using the training data (as in operation 1915) includes further training the trained machine learning model using the model personalization data.

In some examples, modifying the trained machine learning model using the training data (as in operation 1915) includes modifying a hyperparameter of the trained machine learning model based on the model personalization data.

At operation 1920, the machine learning model personalization system (or a component or subsystem thereof) is configured to, and can, receive a message. Examples of the message can include the message(s) received from the user in operation 140, the message(s) 260 received by the special-purpose server system(s) 110 from the client device(s) 105 (e.g., received from the user through the conversational UI 270), the message 540, the message 610, the message 620, the user prompt of operation 746, further messages of the chat function sub-process 754, the message 830, the message 905, the message 1040, the message 1050, the message 1060, the message 1070, messages 1245, the prompt 1370, the input(s) 1405, the message(s) in the information 1410, the query 1530, the prompt 1535, message(s) in the data stream 1605, or a combination thereof.

In some examples, the message is received through a graphical user interface (GUI), such as the conversational UI 270, the UI 605, and/or the UI 650.

At operation 1925, the machine learning model personalization system (or a component or subsystem thereof) is configured to, and can, generate a response using the personalized machine learning model. The response is responsive to the message. The response simulates the subject by including at least a subset of the subject-specific information. Examples of the response include the response(s) generated in operation 145, the response(s) 265, the text response 545, the text response 550, the text response 555, the voice response 560, the voice response 565, the voice response 570, the visual response 580, the visual response 585, the response 615, the response 625, the text response of operation 760, the voice response of operation 764, the summary 845, the summary 855, the summary 865, the summary 870, the response 835, the response 915, the emotions 925, the voice-based output 935, text response 1045, the text response 1055, the text response 1065, the text response 1075, interactive biography 1225, the responses 1250 to the messages 1245, the update 1255 to the interactive biography 1225, the summary 1345, the summary 1355, the summary 1365, the summary 1375, the previous output(s) 1415, the output(s) 1430, the response(s) 1432, the response(s) 1555, another response discussed herein, or a combination thereof.

In some examples, modifying the trained machine learning model using the model personalization data (as in operation 1915) includes modifying contextual data for a prompt (e.g., a role, instructions in the prompt on how responses are to be generated) associated with the message. The response is responsive to the prompt, and the prompt includes the contextual data and the message.

At operation 1930, the machine learning model personalization system (or a component or subsystem thereof) is configured to, and can, output the response.

In some examples, the machine learning model personalization system (or a component or subsystem thereof) is configured to, and can, process the response using a text-to-speech algorithm to generate an audio response, wherein the audio response vocalizes the response, and wherein outputting the response includes outputting the audio response.

In some examples, the machine learning model personalization system (or a component or subsystem thereof) is configured to, and can, process voice input data to generate voice model personalization data. The machine learning model personalization system can modify a second trained machine learning model (e.g., voice ML model 520, 778//, 930//, personalized voice ML model(s) 1230) using the voice model personalization data to generate a personalized voice machine learning model (e.g., personalized voice ML model 525) that is personalized to simulate a voice of the subject. In some examples, the voice model personalization data includes data based on recorded utterances as discussed with respect to the voice capture (sub-process 770). In some examples, the voice model personalization data includes the 1434// and/or other data extracted using 1425//. The machine learning model personalization system can process the response (e.g., text response 555, 915//) using the personalized voice machine learning model to generate an audio response (e.g., voice response 565, 935//). The audio response vocalizes the response via a simulation of the voice of the subject. In some examples, outputting the response (as in operation 1930) includes outputting the audio response.

In some examples, the voice model personalization data includes training data, and modifying the second trained machine learning model using the voice model personalization data includes further training the second trained machine learning model further using the training data. In some examples, the voice model personalization data includes fine-tuning data, and modifying the second trained machine learning model using the voice model personalization data includes fine-tuning the second trained machine learning model further using the fine-tuning data. In some examples, the voice model personalization data includes model parameter(s), and modifying the second trained machine learning model using the voice model personalization data includes setting or adjusting model parameter(s) (e.g., hyperparameters) of the second trained machine learning model further using the model parameter(s).

In some examples, the machine learning model personalization system (or a component or subsystem thereof) is configured to, and can, process the response using a second trained machine learning model (e.g., the 920//) to identify emotions (e.g., the 925//) corresponding to portions of the response (e.g., the 925// corresponding to the portions of the 915//). In some examples, outputting the response (as in operation 1930) includes outputting a synthesized voice that reads the response according to audio characteristics (e.g., pitch, volume, tone, speed, and/or ranges for variability of these) that are set based on the identified emotions.

In some examples, the conversational user interface is a text-based user interface, as in the 605//. In some examples, the conversational user interface is a voice-based user interface and/or video-based user interface, as in the 650//.

In some examples, the machine learning model personalization system (or a component or subsystem thereof) is configured to, and can, process visual input data to generate visual model personalization data. The machine learning model personalization system can modify a second trained machine learning model (e.g., visual ML model 530) using the visual model personalization data to generate a personalized visual machine learning model (e.g., personalized visual ML model 535) that is personalized to simulate an appearance of the subject. The machine learning model personalization system can process the response (e.g., text response 555 and/or voice response 570) using the personalized visual machine learning model to generate a visual response (e.g., visual response 585). The visual response includes mouth movements associated with vocalizing the response via a simulation of the appearance of the subject. In some examples, outputting the response (as in operation 1930) includes outputting the visual response.

In some examples, the visual model personalization data includes training data, and modifying the second trained machine learning model using the visual model personalization data includes further training the second trained machine learning model further using the training data. In some examples, the visual model personalization data includes fine-tuning data, and modifying the second trained machine learning model using the visual model personalization data includes fine-tuning the second trained machine learning model further using the fine-tuning data. In some examples, the visual model personalization data includes model parameter(s), and modifying the second trained machine learning model using the visual model personalization data includes setting or adjusting model parameter(s) (e.g., hyperparameters) of the second trained machine learning model further using the model parameter(s).

In some examples, the machine learning model personalization system (or a component or subsystem thereof) is configured to, and can, receive a second message after the response is output (at operation 1930). The machine learning model personalization system can extract feedback (e.g., feedback 1455) about the response from the second message. The machine learning model personalization system (e.g., ML engine 1420) can update (e.g., update 1460) the personalized machine learning model (e.g., ML model(s) 1425) further based on the feedback. The machine learning model personalization system can generate a second response using the personalized machine learning model (e.g., as updated based on the feedback). The second response is responsive (e.g., conversationally responsive) to the second message. The machine learning model personalization system can output the second response. In some examples, updating the personalized machine learning model further based on the feedback includes further training the personalized machine learning model based on the feedback. In some examples, updating the personalized machine learning model further based on the feedback includes further fine-tuning the personalized machine learning model based on the feedback. In some examples,

In some examples, the subject-specific information includes a link, and the response includes the link. In some examples, the subject-specific information includes a file, the response includes a link, and the file is accessible through the link. Examples of such links are discussed with respect to the table 400.

In some examples, the personalized machine learning model is personalized to simulate the subject at least by simulating at least one of a speaking style of the subject, a writing style of the subject, a verbal tic of the subject, an accent of the subject, a dialect of the subject, a language register of the subject, an elocution of the subject, a tone associated with the subject, a diction associated with the subject, a rhetoric associated with the subject, a lexicon associated with the subject, a jargon associated with the subject, a cadence associated with the subject, an idiolect associated with the subject, a syntax associated with the subject, or a linguistic persona associated with the subject. In some examples, the response is generated to simulate the subject also by being generated to simulate at least one of a speaking style of the subject, a writing style of the subject, a verbal tic of the subject, an accent of the subject, a dialect of the subject, a language register of the subject, an elocution of the subject, a tone associated with the subject, a diction associated with the subject, a rhetoric associated with the subject, a lexicon associated with the subject, a jargon associated with the subject, a cadence associated with the subject, an idiolect associated with the subject, a syntax associated with the subject, or a linguistic persona associated with the subject.

In some examples, the machine learning model personalization system (or a component or subsystem thereof) is configured to, and can, identify a second trained machine learning model (e.g., ML model 1125, ML model 1135, and/or ML model 1145) based on the model personalization data (e.g., based on the model personalization data identifying the topic 1130, the topic 1140, and/or the topic 1150). In some examples, modifying the trained machine learning model using the model personalization data to generate the personalized machine learning model (as in operation 1915) includes combining the trained machine learning model (e.g., the version 1120 of the personalized ML model 1110) and the second trained machine learning model (e.g., ML model 1125, ML model 1135, and/or ML model 1145) to generate the personalized machine learning model (e.g., the updated version 1155 of the personalized ML model 1110).

In some examples, the machine learning model personalization system (or a component or subsystem thereof) is configured to, and can, identify a second personalized machine learning model that is configured to simulate a second subject (e.g., the personalized ML model 1020 for the second person 1025, the personalized ML model 1030 for the third person 1035). In some examples, the machine learning model personalization system is configured to, and can, combine the personalized machine learning model (e.g., the personalized ML model 1010 for the first person 1015) and the second personalized machine learning model (e.g., the personalized ML model 1020 for the second person 1025, the personalized ML model 1030 for the third person 1035) to generate a group-specific personalized machine learning model (e.g. Customized collective ML model 1080) configured to simulate a group. The group includes the subject (e.g., first person 1015) and the second subject (e.g., the second person 1025 and/or the third person 1035).

In some examples, the machine learning model personalization system (or a component or subsystem thereof) is configured to, and can, generate a biographical narrative (e.g., interactive biography 1225) about the subject (e.g., person 1215) using the personalized machine learning model (e.g., personalized text ML model(s) 1220). The machine learning model personalization system can output the biographical narrative using the conversational user interface (e.g., conversational UI 270), for instance to another user (e.g., listener 1240). The conversational user interface can be text-based or voice-based. In some examples, receiving the message (as in operation 1920) interrupts the biographical narrative, for instance like the receipt of the messages 1245 interrupts the output of the interactive biography 1225. In some examples, the response (e.g., responses 1250) is associated with the message (e.g., messages 1245) and the biographical narrative (e.g., interactive biography 1225). In some examples, the model personalization system resumes output of the biographical narrative (e.g., interactive biography 1225) after outputting the response. In some examples, the model personalization system updates the biographical narrative (e.g., via update 1255 to the interactive biography 1225) based on the response (e.g., responses 1250) and/or the message (e.g., messages 1245).

In some examples, the processes described herein may be performed by a computing device or apparatus. The computing device can include any suitable device, such as a mobile device (e.g., a mobile phone), a desktop computing device, a tablet computing device, a wearable device (e.g., a VR headset, an AR headset, AR glasses, a network-connected watch or smartwatch, or other wearable device), a server computer, an autonomous vehicle or computing device of an autonomous vehicle, a robotic device, a television, and/or any other computing device with the resource capabilities to perform the processes described herein. In some cases, the computing device or apparatus may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, a network interface configured to communicate and/or receive the data, any combination thereof, and/or other component(s). The network interface may be configured to communicate and/or receive Internet Protocol (IP) based data or other type of data.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

The processes described herein are illustrated as logical flow diagrams, block diagrams, or conceptual diagrams, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the processes described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

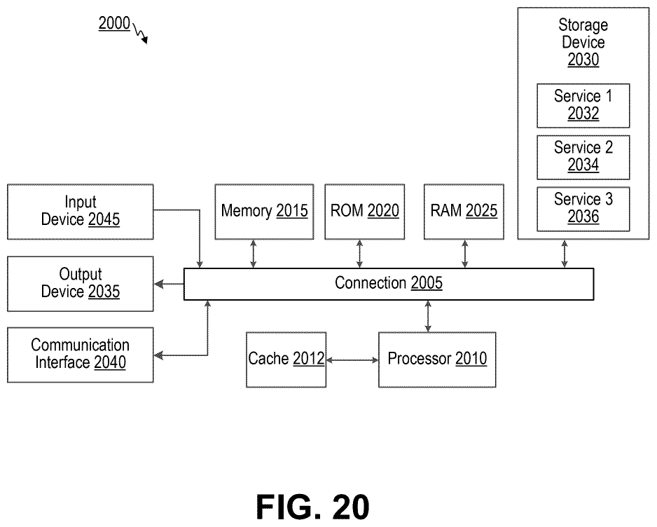

FIG. 20 is a diagram illustrating an example of a system for implementing certain aspects of the present technology. In particular, FIG. 20 illustrates an example of computing system 2000, which can be for example any computing device making up internal computing system, a remote computing system, a camera, or any component thereof in which the components of the system are in communication with each other using connection 2005. Connection 2005 can be a physical connection using a bus, or a direct connection into processor 2010, such as in a chipset architecture. Connection 2005 can also be a virtual connection, networked connection, or logical connection.

In some aspects, computing system 2000 is a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

Example system 2000 includes at least one processing unit (CPU or processor) 2010 and connection 2005 that couples various system components including system memory 2015, such as read-only memory (ROM) 2020 and random access memory (RAM) 2025 to processor 2010. Computing system 2000 can include a cache 2012 of high-speed memory connected directly with, in close proximity to, or integrated as part of processor 2010.

Processor 2010 can include any general purpose processor and a hardware service or software service, such as services 2032, 2034, and 2036 stored in storage device 2030, configured to control processor 2010 as well as a special-purpose processor where software instructions are incorporated into the actual processor design. Processor 2010 may essentially be a completely self-contained computing system, containing multiple cores or processors, a bus, memory controller, cache, etc. A multi-core processor may be symmetric or asymmetric.

To enable user interaction, computing system 2000 includes an input device 2045, which can represent any number of input mechanisms, such as a microphone for speech, a touch-sensitive screen for gesture or graphical input, keyboard, mouse, motion input, speech, etc. Computing system 2000 can also include output device 2035, which can be one or more of a number of output mechanisms. In some instances, multimodal systems can enable a user to provide multiple types of input/output to communicate with computing system 2000. Computing system 2000 can include communications interface 2040, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 2002.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 2040 may also include one or more Global Navigation Satellite System (GNSS) receivers or transceivers that are used to determine a location of the computing system 2000 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 2030 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L5/L#), resistive random-access memory (RRAM/ReRAM), phase change memory (PCM), spin transfer torque RAM (STT-RAM), another memory chip or cartridge, and/or a combination thereof.

The storage device 2030 can include software services, servers, services, etc., that when the code that defines such software is executed by the processor 2010, it causes the system to perform a function. In some aspects, a hardware service that performs a particular function can include the software component stored in a computer-readable medium in connection with the necessary hardware components, such as processor 2010, connection 2005, output device 2035, etc., to carry out the function.

As used herein, the term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted using any suitable means including memory sharing, message passing, token passing, network transmission, or the like.

In some aspects, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” means A, B, or A and B. In another example, claim language reciting “at least one of A, B, and C” means A, B, C, or A and B, or A and C, or B and C, or A and B and C. The language “at least one of” a set and/or “one or more” of a set does not limit the set to the items listed in the set. For example, claim language reciting “at least one of A and B” can mean A, B, or A and B, and can additionally include items not listed in the set of A and B.

The various illustrative logical blocks, modules, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for encoding and decoding, or incorporated in a combined video encoder-decoder (CODEC).

Illustrative aspects of the disclosure include:
Aspect 1. A method for machine learning model personalization, the method comprising: receiving input data through a discovery user interface, wherein the input data includes answers from a subject, wherein the answers are associated with questions, and wherein the answers include subject-specific information that is specific to the subject; processing the input data to generate model personalization data; modifying a trained machine learning model using the model personalization data to generate a personalized machine learning model that is personalized to simulate the subject; receiving a message through a conversational user interface; generating a response using the personalized machine learning model, wherein the response is responsive to the message, and wherein the response is generated to simulate the subject by being generated to include at least a subset of the subject-specific information; and outputting the response through the conversational user interface.
Aspect 2. The method of aspect 1, wherein modifying the trained machine learning model using the model personalization data includes fine-tuning the trained machine learning model using the model personalization data.
Aspect 3. The method of aspect 1, wherein the model personalization data includes training data, and wherein modifying the trained machine learning model using the model personalization data includes further training the trained machine learning model using the training data.
Aspect 4. The method of aspect 1, wherein modifying the trained machine learning model using the model personalization data includes modifying contextual data for a prompt associated with the message, wherein the response is responsive to the prompt, and wherein the prompt includes the contextual data and the message.
Aspect 5. The method of aspect 1, wherein modifying the trained machine learning model using the model personalization data includes modifying a hyperparameter of the trained machine learning model based on the model personalization data.
Aspect 6. The method of aspect 1, wherein processing the input data includes parsing the input data to extract a plurality of data elements, wherein processing the input data further includes categorizing the plurality of data elements into a plurality of categories of data.
Aspect 7. The method of aspect 1, wherein processing the input data includes converting the input data into a spreadsheet.
Aspect 8. The method of aspect 1, wherein processing the model personalization data includes converting the input data into a JavaScript Object Notation (JSON) file.
Aspect 9. The method of aspect 1, wherein the trained machine learning model is a large language model (LLM).
Aspect 10. The method of aspect 1, wherein the subject-specific information includes at least one of a memory of the subject, an experience of the subject, a bias of the subject, an opinion of the subject, a hobby of the subject, a sport associated with the subject, an affiliation of the subject, an accolade associated with the subject, an image of the subject, a video of the subject, a document associated with the subject, or a website associated with the subject.
Aspect 11. The method of aspect 1, wherein the subject-specific information includes information from one or more previous responses previously generated using the personalized machine learning model.
Aspect 12. The method of aspect 1, further comprising: processing the response using a text-to-speech algorithm to generate an audio response, wherein the audio response vocalizes the response, and wherein outputting the response includes outputting the audio response.
Aspect 13. The method of aspect 1, further comprising: processing voice input data to generate voice model personalization data; modifying a second trained machine learning model using the voice model personalization data to generate a personalized voice machine learning model that is personalized to simulate a voice of the subject; and processing the response using the personalized voice machine learning model to generate an audio response that vocalizes the response via a simulation of the voice of the subject, and wherein outputting the response includes outputting the audio response.
Aspect 14. The method of aspect 13, wherein the voice model personalization data includes training data, and wherein modifying the second trained machine learning model using the voice model personalization data includes further training the second trained machine learning model further using the training data.
Aspect 15. The method of aspect 1, further comprising: processing the response using a second trained machine learning model to identify emotions corresponding to portions of the response, wherein outputting the response includes outputting a synthesized voice that reads the response according to audio characteristics that are set based on the identified emotions.
Aspect 16. The method of aspect 1, wherein the conversational user interface is a voice-based user interface.
Aspect 17. The method of aspect 1, further comprising: processing visual input data to generate visual model personalization data; modifying a second trained machine learning model using the visual model personalization data to generate a personalized visual machine learning model that is personalized to simulate an appearance of the subject; and processing the response using the personalized visual machine learning model to generate a visual response that includes mouth movements associated with vocalizing the response via a simulation of the appearance of the subject, and wherein outputting the response includes outputting the visual response.
Aspect 18. The method of aspect 17, wherein the visual model personalization data includes training data, and wherein modifying the second trained machine learning model using the visual model personalization data includes further training the second trained machine learning model further using the training data.
Aspect 19. The method of aspect 1, further comprising: receiving a second message after the response is output; extracting feedback about the response from the second message; updating the personalized machine learning model further based on the feedback; generating a second response using the personalized machine learning model, wherein the second response is responsive to the second message; and outputting the second response.
Aspect 20. The method of aspect 19, wherein updating the personalized machine learning model further based on the feedback includes further training the personalized machine learning model based on the feedback.
Aspect 21. The method of aspect 19, wherein updating the personalized machine learning model further based on the feedback includes further fine-tuning the personalized machine learning model based on the feedback.
Aspect 22. The method of aspect 1, wherein the subject-specific information includes a link, and wherein the response includes the link.
Aspect 23. The method of aspect 1, wherein the subject-specific information includes a file, wherein the response includes a link, and wherein the file is accessible through the link.
Aspect 24. The method of aspect 1, wherein the personalized machine learning model is personalized to simulate a speaking style of the subject.
Aspect 25. The method of aspect 1, wherein the response is generated to simulate a speaking style of the subject.
Aspect 26. The method of aspect 1, further comprising: identifying a second trained machine learning model based on the model personalization data, wherein modifying the trained machine learning model using the model personalization data to generate the personalized machine learning model includes combining the trained machine learning model and the second trained machine learning model to generate the personalized machine learning model.
Aspect 27. The method of aspect 1, further comprising: identifying a second personalized machine learning model that is configured to simulate a second subject; and combining the personalized machine learning model and the second personalized machine learning model to generate a group-specific personalized machine learning model configured to simulate a group, wherein the group includes the subject and the second subject.
Aspect 28. The method of aspect 1, further comprising: generating a biographical narrative about the subject using the personalized machine learning model; outputting the biographical narrative using the conversational user interface, wherein receiving the message interrupts the biographical narrative, and wherein the response is associated with the message and the biographical narrative; and resuming output of the biographical narrative after outputting the response.
Aspect 29. A system for machine learning model personalization, the system comprising: a memory that stores instructions; and a processor coupled to the memory, wherein execution of the instructions by the processor causes the processor to: receive input data through a discovery user interface, wherein the input data includes answers from a subject, wherein the answers are associated with questions, and wherein the answers include subject-specific information that is specific to the subject; process the input data to generate model personalization data; modify a trained machine learning model using the model personalization data to generate a personalized machine learning model that is personalized to simulate the subject; receive a message through a conversational user interface; generate a response using the personalized machine learning model, wherein the response is responsive to the message, and wherein the response is generated to simulate the subject by being generated to include at least a subset of the subject-specific information; and output the response through the conversational user interface.
Aspect 30. The system of aspect 29, wherein modifying the trained machine learning model using the model personalization data includes fine-tuning the trained machine learning model using the model personalization data.
Aspect 31. The system of aspect 29, wherein the model personalization data includes training data, and wherein modifying the trained machine learning model using the model personalization data includes further training the trained machine learning model using the training data.
Aspect 32. The system of aspect 29, wherein modifying the trained machine learning model using the model personalization data includes modifying contextual data for a prompt associated with the message, wherein the response is responsive to the prompt, and wherein the prompt includes the contextual data and the message.
Aspect 33. The system of aspect 29, wherein modifying the trained machine learning model using the model personalization data includes modifying a hyperparameter of the trained machine learning model based on the model personalization data.
Aspect 34. The system of aspect 29, wherein processing the input data includes parsing the input data to extract a plurality of data elements, wherein processing the input data further includes categorizing the plurality of data elements into a plurality of categories of data.
Aspect 35. The system of aspect 29, wherein processing the input data includes converting the input data into a spreadsheet.
Aspect 36. The system of aspect 29, wherein processing the model personalization data includes converting the input data into a JavaScript Object Notation (JSON) file.
Aspect 37. The system of aspect 29, wherein the trained machine learning model is a large language model (LLM).
Aspect 38. The system of aspect 29, wherein the subject-specific information includes at least one of a memory of the subject, an experience of the subject, a bias of the subject, an opinion of the subject, a hobby of the subject, a sport associated with the subject, an affiliation of the subject, an accolade associated with the subject, an image of the subject, a video of the subject, a document associated with the subject, or a website associated with the subject.
Aspect 39. The system of aspect 29, wherein the subject-specific information includes information from one or more previous responses previously generated using the personalized machine learning model.
Aspect 40. The system of aspect 29, wherein the execution of the instructions by the processor causes the processor to: process the response using a text-to-speech algorithm to generate an audio response, wherein the audio response vocalizes the response, and wherein outputting the response includes outputting the audio response.
Aspect 41. The system of aspect 29, wherein the execution of the instructions by the processor causes the processor to: process voice input data to generate voice model personalization data; modify a second trained machine learning model using the voice model personalization data to generate a personalized voice machine learning model that is personalized to simulate a voice of the subject; and process the response using the personalized voice machine learning model to generate an audio response that vocalizes the response via a simulation of the voice of the subject, and wherein outputting the response includes outputting the audio response.
Aspect 42. The system of aspect 41, wherein the voice model personalization data includes training data, and wherein modifying the second trained machine learning model using the voice model personalization data includes further training the second trained machine learning model further using the training data.
Aspect 43. The system of aspect 29, wherein the execution of the instructions by the processor causes the processor to: process the response using a second trained machine learning model to identify emotions corresponding to portions of the response, wherein outputting the response includes outputting a synthesized voice that reads the response according to audio characteristics that are set based on the identified emotions.
Aspect 44. The system of aspect 29, wherein the conversational user interface is a voice-based user interface.
Aspect 45. The system of aspect 29, wherein the execution of the instructions by the processor causes the processor to: process visual input data to generate visual model personalization data; modify a second trained machine learning model using the visual model personalization data to generate a personalized visual machine learning model that is personalized to simulate an appearance of the subject; and process the response using the personalized visual machine learning model to generate a visual response that includes mouth movements associated with vocalizing the response via a simulation of the appearance of the subject, and wherein outputting the response includes outputting the visual response.
Aspect 46. The system of aspect 45, wherein the visual model personalization data includes training data, and wherein modifying the second trained machine learning model using the visual model personalization data includes further training the second trained machine learning model further using the training data.
Aspect 47. The system of aspect 29, wherein the execution of the instructions by the processor causes the processor to: receive a second message after the response is output; extract feedback about the response from the second message; update the personalized machine learning model further based on the feedback; generate a second response using the personalized machine learning model, wherein the second response is responsive to the second message; and output the second response.
Aspect 48. The system of aspect 47, wherein updating the personalized machine learning model further based on the feedback includes further training the personalized machine learning model based on the feedback.
Aspect 49. The system of aspect 47, wherein updating the personalized machine learning model further based on the feedback includes further fine-tuning the personalized machine learning model based on the feedback.
Aspect 50. The system of aspect 29, wherein the subject-specific information includes a link, and wherein the response includes the link.
Aspect 51. The system of aspect 29, wherein the subject-specific information includes a file, wherein the response includes a link, and wherein the file is accessible through the link.
Aspect 52. The system of aspect 29, wherein the personalized machine learning model is personalized to simulate a speaking style of the subject.
Aspect 53. The system of aspect 29, wherein the response is generated to simulate a speaking style of the subject.
Aspect 54. The system of aspect 29, wherein the execution of the instructions by the processor causes the processor to: identify a second trained machine learning model based on the model personalization data, wherein modifying the trained machine learning model using the model personalization data to generate the personalized machine learning model includes combining the trained machine learning model and the second trained machine learning model to generate the personalized machine learning model.
Aspect 55. The system of aspect 29, wherein the execution of the instructions by the processor causes the processor to: identify a second personalized machine learning model that is configured to simulate a second subject; and combine the personalized machine learning model and the second personalized machine learning model to generate a group-specific personalized machine learning model configured to simulate a group, wherein the group includes the subject and the second subject.
Aspect 56. The system of aspect 29, wherein the execution of the instructions by the processor causes the processor to: generate a biographical narrative about the subject using the personalized machine learning model; output the biographical narrative using the conversational user interface, wherein receiving the message interrupts the biographical narrative, and wherein the response is associated with the message and the biographical narrative; and resume output of the biographical narrative after outputting the response.
Aspect 57. A non-transitory computer-readable storage medium having embodied thereon a program, wherein the program is executable by a processor to perform a method of machine learning model personalization, the method comprising: receiving input data through a discovery user interface, wherein the input data includes answers from a subject, wherein the answers are associated with questions, and wherein the answers include subject-specific information that is specific to the subject; processing the input data to generate model personalization data; modifying a trained machine learning model using the model personalization data to generate a personalized machine learning model that is personalized to simulate the subject; receiving a message through a conversational user interface; generating a response using the personalized machine learning model, wherein the response is responsive to the message, and wherein the response is generated to simulate the subject by being generated to include at least a subset of the subject-specific information; and outputting the response through the conversational user interface.
Aspect 58. The non-transitory computer-readable storage medium of aspect 57, wherein modifying the trained machine learning model using the model personalization data includes fine-tuning the trained machine learning model using the model personalization data.
Aspect 59. The non-transitory computer-readable storage medium of aspect 57, wherein the model personalization data includes training data, and wherein modifying the trained machine learning model using the model personalization data includes further training the trained machine learning model using the training data.
Aspect 60. The non-transitory computer-readable storage medium of aspect 57, wherein modifying the trained machine learning model using the model personalization data includes modifying contextual data for a prompt associated with the message, wherein the response is responsive to the prompt, and wherein the prompt includes the contextual data and the message.
Aspect 61. The non-transitory computer-readable storage medium of aspect 57, wherein modifying the trained machine learning model using the model personalization data includes modifying a hyperparameter of the trained machine learning model based on the model personalization data.
Aspect 62. The non-transitory computer-readable storage medium of aspect 57, wherein processing the input data includes parsing the input data to extract a plurality of data elements, wherein processing the input data further includes categorizing the plurality of data elements into a plurality of categories of data.
Aspect 63. The non-transitory computer-readable storage medium of aspect 57, wherein processing the input data includes converting the input data into a spreadsheet.
Aspect 64. The non-transitory computer-readable storage medium of aspect 57, wherein processing the model personalization data includes converting the input data into a JavaScript Object Notation (JSON) file.
Aspect 65. The non-transitory computer-readable storage medium of aspect 57, wherein the trained machine learning model is a large language model (LLM).
Aspect 66. The non-transitory computer-readable storage medium of aspect 57, wherein the subject-specific information includes at least one of a memory of the subject, an experience of the subject, a bias of the subject, an opinion of the subject, a hobby of the subject, a sport associated with the subject, an affiliation of the subject, an accolade associated with the subject, an image of the subject, a video of the subject, a document associated with the subject, or a website associated with the subject.
Aspect 67. The non-transitory computer-readable storage medium of aspect 57, wherein the subject-specific information includes information from one or more previous responses previously generated using the personalized machine learning model.
Aspect 68. The non-transitory computer-readable storage medium of aspect 57, further comprising: processing the response using a text-to-speech algorithm to generate an audio response, wherein the audio response vocalizes the response, and wherein outputting the response includes outputting the audio response.
Aspect 69. The non-transitory computer-readable storage medium of aspect 57, further comprising: processing voice input data to generate voice model personalization data; modifying a second trained machine learning model using the voice model personalization data to generate a personalized voice machine learning model that is personalized to simulate a voice of the subject; and processing the response using the personalized voice machine learning model to generate an audio response that vocalizes the response via a simulation of the voice of the subject, and wherein outputting the response includes outputting the audio response.
Aspect 70. The non-transitory computer-readable storage medium of aspect 69, wherein the voice model personalization data includes training data, and wherein modifying the second trained machine learning model using the voice model personalization data includes further training the second trained machine learning model further using the training data.
Aspect 71. The non-transitory computer-readable storage medium of aspect 57, further comprising: processing the response using a second trained machine learning model to identify emotions corresponding to portions of the response, wherein outputting the response includes outputting a synthesized voice that reads the response according to audio characteristics that are set based on the identified emotions.
Aspect 72. The non-transitory computer-readable storage medium of aspect 57, wherein the conversational user interface is a voice-based user interface.
Aspect 73. The non-transitory computer-readable storage medium of aspect 57, further comprising: processing visual input data to generate visual model personalization data; modifying a second trained machine learning model using the visual model personalization data to generate a personalized visual machine learning model that is personalized to simulate an appearance of the subject; and processing the response using the personalized visual machine learning model to generate a visual response that includes mouth movements associated with vocalizing the response via a simulation of the appearance of the subject, and wherein outputting the response includes outputting the visual response.
Aspect 74. The non-transitory computer-readable storage medium of aspect 73, wherein the visual model personalization data includes training data, and wherein modifying the second trained machine learning model using the visual model personalization data includes further training the second trained machine learning model further using the training data.
Aspect 75. The non-transitory computer-readable storage medium of aspect 57, further comprising: receiving a second message after the response is output; extracting feedback about the response from the second message; updating the personalized machine learning model further based on the feedback; generating a second response using the personalized machine learning model, wherein the second response is responsive to the second message; and outputting the second response.
Aspect 76. The non-transitory computer-readable storage medium of aspect 75, wherein updating the personalized machine learning model further based on the feedback includes further training the personalized machine learning model based on the feedback.
Aspect 77. The non-transitory computer-readable storage medium of aspect 75, wherein updating the personalized machine learning model further based on the feedback includes further fine-tuning the personalized machine learning model based on the feedback.
Aspect 78. The non-transitory computer-readable storage medium of aspect 57, wherein the subject-specific information includes a link, and wherein the response includes the link.
Aspect 79. The non-transitory computer-readable storage medium of aspect 57, wherein the subject-specific information includes a file, wherein the response includes a link, and wherein the file is accessible through the link.
Aspect 80. The non-transitory computer-readable storage medium of aspect 57, wherein the personalized machine learning model is personalized to simulate a speaking style of the subject.
Aspect 81. The non-transitory computer-readable storage medium of aspect 57, wherein the response is generated to simulate a speaking style of the subject.
Aspect 82. The non-transitory computer-readable storage medium of aspect 57, further comprising: identifying a second trained machine learning model based on the model personalization data, wherein modifying the trained machine learning model using the model personalization data to generate the personalized machine learning model includes combining the trained machine learning model and the second trained machine learning model to generate the personalized machine learning model.
Aspect 83. The non-transitory computer-readable storage medium of aspect 57, further comprising: identifying a second personalized machine learning model that is configured to simulate a second subject; and combining the personalized machine learning model and the second personalized machine learning model to generate a group-specific personalized machine learning model configured to simulate a group, wherein the group includes the subject and the second subject.
Aspect 84. The non-transitory computer-readable storage medium of aspect 57, further comprising: generating a biographical narrative about the subject using the personalized machine learning model; outputting the biographical narrative using the conversational user interface, wherein receiving the message interrupts the biographical narrative, and wherein the response is associated with the message and the biographical narrative; and resuming output of the biographical narrative after outputting the response.
Aspect 85. An apparatus comprising one or more means for performing operations according to any of Aspects 1 to 84.

What is claimed is:

1. A method for machine learning model personalization, the method comprising:
receiving input data through a discovery user interface, wherein the input data includes answers from a subject, wherein the answers are associated with questions, and wherein the answers include subject-specific information that is specific to the subject;
processing the input data to generate model personalization data;
modifying a trained machine learning model using the model personalization data to generate a personalized machine learning model that is personalized to simulate the subject;
receiving a message through a conversational user interface;
generating a response using the personalized machine learning model, wherein the response is responsive to the message, and wherein the response is generated to simulate the subject by being generated to include at least a subset of the subject-specific information; and
outputting the response through the conversational user interface.

2. The method of claim 1, wherein modifying the trained machine learning model using the model personalization data includes fine-tuning the trained machine learning model using the model personalization data.

3. The method of claim 1, wherein the model personalization data includes training data, and wherein modifying the trained machine learning model using the model personalization data includes further training the trained machine learning model using the training data.

4. The method of claim 1, wherein modifying the trained machine learning model using the model personalization data includes modifying contextual data for a prompt associated with the message, wherein the response is responsive to the prompt, and wherein the prompt includes the contextual data and the message.

5. The method of claim 1, wherein modifying the trained machine learning model using the model personalization data includes modifying a hyperparameter of the trained machine learning model based on the model personalization data.

6. The method of claim 1, wherein processing the input data includes parsing the input data to extract a plurality of data elements, wherein processing the input data further includes categorizing the plurality of data elements into a plurality of categories of data.

7. The method of claim 1, wherein processing the input data includes converting the input data into a spreadsheet.

8. The method of claim 1, wherein processing the model personalization data includes converting the input data into a JavaScript Object Notation (JSON) file.

9. The method of claim 1, wherein the trained machine learning model is a large language model (LLM).

10. The method of claim 1, wherein the subject-specific information includes at least one of a memory of the subject, an experience of the subject, a bias of the subject, an opinion of the subject, a hobby of the subject, a sport associated with the subject, an affiliation of the subject, an accolade associated with the subject, an image of the subject, a video of the subject, a document associated with the subject, or a website associated with the subject.

11. The method of claim 1, wherein the subject-specific information includes information from one or more previous responses previously generated using the personalized machine learning model.

12. The method of claim 1, further comprising:
processing the response using a text-to-speech algorithm to generate an audio response, wherein the audio response vocalizes the response, and wherein outputting the response includes outputting the audio response.

13. The method of claim 1, further comprising:
processing voice input data to generate voice model personalization data;
modifying a second trained machine learning model using the voice model personalization data to generate a personalized voice machine learning model that is personalized to simulate a voice of the subject; and
processing the response using the personalized voice machine learning model to generate an audio response that vocalizes the response via a simulation of the voice of the subject, and wherein outputting the response includes outputting the audio response.

14. The method of claim 13, wherein the voice model personalization data includes training data, and wherein modifying the second trained machine learning model using the voice model personalization data includes further training the second trained machine learning model further using the training data.

15. The method of claim 1, further comprising:
processing the response using a second trained machine learning model to identify emotions corresponding to portions of the response, wherein outputting the response includes outputting a synthesized voice that reads the response according to audio characteristics that are set based on the identified emotions.

16. The method of claim 1, wherein the conversational user interface is a voice-based user interface.

17. The method of claim 1, further comprising:
processing visual input data to generate visual model personalization data;
modifying a second trained machine learning model using the visual model personalization data to generate a personalized visual machine learning model that is personalized to simulate an appearance of the subject; and
processing the response using the personalized visual machine learning model to generate a visual response that includes mouth movements associated with vocalizing the response via a simulation of the appearance of the subject, and wherein outputting the response includes outputting the visual response.

18. The method of claim 17, wherein the visual model personalization data includes training data, and wherein modifying the second trained machine learning model using the visual model personalization data includes further training the second trained machine learning model further using the training data.

19. The method of claim 1, further comprising:
receiving a second message after the response is output;
extracting feedback about the response from the second message;
updating the personalized machine learning model further based on the feedback;
generating a second response using the personalized machine learning model, wherein the second response is responsive to the second message; and
outputting the second response.

20. The method of claim 19, wherein updating the personalized machine learning model further based on the feedback includes further training the personalized machine learning model based on the feedback.

21. The method of claim 19, wherein updating the personalized machine learning model further based on the feedback includes further fine-tuning the personalized machine learning model based on the feedback.

22. The method of claim 1, wherein the subject-specific information includes a link, and wherein the response includes the link.

23. The method of claim 1, wherein the subject-specific information includes a file, wherein the response includes a link, and wherein the file is accessible through the link.

24. The method of claim 1, wherein the personalized machine learning model is personalized to simulate a speaking style of the subject.

25. The method of claim 1, wherein the response is generated to simulate a speaking style of the subject.

26. The method of claim 1, further comprising:
identifying a second trained machine learning model based on the model personalization data, wherein modifying the trained machine learning model using the model personalization data to generate the personalized machine learning model includes combining the trained machine learning model and the second trained machine learning model to generate the personalized machine learning model.

27. The method of claim 1, further comprising:
identifying a second personalized machine learning model that is configured to simulate a second subject; and
combining the personalized machine learning model and the second personalized machine learning model to generate a group-specific personalized machine learning model configured to simulate a group, wherein the group includes the subject and the second subject.

28. The method of claim 1, further comprising:
generating a biographical narrative about the subject using the personalized machine learning model;
outputting the biographical narrative using the conversational user interface, wherein receiving the message interrupts the biographical narrative, and wherein the response is associated with the message and the biographical narrative; and
resuming output of the biographical narrative after outputting the response.

29. A system for machine learning model personalization, the system comprising:
a memory that stores instructions; and
a processor coupled to the memory, wherein execution of the instructions by the processor causes the processor to:
receive input data through a discovery user interface, wherein the input data includes answers from a subject, wherein the answers are associated with questions, and wherein the answers include subject-specific information that is specific to the subject;
process the input data to generate model personalization data;
modify a trained machine learning model using the model personalization data to generate a personalized machine learning model that is personalized to simulate the subject;
receive a message through a conversational user interface;
generate a response using the personalized machine learning model, wherein the response is responsive to the message, and wherein the response is generated to simulate the subject by being generated to include at least a subset of the subject-specific information; and
output the response through the conversational user interface.

30. The system of claim 29, wherein modifying the trained machine learning model using the model personalization data includes fine-tuning the trained machine learning model using the model personalization data.

31. The system of claim 29, wherein the model personalization data includes training data, and wherein modifying the trained machine learning model using the model personalization data includes further training the trained machine learning model using the training data.

32. The system of claim 29, wherein modifying the trained machine learning model using the model personalization data includes modifying contextual data for a prompt associated with the message, wherein the response is responsive to the prompt, and wherein the prompt includes the contextual data and the message.

33. The system of claim 29, wherein modifying the trained machine learning model using the model personalization data includes modifying a hyperparameter of the trained machine learning model based on the model personalization data.

34. The system of claim 29, wherein processing the input data includes parsing the input data to extract a plurality of data elements, wherein processing the input data further includes categorizing the plurality of data elements into a plurality of categories of data.

35. The system of claim 29, wherein processing the input data includes converting the input data into a spreadsheet.

36. The system of claim 29, wherein processing the model personalization data includes converting the input data into a JavaScript Object Notation (JSON) file.

37. The system of claim 29, wherein the trained machine learning model is a large language model (LLM).

38. The system of claim 29, wherein the subject-specific information includes at least one of a memory of the subject, an experience of the subject, a bias of the subject, an opinion of the subject, a hobby of the subject, a sport associated with the subject, an affiliation of the subject, an accolade associated with the subject, an image of the subject, a video of the subject, a document associated with the subject, or a website associated with the subject.

39. The system of claim 29, wherein the subject-specific information includes information from one or more previous responses previously generated using the personalized machine learning model.

40. The system of claim 29, wherein the execution of the instructions by the processor causes the processor to:
process the response using a text-to-speech algorithm to generate an audio response, wherein the audio response vocalizes the response, and wherein outputting the response includes outputting the audio response.

41. The system of claim 29, wherein the execution of the instructions by the processor causes the processor to:
process voice input data to generate voice model personalization data;
modify a second trained machine learning model using the voice model personalization data to generate a personalized voice machine learning model that is personalized to simulate a voice of the subject; and
process the response using the personalized voice machine learning model to generate an audio response that vocalizes the response via a simulation of the voice of the subject, and wherein outputting the response includes outputting the audio response.

42. The system of claim 41, wherein the voice model personalization data includes training data, and wherein modifying the second trained machine learning model using the voice model personalization data includes further training the second trained machine learning model further using the training data.

43. The system of claim 29, wherein the execution of the instructions by the processor causes the processor to:
process the response using a second trained machine learning model to identify emotions corresponding to portions of the response, wherein outputting the response includes outputting a synthesized voice that reads the response according to audio characteristics that are set based on the identified emotions.

44. The system of claim 29, wherein the conversational user interface is a voice-based user interface.

45. The system of claim 29, wherein the execution of the instructions by the processor causes the processor to:
process visual input data to generate visual model personalization data;
modify a second trained machine learning model using the visual model personalization data to generate a personalized visual machine learning model that is personalized to simulate an appearance of the subject; and
process the response using the personalized visual machine learning model to generate a visual response that includes mouth movements associated with vocalizing the response via a simulation of the appearance of the subject, and wherein outputting the response includes outputting the visual response.

46. The system of claim 45, wherein the visual model personalization data includes training data, and wherein modifying the second trained machine learning model using the visual model personalization data includes further training the second trained machine learning model further using the training data.

47. The system of claim 29, wherein the execution of the instructions by the processor causes the processor to:
receive a second message after the response is output;
extract feedback about the response from the second message;
update the personalized machine learning model further based on the feedback;
generate a second response using the personalized machine learning model, wherein the second response is responsive to the second message; and
output the second response.

48. The system of claim 47, wherein updating the personalized machine learning model further based on the feedback includes further training the personalized machine learning model based on the feedback.

49. The system of claim 47, wherein updating the personalized machine learning model further based on the feedback includes further fine-tuning the personalized machine learning model based on the feedback.

50. The system of claim 29, wherein the subject-specific information includes a link, and wherein the response includes the link.

51. The system of claim 29, wherein the subject-specific information includes a file, wherein the response includes a link, and wherein the file is accessible through the link.

52. The system of claim 29, wherein the personalized machine learning model is personalized to simulate a speaking style of the subject.

53. The system of claim 29, wherein the response is generated to simulate a speaking style of the subject.

54. The system of claim 29, wherein the execution of the instructions by the processor causes the processor to:
identify a second trained machine learning model based on the model personalization data, wherein modifying the trained machine learning model using the model personalization data to generate the personalized machine learning model includes combining the trained machine learning model and the second trained machine learning model to generate the personalized machine learning model.

55. The system of claim 29, wherein the execution of the instructions by the processor causes the processor to:
identify a second personalized machine learning model that is configured to simulate a second subject; and
combine the personalized machine learning model and the second personalized machine learning model to generate a group-specific personalized machine learning model configured to simulate a group, wherein the group includes the subject and the second subject.

56. The system of claim 29, wherein the execution of the instructions by the processor causes the processor to:
generate a biographical narrative about the subject using the personalized machine learning model;
output the biographical narrative using the conversational user interface, wherein receiving the message interrupts the biographical narrative, and wherein the response is associated with the message and the biographical narrative; and
resume output of the biographical narrative after outputting the response.

57. A non-transitory computer-readable storage medium having embodied thereon a program, wherein the program is executable by a processor to perform a method of machine learning model personalization, the method comprising:
receiving input data through a discovery user interface, wherein the input data includes answers from a subject, wherein the answers are associated with questions, and wherein the answers include subject-specific information that is specific to the subject;
processing the input data to generate model personalization data;
modifying a trained machine learning model using the model personalization to generate a personalized machine learning model that is personalized to simulate the subject;
receiving a message through a conversational user interface;
generating a response using the personalized machine learning model, wherein the response is responsive to the message, and wherein the response is generated to simulate the subject by being generated to include at least a subset of the subject-specific information; and
outputting the response through the conversational user interface.

58. The non-transitory computer-readable storage medium of claim 57, wherein modifying the trained machine learning model using the model personalization data includes fine-tuning the trained machine learning model using the model personalization data.

59. The non-transitory computer-readable storage medium of claim 57, wherein the model personalization data includes training data, and wherein modifying the trained machine learning model using the model personalization data includes further training the trained machine learning model using the training data.

60. The non-transitory computer-readable storage medium of claim 57, wherein modifying the trained machine learning model using the model personalization data includes modifying contextual data for a prompt associated with the message, wherein the response is responsive to the prompt, and wherein the prompt includes the contextual data and the message.

61. The non-transitory computer-readable storage medium of claim 57, wherein modifying the trained machine learning model using the model personalization data includes modifying a hyperparameter of the trained machine learning model based on the model personalization data.

62. The non-transitory computer-readable storage medium of claim 57, wherein processing the input data includes parsing the input data to extract a plurality of data elements, wherein processing the input data further includes categorizing the plurality of data elements into a plurality of categories of data.

63. The non-transitory computer-readable storage medium of claim 57, wherein processing the input data includes converting the input data into a spreadsheet.

64. The non-transitory computer-readable storage medium of claim 57, wherein processing the model personalization data includes converting the input data into a JavaScript Object Notation (JSON) file.

65. The non-transitory computer-readable storage medium of claim 57, wherein the trained machine learning model is a large language model (LLM).

66. The non-transitory computer-readable storage medium of claim 57, wherein the subject-specific information includes at least one of a memory of the subject, an experience of the subject, a bias of the subject, an opinion of the subject, a hobby of the subject, a sport associated with the subject, an affiliation of the subject, an accolade associated with the subject, an image of the subject, a video of the subject, a document associated with the subject, or a website associated with the subject.

67. The non-transitory computer-readable storage medium of claim 57, wherein the subject-specific information includes information from one or more previous responses previously generated using the personalized machine learning model.

68. The non-transitory computer-readable storage medium of claim 57, further comprising:
processing the response using a text-to-speech algorithm to generate an audio response, wherein the audio response vocalizes the response, and wherein outputting the response includes outputting the audio response.

69. The non-transitory computer-readable storage medium of claim 57, further comprising:
processing voice input data to generate voice model personalization data;
modifying a second trained machine learning model using the voice model personalization data to generate a personalized voice machine learning model that is personalized to simulate a voice of the subject; and
processing the response using the personalized voice machine learning model to generate an audio response that vocalizes the response via a simulation of the voice of the subject, and wherein outputting the response includes outputting the audio response.

70. The non-transitory computer-readable storage medium of claim 69, wherein the voice model personalization data includes training data, and wherein modifying the second trained machine learning model using the voice model personalization data includes further training the second trained machine learning model further using the training data.

71. The non-transitory computer-readable storage medium of claim 57, further comprising:
processing the response using a second trained machine learning model to identify emotions corresponding to portions of the response, wherein outputting the response includes outputting a synthesized voice that reads the response according to audio characteristics that are set based on the identified emotions.

72. The non-transitory computer-readable storage medium of claim 57, wherein the conversational user interface is a voice-based user interface.

73. The non-transitory computer-readable storage medium of claim 57, further comprising:
processing visual input data to generate visual model personalization data;
modifying a second trained machine learning model using the visual model personalization data to generate a personalized visual machine learning model that is personalized to simulate an appearance of the subject; and
processing the response using the personalized visual machine learning model to generate a visual response that includes mouth movements associated with vocalizing the response via a simulation of the appearance of the subject, and wherein outputting the response includes outputting the visual response.

74. The non-transitory computer-readable storage medium of claim 73, wherein the visual model personalization data includes training data, and wherein modifying the second trained machine learning model using the visual model personalization data includes further training the second trained machine learning model further using the training data.

75. The non-transitory computer-readable storage medium of claim 57, further comprising:
receiving a second message after the response is output;
extracting feedback about the response from the second message;
updating the personalized machine learning model further based on the feedback;
generating a second response using the personalized machine learning model, wherein the second response is responsive to the second message; and
outputting the second response.

76. The non-transitory computer-readable storage medium of claim 75, wherein updating the personalized machine learning model further based on the feedback includes further training the personalized machine learning model based on the feedback.

77. The non-transitory computer-readable storage medium of claim 75, wherein updating the personalized machine learning model further based on the feedback includes further fine-tuning the personalized machine learning model based on the feedback.

78. The non-transitory computer-readable storage medium of claim 57, wherein the subject-specific information includes a link, and wherein the response includes the link.

79. The non-transitory computer-readable storage medium of claim 57, wherein the subject-specific information includes a file, wherein the response includes a link, and wherein the file is accessible through the link.

80. The non-transitory computer-readable storage medium of claim 57, wherein the personalized machine learning model is personalized to simulate a speaking style of the subject.

81. The non-transitory computer-readable storage medium of claim 57, wherein the response is generated to simulate a speaking style of the subject.

82. The non-transitory computer-readable storage medium of claim 57, further comprising:
identifying a second trained machine learning model based on the model personalization data, wherein modifying the trained machine learning model using the model personalization data to generate the personalized machine learning model includes combining the trained machine learning model and the second trained machine learning model to generate the personalized machine learning model.

83. The non-transitory computer-readable storage medium of claim 57, further comprising:
identifying a second personalized machine learning model that is configured to simulate a second subject; and
combining the personalized machine learning model and the second personalized machine learning model to generate a group-specific personalized machine learning model configured to simulate a group, wherein the group includes the subject and the second subject.

84. The non-transitory computer-readable storage medium of claim 57, further comprising:
generating a biographical narrative about the subject using the personalized machine learning model;
outputting the biographical narrative using the conversational user interface, wherein receiving the message interrupts the biographical narrative, and wherein the response is associated with the message and the biographical narrative; and
resuming output of the biographical narrative after outputting the response.
